(19) United States
(12) Patent Application Publication
(10) Pub. No.: US 2008/0199841 A1
(43) Pub. Date: Aug. 21, 2008

(54) Method to overcome pain and addiction

(76) Inventor: Carlota Aguilar-Long, Bayou Vista, TX (US)

Correspondence Address: Benjamin Aaron Adler;ADLER & ASSOCIATES, 8011 Candle Lane, Houston, TX, 77071, US

(21) Appl. No.: 11/708,443

(22) Filed: Feb. 20, 2007

(51) Int. Cl. G09B 23/28

(52) U.S. Cl. 434/262

(57) ABSTRACT

The present invention is directed to a method of treating pain and addiction in an individual. The mode of treatment is via a class, which combines 1) an alternative to reality through the simulation of real life experience, 2)discussion where individual participants a) identify factors that influenced the characters' and their choices by utilizing a behavior and self diagram, b)Evaluate the opinion of scholars and experts in the field, 3) The use of neuro-linguistic programming excercises to process emotions that have hindered the individual's life. This method provides an individual with alternative choices in life and helps develop positive goals for the future.

### BACKGROUND OF THE INVENTION

1. Field of the Invention

The present invention relates generally to the field of rehabilitation therapy. More specifically, the present invention is directed to a method to overcome pain and addiction via a classroom course that combines the techniques of simulation of a real life experience, discussion and neurolinguistic programming (NLP) exercises.

2. Description of the Related Art

Over the years a number of techniques such as hypnosis, kinesthetics, classroom discussions, virtual reality experience etc. have been used to help individuals overcome emotional distress such as depression and addiction to narcotics. These programs are used in prisons and rehabilitation centers to help individuals overcome their psychological barriers and to help them establish a better life for themselves in society.

Richard Bandler and John Grindler pioneered neuro-linguistic programming (NLP) in which the therapist tells the individual being treated to complete a certain mental exercise in his/her mind in order to bring about behavioral change at the unconscious and conscious levels of the patient's mind. The neuro-linguistic programming practitioner's goal is generally to reprogram an individual's beliefs about himself/herself. By detecting automatic body changes, the neuro-linguistic programming practitioner attempts to discern how an individual perceives and relates to identity, personal beliefs and life goal issues. Neuro-linguistic programming can help individuals replace false or negative perceptions with positive life affirming beliefs.

U.S. Pat. No. 6,425,764 describes a virtual reality immersion therapy for treating problems using computer graphics, images imported from photographs and video for sensory stimulation. This method however requires the use of expensive electronic equipment to achieve the desired therapeutic effect. U.S. Pat. No. 6,431,874 discloses a method to reduce tobacco smoking, which uses a combination of educating tobacco smokers regarding smoking, hypnotizing tobacco smokers and providing dietary substances to address the nutritional needs of nicotine addiction.

Visual stimulation alone allows for retention of only 10% of the subject matter taught. Auditory learning has a retention of 30% and kinesthetics has a much higher retention of 70%. However, the highest retention of about 90% is achieved when a concept is communicated via the dramatization or simulation of a real life experience. Such a mode of communication or teaching will be beneficial in the long run when used to rehabilitate individuals suffering from addiction or trauma.

The prior art teaches using auditory, visual and neuro-linguistic programming exercises to help individuals overcome mental stress and addiction. However prior art lacks in a method that uses dramatization, discussion and neuro-linguistic programming exercises to help an individual overcome pain and addiction. The present invention fulfils this need in the art.

### SUMMARY OF THE INVENTION

The present invention is directed to a method of overcoming pain and addiction in an individual in need of such treatment. The pain that is treated is not related to physical pain as in an injury or a disease manifestation but rather deep mental agony. The addiction that is addressed can be addiction to drugs, alcohol, food, tobacco etc. The method of treatment disclosed herein comprises a classroom course for individuals in need of such treatment and one or more professionals specifically trained to conduct this classroom course. The course comprises: (a) the dramatization or simulation of a real life experience; (b) a discussion between said individuals and said professional about the story and characters, during which the individual identifies the origin of the character's choices as well as his/her own choices utilizing the Behavior and Self diagram (FIG. 1), presented in step (a); (c) Neuro-linguistic Programming excercises (NLP) that takes said individual to an emotional state where said individual processes own traumas and fears; and (d) conducting an attitude test at the beginning and at the end of said course to measure changes in attitude as a result of said course. In a related embodiment step (c) involves neuro-linguistic programming exercises where an individual is guided by vocal instructions from the trained professional to traumatic incidents in the past. The individual's mind is programmed to create positive memories and stimulate positive goals.

### BRIEF DESCRIPTION OF THE DRAWINGS

FIG. 1 shows the Behavior and Self Diagram.

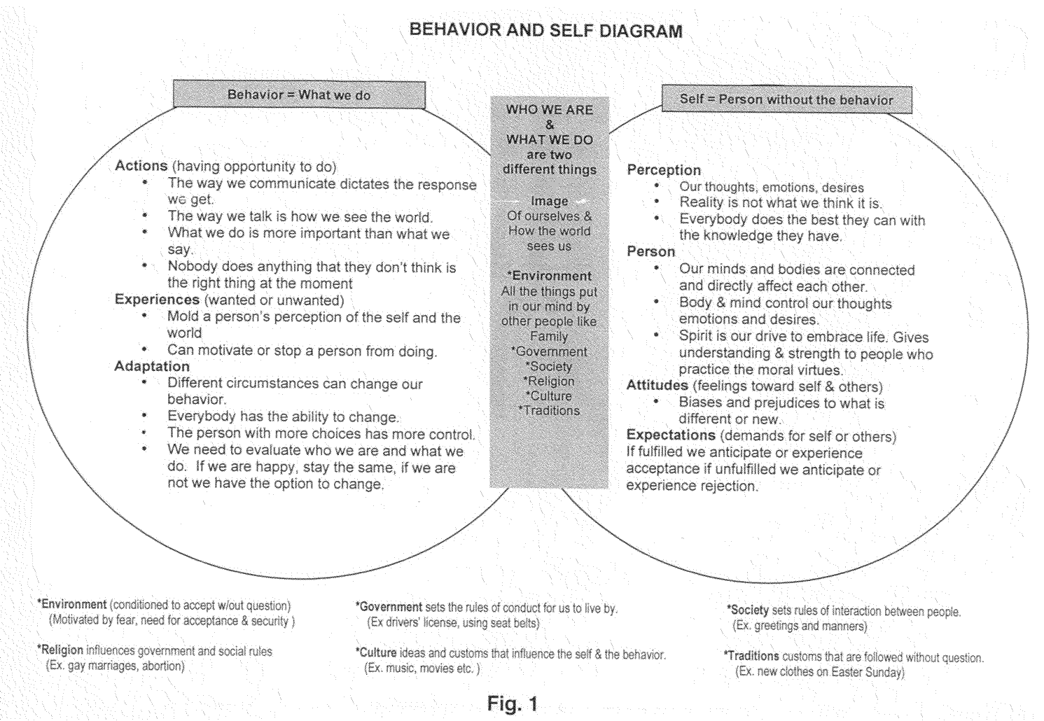

### DETAILED DESCRIPTION OF THE INVENTION

For an individual to overcome mental agony and/or addiction it is important that the individual objectively assesses traumatic situations in his/her life that pushed him/her to commit an act of felony or gravitate towards drugs, alcohol or any other form of addiction. The invention does not just use Neuro-Linguistic Programming to process pain. It uses the NLP principles as a guide to distinguish the Self from the Behavior. The NLP principles are summarized in the Behavior and Self Diagram. Individuals participating in this class will learn to recognize the forces that have influenced their self concept and their behavior by mastering the use of this diagram during the course of this class. Such objective assessment helps the individual overcome feelings of guilt and despair at having made the choices that he/she had made under such traumatic situations. If an individual can see the same situation in the form of a play, where the lead artist goes through a similar life situation, then this individual can objectively assess the situation without feeling threatened as the traumatic incident is not happening to him/her but to a character in a play. During and after the play, the individual can be drawn to discuss his/her opinions about the character's choices. At this point the individual will be asked by the trained professional to use the Behavior and Self Diagram to identify the forces that influenced the character's choices. The individual will be told about opinions of scholars and experts in various fields to assess the character's choices and to introduce alternative mode of thinking and alternative choices that are available.

Thus the unique combination of three powerful elements engage the individuals participating in the class at various levels, First, at a child like or trusting level by pretending to be one or more of the characters in the dramatization or simulation of a real life experience. Second, at mental level during the discussion by utilizing the Behavior & Self diagram to analyze the forces that shaped the characters' and their own self concept and behavior; Alternatives to the character's and their own choices are also presented to the individuals during the discussion through statements made by scholars and experts in the field; The third level of intervention is at a subconscious level by utilizing various Neuro-linguistic Programming exercises to repair critical emotional damage caused by pain and addiction. This invention for treatment uses a three pronged approach: 1) the dramatization or the simulation of a real life experience to address negative emotions by observing them outside of the self; 2) The discussion allows the individuals to learn how their self-concept and behaviors are shaped while discussing professionals and experts' opinions and alternative behavioral choices for the characters and themselves. 3) Neuro-linguistic programming exercises to acknowledge and treat the emotional responses triggered by the discussion. These three elements produce significant attitudinal changes in individual participants suffering from pain and addiction.

The presentation of such alternative choices is usually well received if it is introduced as choices that the individual is free to make rather than imposing them as compulsory choices that the individual has to make. In other words an individual will be more receptive to new ideas if they are not imposed as the only alternative available to him/her. Once the individual is able to see alternative approaches to life and life situations he/she can be taken through a series of neuro-linguistic programming exercises to create positive memories that stimulate positive goals. Thus combining the dramatization or simulation of a real life experience, followed by discussion and neuro-linguistic programming exercises can help an individual overcome pain and addiction. The present invention is directed to a method, which uses this combination in a class to rehabilitate people suffering from mental agony and/or addiction. The class objectives are to give participants the tools to: (1) deal with their emotions without being destructive; (2) evaluate their expectations; and (3) examine their beliefs as well as the beliefs of others by comparing and discussing their beliefs with the beliefs of professionals and experts in covered areas.

In one embodiment the present invention is directed to a method to help an individual overcome pain and agony via a classroom course conducted by one or more professionals specifically trained to conduct such course and comprises: (a) the dramatization or simulation of a real life experience; (b) a discussion between said individuals and said professional about the story and characters presented in (a); (c) a Neuro linguistic exercise, wherein said individual is guided to an emotional state where he processes own traumas and fears; and (d) conducting an attitude test at the beginning and at the end of said course to measure changes in attitude as a result of said course. The attitude test is based on a series of indicators found in the book written by Yochelson and Samenow titled The Criminal Personality Volume II. Generally the pain treated by this method is not of a physical nature such as for example caused by an injury or a disease manifestation but rather a mental distress such as that associated with doing something hurtful to others or the pain associated with being a victim of a wrongful deed such as for example child abuse. Being a drug-addict, being incarcerated, or being unable to conform to the expectations of society can also cause such trauma or pain. In this embodiment the dramatization or simulation of a real life experience presents difficult areas of concern for individual participants. In a preferred embodiment the dramatization of a traumatic life situation involves an emotionally distressed young individual, such as an individual with a handicap or an an ex convict with a drug addiction problem.

A discussion of the play allows participants to express their opinion about the characters and the choices made by them in a non-threatening situation. As the traumatic situation is happening to ‘another’ and not ‘self’, the individual is able to arrive at alternative choices that the character could have opted for. Additionally, the professional conducting the class asks individual participants to identify in the Behavior and Self diagram the origin of the character's choices and introduces opinions by scholars and experts in the related field about the characters in the play and alternative choice proposed by these experts.

In a preferred embodiment, the opinion of scholars and experts in the related field are not imposed on the participants but are rather presented as options that participants are free to consider. Additionally, the pros and cons of different alternatives are also discussed so that the participants can make an informed decision about choice that they can make in difficult life situations. In another embodiment of the present invention, is neuro-linguistic programming exercises conducted by the trained professional to take the participants to traumatic incidents in their past so that participants can deal with this trauma and overcome pain and guilt attached to such incidents. This is very essential to the healing process as the participants should be free of critical negative feelings about their past. The participant via neuro-linguistic programming exercises is taken to a desired place in the future and his/her mind is programmed to think about positive memories that stimulate positive goals.

In one embodiment the class of the present invention comprises the following topics through dramatization, discussion and neuro-linguistic programming exercises: (i) the road to freedom; (ii) finding the way out of darkness; (iii) children in violent homes; (iv) neuro-linguistic programming exercise to process childhood abuse; (v) childhood wounds; (vi) recognizing the spirit; (vii) lost in a sea of problems; (viii) drugs a mirage in the desert; (ix) when the family went wrong; (x) paralyzing guilt; (xi) the bleeding pain of victimization; (xii) neuro-linguistic programming exercise to accept family's faults; (xiii) dominance and submission; (xiv) trapped by bad luck; (xv) sex and survival; (xvi) trying and not succeeding; (xvii) recognizing the teacher in everyone; (xviii) neuro-linguistic programming exercise to project a desired future; (xix) women in the search of wholeness; (xx) love, a four letter word; (xxi) nothing to do and nowhere to go; (xxii) emotional atrophies that maim men; (xxiii) conquering the mountain of forgiveness; and (xxiv) neuro-linguistic programming exercise to forgive and let go of resentment. In a preferred embodiment the concepts of (i)-(vi) are covered in the first section, (vii)-(xii) in the second session, (viii)-(xviii) in the third session and (xix)-(xxiv) in the fourth session. There is preferably a break between each section to allow for a discussion between the participant and the trained professional about the concepts covered in each session. The dramatized form of the class has set breaks to allow for the section discussions and the Neuro Linguistic programming excercises.

At the beginning of the class the individuals take a pre-attitude test. The trained professionals conducting the class use teaching aids such as videotapes, audio tapes, blackboard, power point presentations, paper and writing medium to convey the course material to the participants. The class is a 20 hour class conducted in four five hour sessions. The trained professional is skilled in NLP technique, which is well known in the related art. One can find a description of neuro-linguistic programming technique in a number of books authored or coauthored by Dr. Richard Bandler (The Stucture of Magic. Volumes I and II (1975, 1976); Frogs into Princes. (1980); Tranceformations (1981)). The class disclosed in the instant invention can be held in any room with sufficient space for some participants to perform and sitting space for the observing participants and trained professional/s.

The following examples are given for the purpose of illustrating various embodiments of the invention and are not meant to limit the present invention in any fashion. One skilled in the art will appreciate readily that the present invention is well adapted to carry out the objects and obtain the ends and advantages mentioned, a; well as those objects, ends and advantages inherent herein, changes therein and other uses which are encompassed within the spirit of the invention as defined by the scope of the claims will occur to those skilled in the art.

### EXAMPLE 1

Before class begins, individual participants take the attitude pre-test. A hand out called mastery of objectives is also given to individual participants at the beginning of the class. This mastery of objectives has a series of questions about the session. The individual participants will learn the answers during the session and discuss such answers at the end of the day.

1.—Staging Instructions and Stage Set Up

David is in his prison cell. He is anxious about his future as he is going to be released the following day. The stage is set with a table at left center and two chairs next to each other in front of the table. David is sitting in the far left chair with his head down and his hands clenched between his legs. David looks worried. He runs his hands through the back of his head and looks to the sides. He remains with his head down until the monologue starts. (Start monologue) He gets up slowly and walks to the front right looking at the ceiling and the walls. He stops at the back right and looks at an imaginary calendar taped on the wall and slowly walks back to his chair. (Double bell) he sits in the same chair lowers his head and rests his clenched hands between his legs. David's monologue: I can't believe I'll be leaving this cage tomorrow. I'll be free to do what I want, when I want. How come I'm not happy? From now on I'll have to carry a big label that identifies me as a criminal. I know it's not gonna to be easy. I'll have to walk a tightrope to survive in the outside world.

2—Staging Instructions and Stage Set Up

Rev. Crane (Rev) visits David is in his prison cell. He talks to him about freedom.

David is sitting at the edge of the front chair with a curved back and his arms supporting his face. He's lost in his thoughts. Acts surprised when he hears the door open and sees Rev. entering from the right. David stands when Rev. is a few feet away from him. (Double bell) David points at the front of the chair to Rev, they both sit. David sits with the weight of his body away from Rev. He seems bored but polite. (Double bell) David gets up upset when Rev. asks him how does he feel about himself. David paces gesturing with his arms as he answers. (Bell) Rev. gets up and takes command of the space. David stands looking at Rev. as he listens, (Double bell) David sits again. Rev. paces and motions with his hands as he talks. (Bell) Rev. sits after asking David if he a/ants him to bless him. David gives him his hands. After the short prayer Rev. gets up and exits stage right. When Rev. leaves David sits again with his curved back and his hands supporting his head.

Dialogue between David and Rev. Crane: Rev. Crane: Hi David, They told me at the warden's office you'd be leaving tomorrow. So I thought I'd stop and see you before you left and ask you about your plans. David: I want to go to school and make money. I tried to do that before, but I ended up quitting. Rev. Crane: Why did you quit? David: I had too much pressure at the time, and I couldn't deal with the problems. Rev. Crane: Do you think it'll be different this time? That once you leave this prison and make money you'll be free? David: Well yea! That's why I want to make money, to be truly free. Rev. Crane: Most guys in this place, and even outside, think like you do. They think they'll be free if they have lots of money and can do whatever they want. But what they don't understand is that money can only buy possessions. Buddha said that nothing, and that means not even money, can save us from suffering, from falling ill and dying. But you're young and you probably haven't given much thought to things like that. David: That means I can be free while I'm young and healthy, as long as I stay out of trouble? Rev. Crane: Well, yes and no. True freedom takes more effort than that. Right now you know you're not free because you can see and touch the walls of the prison that holds you. But there are other prisons as well. “Our own bodies and minds are prisons if we just follow them blindly. And most people do. They just follow their whims without question, always assuming that what they feel is real and what they think must be right.” (Krishnamurti, At the Feet of the Masters 11-14) Tell me David, how do you feel about yourself now that you're getting ready to be free? David: Well how am I supposed to feel after society has labeled me as a criminal and there's nothing I can do about it? How am I supposed to take it without feeling angry and frustrated? Rev. Crane: That's exactly what I'm talking about. What do you mean by society? Who are these people and how do you know what they think? You're already feeling angry and frustrated by the opinions of people who don't even know you. If you don't question the thoughts and emotions that your mind is feeding you then it won't be long before you end up in prison again. This is a complicated concept. Look, I just came to tell you that I have a little place downtown where I help people like you find the path of right living. Her,e's the address. I hope you come by. Don't wait until your life gets out of control. David: I don't understand very well what you're talking about, but thanks anyway. Rev. Crane: Do you want me to bless you before I leave? David: Well, Ok ah. Rev. Crane: Just give me your hands and listen. May the light in you, see the light of God, in every creature you meet, for the good of humanity. Goodbye David and good luck. David: Bye Reverend Crane.

At this point the play is stopped for discussion of material presented so far.

THE ROAD TO FREEDOM.

Q During the next few minutes we are going to talk about freedom. Why were David and Rev. Crane talking about freedom? Sample Response: Because David was about to be released from prison. Q Why does society incarcerate people that break the law? Sample Response: To punish them, or to keep them from hurting other people. Q How do you think society expects people to act? Sample Response: Society expects people to respect other people's lives' and possessions; act responsible, and work or

do things that benefit the community. Q People that do not do what's expected are rejected by society. Do you think that pushes them to become criminals? Sample Response: Validate participant's response. Following is an example of an expert opinion narrated by the trained professional. Doctor Stanton E. Samenow says that the criminal is the one that rejects society first. Criminals like to say they're the ones being rejected by everybody. By their parents, their neighbors, their teachers and their employers but they don 't say why they're being rejected. They don 't say that they find responsible people stupid, boring and dull. (pg 13) The questions and answer session resumes as follows. Q David was upset because as a convicted criminal he was not going to be accepted. How do convicted criminals in his situation behave around others? Sample Response: (Validate participants' response) Following is another example of an expert opinion narrated by the trained professional. Dr. Samenow in his years of work with criminals has concluded that it is they who threaten and defy everybody that crosses them. They are sneaky and study people to find their weaknesses and take advantage of them and like to play power games. While others act charming and helpful just long enough to gain people's trust then swindle or conn them with their lies to get what they want (pg 13-14

The question and answer session resumes as follows:

Q Do you think people like David are determined and willing to work hard and sacrifice to get what they want? Sample Response: (Validate participant's response) Following is another example of an expert opinion narrated by the trained professional. In his years of experience, Dr. Samenow noticed that people with criminal tendencies think “Why should I work as hard as others when I can find an easy way out The question and answer session resumes as follows. Q How do you know if a kid is heading the wrong way or if he is on his way to become a criminal? Sample Response: By the kind of friends he has. Following is an example of an expert opinion narrated by the trained professional. Dr. Samenow said that kids choose the company of people they like and admire.” He also says that contrary to what most people think, kids don't get into crime, use drugs or alcohol because of peer pressure. He says that problem kids choose the company they keep and the status they want to have with their peers. But when these kids are held accountable for their actions they quickly blame others by saying “my friend or friends got me into doing it.” Or “my friends said it was OK”. (pg 52-53)

The question and answer session resumes as follows.

Q Think of your own childhood. What were your friends like? Why did you choose them as friends? Sample Response: (Validate participants opinions.) We chose friends that are interested in the same things we are or that like the things that we like. Q What kept you from fitting in with other kind of kids? Sample Response: I was not like them. Didn't like what they did. Q Do you think that to fit in or be accepted by others you have to be and think like them and give up your freedom? Sample Response: (Validate participant's response) Q What is freedom? Sample Response: One simple way to define freedom is not having control over our lives. Q Do people in jail have control over their lives? Can they be victims of other people? Sample Response: Yes Q Can you have freedom without having control? Sample Response: No. Q Do you have control over your life? Sample Response: (Validate participant's response) Q Aside from being in jail, what else keeps people from being free? Sample Response: Not having money, being ill, having to work, family obligations etc. Q What happens when people depend on others for support? Who is in control? Sample Response: Whoever is supporting them. Q How can people have control over their lives? Sample Response: By being independent and able to support themselves. Q Does money guarantee freedom and happiness? Sample Response: No Comment: People that are sick no matter how much money they have don't have control over their lives. Money cannot buy people extra days of life. Even people with lots of money get hurt by others. Q Rev. Crane told David that our own bodies and minds are prisons if we just follow them blindly. What do you think? Sample Response: (Validate participant's response) Following is another example of an expert opinion narrated by the trained professional. It is true because most of us are controlled by our body and our mind. Every time we think about doing something, we usually do it to please either our body or our mind. For example we want to eat certain foods to please our body, or want to watch certain TV shows or movies to please our mind. (Krishnamurti, At the Feet of the Master pg 11)

The question and answer session resumes as follows.

Q Think of a time when as an adult you could come and go as you pleased. Did you feel completely free? What was controlling you at the time? What problems or worries kept you from enjoying your freedom? Sample Response: (Validate participants' response)

Following is another example of an expert opinion narrated by the trained professional. According to Krishnamurti, we cannot be free while being obsessed with certain behaviors or when we are overwhelmed with problems and worries. (Thinking Of These Things, pg 10)

The question and answer session resumes as follows. Q Spiritual philosopher Krishnamurti said that wanting things in life also limits our freedom. People that were after power and money had to work hard to get it. Political and religious leaders also had to work hard to get the position they wanted. Krishnamurti said that the moment we decide to go after something in life we are giving up some of our freedom. (Thinking Of These Things, pg 10) Do you thing that to be free we should not have goals or want things in life? Explain why. Sample Response: (Validate participant's response) Q Is Krishnamurti saying that people that don't have goals or don't work have more freedom than those that do? Sample Response: No he says that people that don't have goals or don't work are not free because they are controlled by their body and mind. Q Aside from wanting things how else can our body and mind control us! Sample Response: By overwhelming us with problems and worries. Q We all have worries and problems at one time or another and we all deal with them in different ways. What do you usually do when you are worried or have problems? Do you feel you are in control of your life? Sample Response: Get high; put my problems and worries in God's hands. Take care of my problems until I solve them. Following is another example of an expert opinion narrated by the trained professional. Getting high only makes us forget about the problems not, solve them. Putting our problems in God's hands doesn't mean that we can sit back and wait for Him to solve them. Tackling a problem will not keep new ones from coming up. Q So what can we do to have control over our lives and be free? Sample Response: (Validate participant's response)

Following is an example of an expert opinion narrated by the trained professional. Spiritual philosopher Krishnamurti said that to be-free we need to make an effort to: Understand our environment. A definition of environment can be our surroundings that includes people places and things that affect our lives. These can be close to us or as wide as the world and. Understand who we are from moment to moment. (Thinking Of These Things, pg 11) The question and answer session resumes as follows. Q What kind of life do people that like to break the law have? Sample Response: They will continue in a life of crime regardless of the consequences commit suicide or do things to destroy themselves change their way of thinking and do what society expects of them. Q What kind of life do you think you'll have if you continue to break the law and are controlled by your environment and yourself? Sample Response: (Validate participants response.) Q Has anybody ever told you “Believe me; I know what's best for you”? Have they always been right? Give example. Sample Response: (Validate participant's response).

Following is another example of an expert opinion narrated by the trained professional. Even people with years of experience and experts in their field can be wrong. For example in the 1990 's many doctors were prescribing cocaine to people with morphine addiction. And you can imagine the results. The question and answer session resumes as follows. Q So if experts on the field cannot be reliable and our body and mind cannot be reliable. How do we know what's right or what to do to free ourselves? Sample Response: (Validate participant's response)

Following is another example of an expert opinion narrated by the trained professional. That's why Krishnamurti said that to be free we need to be intelligent and: 1) Stop accepting other people's ideas and beliefs without questioning them first. 2) Stop doing things just because everybody else does. 3) Question our beliefs all the time, and without fear and 4) Understand that all our problems and worries are created by our own expectations. (Thinking Of These Things, pg 11) THE DISCUSSION IS STOPPED AT THIS POINT AND THE PLAY IS RESUMED AS FOLLOWS: 3-Staging instructions & stage setup

Mary Brown, David's mother, is drunk and blames him and his sister Suzanne for her misfortunes. David enters from stage right with a fast food package. (Double bell) He sits the package on the table and looks at Mary irritated. Mary is sitting at the table facing the audience. Her left elbow is on the table holding up her head. Her right hand is holding a glass of alcohol or a bottle. She acts like an angry drunk. At times she waves her hand around ii anger, exaggerating her movements due to the alcohol. David turns around slowly rolling his eyes and shaking his head. (Double bell) David shoves the package off the table and stomps out exiting stage left. Dialogue between David and Mrs. Brown: Mrs. Brown: I don't know why you kids turned out to be like this. I worked all my life to give you everything you needed, and this is how you repay me. You both destroyed my life. It's like I'm buried alive. Max was my only support and now, he's gone. 4-Staging instructions & stage setup Narrator talks about Mary's love life with Joey, David's father and Max his step father. Begin the scene with both Joey and Mary standing at center stage they are facing each other in frozen position. He looks angry and is standing with his chest and arms up and clenched fists. She looks meek & stands with her knees bent and her arms open to the sides looking at him as if pleading. (Double bell) Mary grabs a pillow from prop table and places it on her belly. She shows it to Joey. Joey begins to pace putting his hands on his hips. He acts according to the narration. He picks a guitar from prop table looks at it with longing eyes and puts it down again. Then he walks around shoving and throwing imaginary objects. (Bell) Joey begins to hit Mary. She falls and curls up on the floor. (Bell) Joey runs and exits stage front right. (Double bell) Mary gets up and holds the pillow like a baby. (Double bell) Mary puts the pillow at the prop table and walks to the front left to meet Max who just enters stage left. (Bell) Max uses his pointer finger to order Mary (like a dog) to go to the back. She moves quickly and gets her purse from the prop table. Max snatches the purse from her hands. He uses his finger to order her (like a dog) to sit. She obeys. He takes a few steps to front stage stops and counts the money. Narrator's Monologue: David's parents had moved from Atlanta shortly after they married. His father had used to lose his temper all the time. He would start by swearing, then he would push David's mother around. David remembered crying, holding onto his father's trousers, trying to make him stop. Joey would eventually come to his senses and beg Mary for forgiveness. But one evening, Joey lost all control of himself. He became enraged when Mary told him that she was pregnant again. He was working long hours in a job he hated to support the family. Another child meant more expenses and a second job. He'd always dreamed of becoming a famous guitar player. A bigger family meant being doomed to a life without dreams. That evening his rage was so great that David's crying would not stop him. He started hitting Mary with everything he found at hand. Her screams, alarmed the neighbors. They called the police. Mary was taken to the hospital. The doctors said it was a miracle that her baby survived. Joey managed to evade the police but that was the last time David saw him. He disappeared leaving them with no money. Mary managed to support them by cleaning houses. David was only four. The baby was born premature but healthy. Mary named her Suzanne. Two years later, Mary met Max. Her low self-esteem made her needy for acceptance. She clung to Max. Max took advantage of her weakness and controlled her by threatening to leave and by isolating her. He controlled what she did, who she saw, who she talked to and where she went. By then she had a steady job in a hotel cleaning rooms, all Max was often unemployed. He would take away her paycheck, claiming she didn't know how to manage money. AT THIS POINT THE PLAY IS STOPPED FOR DISCUSSION OF MATERIAL PRESENTED SO FAR.

FINDING YOUR WAY INTO THE DARKNESS:NLP PRINCIPLES

In your previous discussion we learned that true freedom comes when we use our intelligence to: Understand our environment. A definition of environment can be our surroundings which includes people places and things that affect our lives. These can be close to us or as wide as the world and. Understand who we are from moment to moment. (Thinking Of These Things, pg 11).

Now I am going to give you some tools that will help you understand how these two forces dictate every aspect of your life. (Give handout with NLP principles and blank Behavior and Self diagram) Professional trainer will instruct participants to fill in their copy of the diagram)

NLP Principles: Reality is not always what we think it is. (Write Self on the top right side of the diagram) That's why we all have different opinions because our realities are different; our lifestyles are different from neighborhood to neighborhood, from city to city, from country to country. All of us have our own limited view of reality.

The way we communicate dictates the response we get. (Write Behavior on the top left side of the diagram) Q How do you react when a person talks to you in a rude and threatening way? How do you react when a person talks to you politely and with respect? Q Besides using words, and tone of voice, what other things do we use when we communicate with others face to face? Sample Response: Our hands, eyes, torso, and legs; in other words our whole body. * Trained professional comment: So communication is not just a choice of words or tone, it is the way we present ourselves to the world.

Our minds and bodies are connected and directly affect each other. ((Write Who we Are on the center of the diagram) Q What kind of driver are you? Happy or mean? How is your mood reflected in your driving? How does your mind react when you see someone cut you off? Do you get tense, hostile? *Trained professional comment: That means that our thoughts and actions feed on each other. We react and respond to life based on, what we think and justify what we do. Language is a picture of our reality. (Point at Behavior) When I say the word “drunk”. What picture comes to mind? Q Do you see yourself partying or having fun?Or do you do you see yourself or someone you know sick, arguing and throwing punches? *Trained professional comment: We all have different opinions on many things based on our experience. Under different circumstances we can change our behavior. (Point at Self) As humans we can live in the coldest and in the hottest places. People that live in these places adapt their behavior to accommodate the climate. As humans we can also adapt our behavior to comply with social requirements. Just think how different children behave when they're playing at home than when they're in school or church. Q Can you think of other things we as humans can adapt to?

Sample Response: climate, conflict, bills, different lifestyles, rejection, etc. Nobody does anything that they don't think is the right thing at the moment. (Point at Self) Q (Ask three participants one at the time). Tell me what were you thinking the first time you used drugs? Sample Response: That I wasn't going to get hooked. That it was going to help me forget about my problems. That's a thing all kids do. *Trained professional comment: There were three basic reasons behind all our bad choices. Ignorance, (I wasn't going to get hooked). Selfishness or self centeredness (angry at the world.) And laziness (everybody said it was OK). Every bad choice we make is based on: ignorance, self centeredness and laziness. Q Think about the popular saying “Show me your friends and I'll show you your future.” Why do addicts chose to hang out with each other? Sample Response: To get drugs, to be with people that think like them, to be with people they admire. (Drug dealers) Comment: Link the answers to one of the three basic reasons we just discussed. Everybody has the ability to change. (Point at Who We Are) Q Ask one of the participants if they drive a car. Now ask him if he has or could drive a moving truck? Sample Response: (Validate participants' response) *Trained professional comment: That means that we can apply what we already know into something new. A criminal may change the way he commits his crimes to hide them better or use his bad experiences in his life of crime to change into a law abiding citizen. What we do is more important than what we say. (Point at Self) Q What other phrases do we use to say this? Sample Response: Walk the talk, Talk is cheap, Actions speak louder than words, etc. Q How can you tell what a person is all about? How long does it take you to figure them out? Sample Response: (Validate participant's response) If what we are doing doesn't work we need to try something else. (Behavior) Imagine you are in the freeway and the traffic is not moving. You are close to an exit lane. Q What do you do? Sample Response: Exit. Q Why don't you just stay in the freeway? Sample Response: Because I can move faster in the feeder road. *Trained professional comment: So by choosing to exit the freeway you changed a situation that wasn 't working for something that worked better for you.

Who we are and what we do are two different things (Present Behavior & Self Diagram). (Who We Are) Write BEHAVIOR & SELF on their respective side of the diagram and explain; You have yourself and then you have your behavior. Q Have you ever changed your opinion about someone once you learn more about their behavior? * Trained professional comment: Behavior and self are very different things and we are going to identify one from the other with the help of this diagram. (Give participants a copy of the Behavior & Self Diagram) Now tell them to use the diagram to figure out where each of the principles fall in the diagram) If we are not happy and healthy we need to look at ourselves and our behavior and make changes. (Who We Are) Q What is keeping you from enjoying life? Sample Response: Stress, problems, having to please others, etc. Q Can a person with stress, health problems, financial problems, and problems with relationships enjoy life? Explain why. Sample Response: No, because their life is too messed up. AT THIS POINT THE DISCUSSION IS ENDED AND THE PLAY IS RESUMED

5-Staging instructions and Stage setup: David argues with Mary and has a flashback of the day he killed Max, his step father. Mary is,sitting at the table while David is leaning on the right side facing her. They are both arguing. (Bell) Mary gets up and walks to the back center. She looks sad and sits on the floor with her arms around her chest.(Double bell) David sits at the table after Mary leaves. He looks down holding his head with his hands by the temples. When the music changes Max enters stage front left. David acts surprised when he sees him coming. (Bell) Max looks angry and walks with his chest up and his fists closed. He paces angrily as he talks to David. (Double bell) David sits leaning his body toward Max and responding to his words by gesturing with his hands. Max pulls David up by grabbing him by the neck of his shirt. (Double bell) David gets a knife from the table and stabs Max. Max falls on the floor and David stands frozen looking at him. (Bell) Mary gets up and runs to join them. She grabs her face and shakes it in disbelief. She drops on her knees next to Max and begins to scream. David takes a few steps back and looking down at them. Dialogue between David and Mrs. Brown; and David and Max. David: But how did Max help you? You were the only one that worked around here. He didn't do anything but get drunk and high. Mrs. Brown: You've always attacked Max even though he raised you. He was like the father you never had! Narrator: David was relieved when Mary left the table. He noticed how she struggled to get up from the chair. When she got up, she walked with a curved back and with her arms hanging from her shoulders. She had aged. He felt old himself, even though he was still in his twenties. His memories took him back to that day when their lives took that tragic turn. David: After all these years, here I am sitting in the same place, waiting for Max to barge in again. It feels as if it was yesterday. Being in this house makes me re-live it all the time, and it doesn't matter whether I'm awake or sleeping. Max: I don't know what your damn sister told you, but it's not true. I'm not gonna to let you bastards put me in jail. Suzanne might be 13, but you've seen how she acts around boys. She must have gotten pregnant by someone else. If you go to the police, I swear you little mother, I'll come back and kill ya! David: I believe my sister, and I'm not afraid of you. Ever since you came to live with us you've beat me up over and over. But this time you've gone too far. You hurt my little sister and you're going to pay. You've marked me for life when you broke my hip but now I don't care if you kill me. I'm done being afraid of you. Max: We'll see. Get up you little bastard and I'll show you something to be afraid of. Mrs. Brown:. No, Nooo! 6-Staging instructions and stage setup Narrator talks about child victims of sexual abuse. Several people are on the stage representing different emotions. Woman #1 looks self conscious about her body. She squats in a chair. With a curled up her body she grabs her head and pulls her clothes down trying to cover her whole body. Man #1 stands at front right stage he looks disturbed and holds a pillow and twists it as if trying to kill someone. Woman #2 looks fearful. She walks around the stage looking to the sides every time she takes a step. Man #2 looks lost or confused. He moves rapidly around the stage and stops suddenly. He looks around and continues to move rapidly without noticing the other people on the stage. Narrator's Monologue: Girls with stepfathers are 7 times more likely to be sexually abused than other girls. But only 1 out of 10 sexual assaults are reported to the police. Victims are subdued not only by physical force, but also by verbal abuse and threats. Sexual assault is always committed by someone who is in a position of greater power than the victim. Although most sex offenders are male and most victims are female, there are still a large number of sex offenders that are female assaulting other females and males. Male sexual assault victims rarely report their assault.

AT THIS POINT THE PLAY IS STOPPED FOR DISCUSSION OF MATERIAL PRESENTED SO FAR.

CHILDREN IN VIOLENT HOMES: During our previous discussions we talked about freedom and the difference between our behavior and our selves. Now we are going to see how emotions connected to childhood experiences affect our behavior. Q How does David's childhood experiences influence the way he saw himself? Sample Response: He saw the world as a cruel place with little to offer. Viewing himself as a person with little or to value. (write ENVIRONMENT, THE WORLD & PEOPLE also write EXPERIENCES in the BEHAVIOR side of the diagram) Q Can David's mother be partly responsible for his drug addiction? Explain why. Sample Response: No, even though Mary was not a good role model for David most children don't see themselves as extensions of their parents they try to be different from them. (Point at PERCEPTION and EXPECTATIONS on the self side of the diagram and have students read explanation) Q What emotions were going through David's mind when he killed Max? Sample Response: He could have been surprised, angry, afraid, hurt, aggravated, frustrated, bitter, humiliated shocked, furious, etc. Q Aside from violence and neglect what other crime is committed against children? Sample Response: Rape. Q Most rapist and serial killers use their troubled childhood as a justification for their actions. Do you think that's a valid justification? Explain why. Sample Response: No. *Trained professional's comment: (Point at the words ACTIONS and the word EXPERIENCES on the behavior side of the diagram and ATTITUDES, in the self side of the diagram) Following is another example of an expert opinion narrated by the trained professional: Doctor Stanton E. Samenow pointed out that “Fortunately for society, most children who suffer neglect or abuse do not become criminals. Most people don 't realize that some criminals come from families where the parents are, stable and responsible (pg 48-49)

The question answer session resumes as follows:

Q From what you know, do you think rapists are controlled by their emotions? Explain why Sample Response: No. Rape is usually a cold calculated act. Q Look at the Who We Are on the diagram and tell me which items on the list have supported the idea that men are superior to women? Sample Response: religion, culture, tradition, society government, family. Q How do this difference between men and women influence the rapist's and violent criminal's actions Sample Response: Following is another example of an expert opinion narrated by the trained professional: Psychotherapist Terrence Real, identified three possible reasons why men rape other men. They might do it to share their physical and emotional trauma with other men thus making their own abuse as something natural. Or they might do it to make other men prove their capacity to resist pain. Another reason might be to demonstrate their power over them. (pg 76) Trained professional gives individual participants the following instructions: (write the word ADAPTATION under EXPERIENCES in the BEHAVIOR side of the diagram) Following is another example of an expert opinion narrated by the trained professional: According to literature provided by the Attorney General's office, men rape women for totally different reasons than men. They rape women to put them in their place, to devalue them and to have control over them. They also rape them to shame them and make them feel defective. (point at ENVIRONMENT). Write WHO WE ARE in the center, then FAMILY, GOVERNMENT, SOCIETY, RELIGION, CULTURE, TRADITIONS under)

The question and answer session resumes as follows:

Q What can a rapist or a serial killer do to stop hurting others? Sample Response: Change his beliefs, Seek professional help. Not give in to his urges. Trained professional instructs participating individuals to point at the words IMAGE under ENVIRONMENT in diagram

Q What emotions are common among rape victims? Sample Response: (Validate participants response) Trained professional comment: Rape victims go trough a number of emotions like shock, numbness, denial, disbelief, anger, fear, powerlessness, guilt and self blame. They also experience low self esteem and lose their trust in other people as well as injustice. (Add BODY & MIND under PERCEPTION and add FEELINGS & REACTIONS under ATTITUDES on the SELF side of the diagram. Then point at ENVIRONMENT & EXPERIENCES in the BEHAVIOR side of the diagram.) Q How do people act as a result of these emotions? Sample Response: they would be distrustful, become violent, use drugs, become hyper macho, withdrawn, overachiever etc. Q What can a person who was raped, abused or neglected as a child do to free him or her,self from those emotions? Sample response: Forget about the incident, get counseling go to a support group, pray, get medication. Etc. *Trained professional's comment: Childhood scars do not always have to be from things as serious as rape, abused or neglect. Children can be scared by unkind comments or cruel games. The second objective of this class is to teach you new ways to deal with your emotions. Now we are going to do our first NLP exercise. It's up to you to decide whether it works for you or not, all we are asking is for you to be open to it. AT THIS POINT THE DISCUSSION IS ENDED AND AN NLP EXERCISE TO PROCESS CHILD ABUSE IS DONE. AFTER THE NLP EXERCISE THE PLAY IS RESUMED 7-Staging instructions and stage setup Narrator talks about David's childhood. David remembers Rev. Crane's words. David is sitting at left back stage. He is slumped in the chair smoking a joint. Mary is standing with Max at the middle center looking meek with knees bent and chest in. Max stands proud next to her in frozen position. (Bell) Mary walks to David and points at Max as if talking about him. David gestures as if accusing Max. Max stands sideways looking at them from a distance. Narrator indicates when Mary joins Max they both walk to center front. As she walks, Mary motioning with her hands as if apologizing to the audience. Max looks at her with contempt as he walks. (Bell) Mary walks to David and grabs him by the arm. She forces him to his knees and makes him pray. After scolding David she joins Max. When he sees her leave, David puts his chin to his chest and curves his back. (Double bell) David stands with difficulty and walks to front right stage limping. He gets a joint from someone in the audience goes back to the chair and slowly relaxes as he smokes. (Double bell) David drops the joint and looks up and freezes when he hears Rev. Crane's words. Narrator's Monologue & Rev. Crane's voice: Narrator: David had been using marihuana and other drugs since he was twelve. That was around the time he became interested in girls. His mother tried to convince him that his injury had been an accident and not Max's doing. She ignored his cries and accusations. With her actions, Mary made him believe that he was not worth attending to. She repeated Max's story to the police and everyone else with conviction, as if she had seen the whole thing. When David was able to walk again, she took him to the church to cast out his demons. Nobody believed David. Since then, he felt depressed and unworthy, he felt so disgusted with himself that he felt he deserved to be abandoned and unloved. Max not only took away his ability to run, but his manhood, his power to be heard. David became timid. He was afraid of the girls' rejection, so he escaped to drugs. Shortly after he got out of prison, he looked for his contact and convinced him to give him some drugs to sell. But instead of selling them he smoked most of it himself. He lit a cigarette and relaxed his body in the chair as he started to feel the effects. His mind wandered and the words of Rev. Crane came back and resounded in his brain. Rev. Crane: But there are other prisons as well. Our own bodies and minds are prisons if we just follow them blindly. And most people do. They just follow their whims without question, always assuming that what they feel is real and what they think must be right. Tell me David, how do you feel about yourself now that you're getting ready to be free?

8—Staging instructions and stage setup Suzanne is on the street talking with her friend Jenny when David joins them. Suzanne and Jenny are standing at the street looking for johns and talking. (Double bell) David enters stage left while Suzanne points him out to Jenny. David looks at Suzanne but stops at a distance from them. When the narrator speaks they all freeze. Dialogue between Suzanne and Jenny: Suzanne: I've been trying to stay clean because I wanna get my kid back. Jenny: I didn't see you try very hard last night when those dudes offered us coke. If you get your kid back you won't be able to party anymore. Are you sure you're ready for that? Suzanne: Well, it won't be easy, but if I find the right man I might be able to do it. Look, here comes David. Be nice to him, maybe he'll share some of his stuff with us. Narrator: As David approached Suzanne, memories of their younger years flooded his mind. He remembered his mother giving him safety instructions as she headed out to work. Suzanne had just learned how to walk and followed him like an orphaned duckling. 9-Staging instructions & stage setup Narrator describes Max relationship with David and how he manipulated and controlled Mary and Suzanne. Max and David are standing at left front stage. Max pretends he's boxing with David. David wants to get away from him but Max blocks him. Mary tries to separate them but Max acts innocent and she turns her back and walks away. (Bell) Max grabs David by the neck and pins him against a wall or the floor. David looks scared. (Bell) Mary turns and faces Max and David. Max grabs her by the arm and walks with her to center right as if explaining. David rubs his sore neck and chest. (Bell) Max takes a bottle from the prop table and gives it to Mary. She takes a big drink and smiles. She lifts her arms as if dancing and Max claps encouraging her as they exit the stage at the left. (Bell) Suzanne enters stage at the right. She is crying. David walks to her and puts his hand on her shoulder. They walk to the center middle. Suzanne covers her face with her hands and David puts his hand in her hair.

Narrator's Monologue: Whenever David reached out for his mother, Max would butt in and call him a “Mamma's boy”, a “faggot”, a “wimp”. Then he would tell Mary that she was babying him and robbing him of his masculinity. He'd say David needed to be a man; that he needed to learn to be a fighter if he was going to survive in a tough world. (Real, pg. 124) Max liked to hit David hard. He often ended up pinning him against a wall or the floor until he was completely immobilized. Then he would stare at David from just inches away with his wild eyes, and say through clenched teeth so that only David could hear: “I could kill you right now if I wanted to”. When David's mother intervened he would claim he was just playing, or showing David how to defend himself from school bullies. He'd got David's mother into drinking and going to bars with him. It was a new experience for Mary who didn't know other ways to have fun. She became absorbed with the night life, paying little attention to David and his sister. Soon after Suzanne turned 12 she stopped confiding in David. A year later she was pregnant. She was only thirteen! And she told David that Max had been abusing her for some time and she was too scared to refuse him or to tell their mother.

10—Staging Instructions and Stage Setup

David expresses his feelings for Suzanne and the last time she visited him at the jail. Jenny and Suzanne are standing again at the center middle and David is watching them from front right. (Bell) Jenny exits stage front left. Suzanne takes out the wig or boa and puts a pillow in her belly. She moves to the chairs and sits in front of David. He sits facing left. They put their right hand to their ear as if talking on a phone. (Bell) Suzanne gets up and slowly leaves the stage at front right. David turns his torso toward her and watches her leave. When she's out of sight he puts his head down and locks his hands between his legs. David and Suzanne: David (thinking) She didn't have anybody to turn to but me and I let her down. Suzanne hadn't been a minor my mother couldn't have forced her to give up the baby up for adoption. Then she'd had to face the fact that it had to be Max's baby and the baby gone she could go on pretending that Max wasn't responsible. Pretty soon, Suzanne got pregnant again and I don't know what drove hereto it. Maybe she was trying to take control of her life, by choosing herself who she could have sex with. Suzanne: I'll never forget what you did for me, and I'm very sorry you had to end up in here. You're the only one that believed me. David, I'm gonna have another baby, and this time I'm gonna keep it. I'm not gonna let mom take him away.

David: That was the last time Suzanne came to visit me. Before I was moved to the state prison, I learned from a neighbor in jail that my mom had kicked Suzanne out and that she'd gone to a runaway shelter. He said he'd heard Suzanne had a miscarriage and lost the baby. I think that was the best thing that could have happened. I mean why bring another loser into this world. I was supposed to take care of my little sister, and I didn't do it. Now she's here, getting high and turning tricks and I'm too messed up to help her.

11—Staging Instructions & Stage Setup

David and Suzanne talk while Jenny looks for clients. Suzanne gives David money before leaving with Jenny. Suzanne and Jenny are standing at the center back. David enters stage front right. They all meet at the center middle. (Double bell) David pulls out a joint and they al take turns smoking., (Bell) Jenny moves away a few steps back and continue smoking while Suzanne and David talk, (Double bell) David moves closer to Suzanne and she reacts by moving back keeping eye contact with David. (Bell) Jenny moves closer to them. Suzanne and David move as if high. (Bell) Jenny regroups. She pokes Suzanne in the shoulder and Suzanne gives David money. He watches them exit stage right. David runs his hand by his hair and walks slowly to the center back. He stands facing the wall and glances from side to side.

Dialogue between David and Suzanne: Suzanne: Hi, David, what are you up to? Got any goodies, or some cash to spare? David:. Funny you should ask. You know I only got out a few weeks ago. I hit up Dog for some stuff on credit. Know, getting a regular job is hard enough, and thought I could sell some and maybe make a little money in the mean time. But being back in the house with mom drinking all the time really stinks. I feel trapped and I've been burning up most of the stuff myself. I need to give Dog his money tomorrow and I don't have anything for him.

Suzanne: So mom let you come back home after what you did? David: Yeah. I think somewhere in her messed up mind she knows Max was messing with you, but she won't admit it. I, I can't stand being in that house, with her acting weird. I mean, I need to get my own place. As soon as I take care of this problem with Dog, I'm gonna find me a good job. When I do that, I want you to come and live with me and go back to school. Suzanne: You must be dreaming. What makes you think I want to go back to school? I'm past all that crap. I just wanna sugar-daddy that'll take care of me. A rich drug dealer who'll buy me a nice car, take me to fancy restaurants, and with enough money to buy me nice clothes and jewelry. Oh yeah, and with a big supply of my favorite goodies in the house. David: Now you're the one dreaming! Suzanne: Jenny and I met these dudes that are loaded. Yesterday they took us to their house. You should've seen the place! I think this guy Carlos liked me. It was his house. Maybe next week you'll see me cruisin' this sorry old neighborhood in a new sports car. Narrator: Many people build their lives on illusions. They escape the pain and despair of their lives by living in an imaginary world, refusing to see things as they really are. In time, they become slaves to their illusions. They don't understand themselves or the world around them. Their inability to figure out what they stand for allows other people to get into their heads and control them. As long as Suzanne viewed herself and the world in her distorted illusions, she was a prisoner of her own dreams. Jenny: Let's go Suzanne, it's getting late and we need to get ready for tonight. Suzanne: This should help keep Dog happy for a few days. David: All those years, waiting to be free. Now I have the time and nobody to hold me back; why do I feel like I'm still in prison? I can't go on like this. I need to be free, truly free.

AT THIS POINT THE PLAY IS STOPPED FOR DISCUSSION OF MATERIAL PRESENTED SO FAR CHILDHOOLD WOUNDS: Q Explain how David's attitude showed on his choices to make a living. Sample Response: He didn't think he could get a job so he decided to make money selling drugs. * At this point the trained professional instructs the individual to work on the Behavior and Self diagram by asking them to: (Point at FEELINGS & REACTION on the SELF side of the diagram and write PLACES AND THINGS under ENVIRONMENT and write ADAPTATION on the BEHAVIOR side of the diagram) Q What NLP principle supports David's choice? Sample Response: Number 6. Nobody does anything that they don't think is the right thing at the moment. Q Describe how Suzanne escaped from her reality. Sample Response: She lived in an imaginary world waiting for someone to rescue her. Trained professional asks participating individuals to point at the area in the Behavior and Self diagram where this falls into (PERCEPTION & MIND) Q The narrator said that “In time people that live in an imaginary world become slaves of their illusions.” What do you think she meant by that? Sample Response: She meant that she was trapped and would only do things that fed to her illusion. She was not able to see other ways to improve her life. Q Explain how children that live in violent homes show how they feel without saying it. Sample Response: They may regress and act like babies, suck their thumbs, wet their beds, suffer of stress related illnesses like headaches, ulcers, and blotching, feel depressed, suffer from anxiety, fear, and guilty. They may have learning problems or be overly aggressive and hard to control or very passive and introverted. Trained professional asks participating individuals to point at the area in the Behavior and Self diagram where this falls into (PERCEPTION, ATTUTUDES & ENVIRONMENT) Q What kind of destructive behavior do you think is common among children that live in a violent environment. Sample Response: They may become violent themselves and create new generations of families with violent behaviors, run away from home, get involve in school and street violence, abuse drugs and alcohol, abuse food, commit or become victims of sexual assault, commit or become victims of date rape. They may get involved in sexual harassment, pornography, or early pregnancy and become school dropouts. At this point the trained professional asks individual participants to write on the (SELF) part of the diagram under (EXPECTATIONS) the words REJECTION & ACCEPTANCE Then he asks them to point at PERCEPTION, ATTITUDES, ENVIRONMENT, ACTIONS & EXPERIENCES in the diagram) Q How do you think David and Suzanne saw themselves as a result of their family environment using the diagram? Sample Response: Suzanne and David learned that they were not important to anybody, that they deserved the abuse and that there was something wrong with them.

Trained professional asks participating individuals to point at the area in the Behavior and Self diagram where this falls into (PERCEPTION, ATTITUDES, ENVIRONMENT & EXPERIENCES)

AT THIS POINT THE DISCUSSION IS ENDED AND THE PLAY IS RESUMED

12—Staging Instructions & Stage Setup

David enters Rev. Crane's office. Rev. Crane talks to David about choices. Rev. Crane is sitting reading a book. David enters stage right limping and stops in front of him. Rev. puts the book down and looks puzzled at the sight of David. David hands Rev. a card. Rev. takes the card and leans on the back of the chair as he talks. He signals David to sit. (Double bell) David sits at the edge of the chair and bounces his leg. (Bell) Rev. stands and walks around the table. David follows him with his head and torso. Rev. stands next to David. David moves away his head and torso away from Rev. and crosses his arms and legs as he listens to him. (Double bell) David looks upset. He stands and paces as he talks. (Bell) Rev. sits and leans forward toward David (Double bell) David calms down and sits. (Bell) Rev. stands and goes to prop table to get two glasses of water. David follows him with his head and torso. (Bell) Rev. sits. David looks at him with curiosity and straightens up his chest.

Dialogue between Rev. Crane, and David. Narrator: Rev. Crane is sitting behind a desk when David walks in. He's reading a book and is startled when he sees David standing in front of him. He puts the book down and looks at the skinny young man, not very tall, nervously looking in any direction as if trying to decide whether to stay or go. David has a wrinkled card on his hand and shows it to Rev. Crane. David: You gave me this card the day I was released from state prison. You said you could help me. I need a job, and I thought you might know someone who'd hire me. Rev. Crane: I'm sorry, what's your name again? David: David Rev. Crane: Well David, there are special agencies that can help you find a job. I'm just a servant of God trying to guide people like you to the path of right living. David: I don't have time for repentance or Sunday school. I have real problems. Rev. Crane: I hear your frustration. But life has taught me that hard times are good teachers. I am not trying to brush you off, but I can't help you with your basic needs, frankly, I think it's time for you to grow. David: What do you mean grow? I, I may be small, but I'm not a boy anymore. Rev. Crane: Growing doesn't just mean to get bigger or older. Growth also means gradual expansion. (The American Heritage Dictionary Second College Edition pg 579) My mission here is to help people like you grow out of their old ways of thinking, to help them expand their choices. Face it, David, the way you've been dealing with your problems up to now has gotten you nowhere. That's why you need to grow, to have a plan and then take action, not just once but many, many times. A professor friend of mine used to drill that to his students. Every time they got discouraged he used to tell them in a solemn tone. “You are the owner of your destiny and the only one responsible for it.” (Alcantara Rodriguez, pg 21) David: I tried to have a positive attitude, but it's hard when all you get is rejection. I had definite plans for things I wanted to do when I got out of prison, but I can't seem to even take the first step. I can't find a job. Nobody wants to hire me, and I have to do what I have to do to survive. Let's face it, goals and things like that aren't for losers like me. Rev. Crane: David, you're not a victim of circumstances, you're just having trouble coping with life. But if you were able to do it when you were just a child, you can do it again now. Remember how you survived your first day of school? Or when you tried something for the first time? Life is always challenging us and forcing us to make choices. You're not the only one who's made some bad choices. We've all done it and no doubt we'll do it again. But looking back I can say in my own defense and in the defense of all the people who've made bad choices, the choices we've made were the best ones we knew how to make at the time. That's because all our choices are based on our experiences: on what we've seen and learned from our parents, other people, and from life. In other words our choices are the result of our past. You have lots of reasons for making bad choices, but the wonderful thing about it is that it's never too late to learn new ways. Well, I see I've got your interest, so be sure to remember this David; you can't change your past, but you can definitely change your future. The choices you make today, no matter how small they are, will shape your life for years to come. You can't continue to give in to pressure and do whatever you need to do to survive because that's not a good choice. You need to start planting the seeds of success today. You need to carefully weigh every choice you make. David: Do you mean I can still be successful, even with my disability and my criminal history? Rev. Crane: Yes, you can. I have no doubt. 13-Staging instructions & stage setup

Rev. Crane poses the age old question “Who am I”? and illustrates with his special lamp. Rev. Crane sits at his desk and David listens intently as he sits in front of him. Rev. begins to talk about the lessons of life and how David can learn from what he has to say. (Bell) Rev. takes his special lamp from prop table and places at the front of his desk for audience to see. He follows the narration and points at the different rays of light in the lamp. David leans forward very interested and watching intently. (Bell) Rev. stops looking at the lamp and leans back into his chair to speak to David.

Dialogue between Rev. Crane and David.

Rev. Crane: Now let's start your first lesson with an age old question. Who am I? You need to know who you are in order to free yourself from your own prison. Tell me David, have you ever asked yourself that question? Who am I? How do you describe yourself to others? Do you give them your name, your race; tell them what you look like? You tell them about a special skill or talent you have or do you tell them you're an ex-con? Who are you? If you've been describing yourself in terms of your body or your mind, you've been cutting yourself short because that's the least of us. David: What do you mean the least of us? When I was in prison I had no control over my life at all. The man controlled my body, my every movement. Rev. Crane: You're right, other people can control our bodies and our minds; but there's a part of us that nobody can control, a part that will always be free, and that doesn't get old, wear out or give in: that's our spirit. Let me show you what I mean with my special lamp. See how the light shoots out from the center in every direction of the glass ball? See how the blue light becomes red after bouncing back from the glass? This is a good example of how our bodies and minds control every aspect of our lives. How these two parts of our selves fight one another for control. See how the light shoots in every direction? “People that haven 't taken the time to learn who they are, are usually looking for meaning in their lives in all directions just like the rays of this lamp. They're looking for money, fame, love, fun, power, you can name each one of these rays something different. You can tell when the body is in control, when you don't feel like working or doing anything that requires effort, when all you want to do are things that give you pleasure. Don 't get me wrong, the body is an important part of our selves, but we need to see it like a car, a vehicle ready to take us wherever we want. We need to take care of our body, to keep it in top shape, because without a healthy body we wouldn't be able to come and go as we please. But a car doesn't drive by itself and neither should our bodies.” (Krishnamurti, At The Feet of The Master, pgs 11-14)

14—Staging Instructions & Stage Diagram

Rev. Crane tells David about the conscious and the subconscious mind. Rev. Crane sits at his desk and David listens intently as he sits in front of him. (Bell) Rev. stands and begins to pace gesturing with his hands as he talks to David. He gets a book from prop table. (Bell) Rev. sits and shows the book to David. (Double bell) David reaches out to ask for the book and flips through the pages reading as Rev. speaks. (Bell) Rev. leans back in his chair and continues to speak as he watches David read the book. (Bell) Rev. goes to prop table and gets another book. He raises his hands to show it to David then he reads from the book. (Bell) Rev. closes the book after reading the passages.

Dialogue between David and Rev. Crane.

Rev. Crane: Now our minds are a little more complex and there's still a lot we don't know about them. But for the sake of understanding, some scientists have divided the mind into two parts: the conscious and the subconscious. With our conscious mind we look at the outside world. We observe, learn, seek recognition and compete. The subconscious on the other hand is like our memory bank. It saves the memories of all our experiences along with the emotions we felt, from the time we were born. Did you know that every time we're confronted with new situations, or when we face a decision, our subconscious immediately goes into its memory banks and brings out old memories and emotions that relate to the new experience? It goes all the way back to when you were born. You start learning from the first day, everybody teaching you your role in society. If you conform you're valued and acknowledged, and the expectations are raised higher. If you don't conform you're rejected, and you're expected to do poorly, and your subconscious remembers all those events. It keeps the memories and emotions of all the times we've failed and all the times we've been rejected. That's why it's so difficult to try to do new things. Every time we try to do something new or try to change a bad habit we fail. Because our subconscious mind will tell us, “Why try?” “Remember what happened when you tried to do this before? Remember that you failed and how that made you feel?” “Do you want to have those horrible feelings again?” Studies have shown that our subconscious feeds us about 1,300 words a minute, and 70 to 80% of what it tells us are negative things about ourselves. My life took a dramatic turn when I learned about this in a book written by Krishnamurti, the famous spiritual teacher. I think it was called At the Feet of the Masters. He said that “the body and mind trick us into thinking that their desires are our desires.” (pg. 11) I got so interested in the subject that I got another one of his books, this one here. It's called Thinking Of These Things. In this book he talked about this a lot more. Let me read you this part: “to be ourselves is very difficult, because our minds tell us that we are despicable persons.” And here's more, “we think that if we could only change ourselves into someone worthy of admiration and respect, things would be different. Then life would be wonderful. But it never happens.” (pg. 11), So it's not surprising we have such a hard time accomplishing anything, considering that our bodies want us to sit idle and enjoy themselves, and our minds are telling us we'll never make it. (Krishnamurt, At the Feet of the Masters pg 11-14). So how can we feel good about ourselves? “Some people try to do it by creating fantasies or fake personalities, but that doesn't work, because the mask they wear in public disappears when they look at themselves in the mirror. So instead of pretending, or working hard to be perfect, we need to love and accept ourselves for who we are,” (Krishnamurti, Thinking Of These Things pg 10-13) which brings us back to that initial question, Who am I?

15—Staging Instructions & Stage Setup

Rev. Crane poses the age old question “Who am I”? and illustrates with his special lamp. Rev. Crane sits at his desk and David listens intently as he sits in front of him. (Bell) Rev. pulls out a paper with a list of moral virtues and shows it to David while he explains. David looks more at peace and content this time. (Bell) Rev. gets his special lamp from prop table and places it in front of the table for audience to see. (Bell) Rev. leans back into his chair away from the lamp and speaks to David. When the narrator begins to speak, Rev. and David freeze in a normal position. (Bell) Rev. stands up and so does David. They reach across the table and shake hands. (Double bell) Rev. sits again and David walks to stage front left. He looks up at the sky above the audience as he speaks. He takes a deep breath and lets it out slowly.

Dialogue between David and Rev. Crane.

Rev. Crane: We really don't stop and think when we learn that God made us in his own image; when we learn that we're his children. Some people don't even want to consider it because it sounds religious, but it really isn't. Religious people will accept it, but surprisingly, not many really believe it. How can we know ourselves if we refuse to accept the truth? If we're unable to see that your spirit and mine are made in God's image? If you don't believe me look at this it's a list of the moral virtues or God-like qualities. You have some of those qualities. “Just like you inherited some of your parents' traits, you 've inherited those God-like qualities from God himself; that proves that you are undeniably His child.” (Escudero, Our Spiritual Latent Powers). Whether you want to be or not, you'll always be connected to Him. David, “how do you think you'll be able to love and accept yourself if you don't know yourself, if you don't acknowledge that very important part of yourself?” (Krishnamurti, At the Feet of the Masters, pg 11-14) Now look at the lamp again and put your hand here at the top. See how all the rays suddenly unify into one strong one? That's what happens when our spirit is in control of our lives; when we surrender our bodies and minds to our spirit. Then all of our energy moves in one direction, like the light in this lamp. This focused energy is what gives us the strength and the determination to embrace life, to resist failure and to stand tall in the midst of adversity. That's why people go to church, to connect with their spirit. So, instead of trying to be like someone you admire who is also another imperfect person; try to be more like your maker. If you're allergic to church just practice the moral virtues. “Make those virtues your guide, but be careful not to do them to make yourself greater. The virtues can only be pure if they're done unselfishly.” (Escudero, “Our Spiritual Latent Powers”) I promise you David that when you do this, you'll be able to love and respect yourself for who you are. Narrator: David was looking at Rev. Crane as if wanting to absorb his every word. His experience with religion had not been good. He had lived hating and feeling sorry for himself. He had no memories of success. He never did anything to win the respect and admiration of others. He wasn't attractive or rich or smart, nor did he have athletic talent. He was just a frail looking man with a limp, with no job and no skills. But to learn that a part of him was perfect and pure, that even he was made in God's image, changed his perception about himself. He realized that he had something very valuable, something that could make him strong, in spite of his physical limitations. Rev. Crane noticed David's reaction and stopped talking. He looked at his watch and excused himself. Rev. Crane: Well David, I got so involved in our conversation I forgot the time. It's visitation time at the jail and I need to go. Would you like to join me? David: No thanks. I'm not ready to go back to that place, even if it's just for a visit. Rev. Crane: Why don't you come by and see me again? I think you'd like to meet the other seekers. We meet here every Tuesday at five o'clock in the afternoon. David: That seems too deep for me. I don't think I could do that, but thanks anyway. Rev. Crane: Then come and see me anyway. I'm here in the mornings and afternoons, except during visitation time at the jail. You know the times. Narrator: David said goodbye to Rev. Crane and walked out the door. He stopped before he got to the intersection because he felt compelled to look at the sky. It was around five in the afternoon. The sky was colored with a mix of intense and light blue with swirls of pinkish clouds. For the first time he realized that maybe he didn't really understand himself, and that he needed to make big changes in his life. Up to that time, nobody had taken the time to talk to him about life that way. He felt somewhat excited and confused as he tried to reconcile these new ideas with his old ones. David: I don't know what my future will bring, but I'm not going to destroy myself. As of this moment I'm making a firm promise to myself to seek every opportunity to learn more.

AT THIS POINT THE PLAY IS STOPPED FOR DISCUSSION OF MATERIAL PRESENTED SO FAR: RECOGNIZING THE SPIRIT Q What do you think Rev. Crane was trying to tell David when he told him he needed to “grow”? Sample Response: He was telling him that he needed to grow out of his old beliefs. Trained professional asks participating individuals to point at the area in the Behavior and Self diagram where this falls into. (ATTITUDE & EXPECTATIONS) Q What NLP principle was Rev. Crane referring to? Sample Response: To number 9. If what we are doing doesn't work we need to try something else. Q Rev. Crane also told David “You are the owner of your destiny and the only one responsible for it.” Do you agree or disagree with Rev. Crane's words? Explain why. Sample Response: (Validate participants' opinions). Q What NLP principle was Rev. Crane referring to? Sample Response: To number 7. Everybody has the ability to change. Q When David said: “Let's face it, goals and things like that aren't for losers like me”. How do you think he came with that conclusion? Sample Response: From his past experiences. Q What NLP principle explains David's comment? Sample Response: Number 4. Language is a picture of our reality. Q According to Krishnamurti, we will never be able to change ourselves enough to win the admiration and respect we need to reassure ourselves. (Thinking Of These Things pg 11) So how can we love ourselves if we cannot become who we want to be? Sample Response: By accepting ourselves the way we are, body mind and spirit. Trained professional asks participating individuals to point at the area in the Behavior and Self diagram where this falls into. (PERCEPTION) Individual participants are instructed to add BODY, MIND and SPIRIT on the SELF side of the diagram. Q NLP principle #3 says that our minds and bodies are connected and directly affect each other. Can our mind make our body to grow taller or change itself? So what can our mind do to change us? Sample Response: No. Our mind can only help us change our behavior. Q We know what body and mind can do for us. What do you think our spirit can do for us? Sample Response: Our spirit gives us the drive to improve, hope for better things, standing for what we believe is right, etc. Trained professional asks participating individuals to write the word SPIRIT under PERCEPTION on the SELF side of Behavior and Self diagram Trained professional's comments: Spirit could also be defined the essence of God in every living thing. A person's uniqueness can also be seen as his or her divine essence. Q When people talk about “moral virtues” what do you think they mean? Sample Response: Moral virtues are God like qualities that all human beings have but are not aware of having. Trained professional's comment: Instead of trying to explain them here is a list so you can see what they are. HAND OUT COPY OF LIST OF VIRTUES AND ALLOW PARTICIPANTS TO GO THROUGH THE LIST As you have seen, you are already expressing some of those God like qualities. So to be free we need to stop trying to be like other people. Instead we need know and strengthen the spirit part of ourselves. Trained professional asks participating individuals to point at the area in the Behavior and Self, diagram where this falls into: (PERCEPTION) Q We know how to use our body and our minds. Explain how Rev. Crane suggested we should use our spirit. Sample Response: He said that we should use our spirit to guide all of our actions. Q Besides guiding our actions, what else can our spirit do for us? Sample Response: (Validate participant's response) Trained professional's comment: Our spirit also gives us a different view of life than the one we have from our conscious mind and our senses. It helps us understand things that the mind cannot explain. Q We know we are listening to our mind through our thoughts and we know that w,e are listening to our body through our senses. How do you know when you are listening to your spirit? Sample Response: When we pray, when we go to church, when we listen to religious music etc. Following is another example of an expert opinion narrated by the trained professional: Most people think that by praying or going to church they are communicating with their spirit. But spiritual teacher G. Jinarajadasa explained that the only way we can communicate with our spirit is by doing things to make the world a better place. And that we need to do it without expecting anything in return. When we expect money, recognition, praise, appreciation, or the reward to go to heaven in return for our good deeds, we are being superficial. We are not communicating with our spirit or be able understand and appreciate life. (Reproduction from the book Divine Vision pg 94). The question answer session resumes: Q Now tell me about a time when you helped someone with no selfish reasons, just to help? Sample Response: (Validate participant's response) Q What did you learned from the experience? Sample Response: That I can make people happy, that I'm a good person, etc. AT THIS POINT THE MASTERY OF OBJECTIVES IS REVIEWED, THE FLOOR IS OPEN FOR COMMENTS AND THE SESSION IS FINISHED

### EXAMPLE 2

Second session begins distributing mastery of objectives handout to participating individuals. 1—Staging instructions and stage set up David is approaching his house and sees ambulances. He talks to the paramedic The stage is dark with only flashlights illuminating it to signify an ambulance nearby. The narrator begins to explain the scene as the lights flash. A chair with a pillow and covered with a blanket simulates a patient. A female paramedic is on center stage talking into a walkie talkie. David enters stage left limping. He looks at imaginary people walking diligently. He goes to the chair and uncovers the pillow, he acts surprised. (Double bell) David approaches the paramedic and asks her questions. He looks worried. Dialogue between David, paramedic and policeman Narrator: David was approaching the corner near his house when he saw police lights, and people running. That was not an unusual sight in his neighborhood, but for some reason he had a bad feeling about it. The vehicles seemed too close to home. He accelerated his pace even though his limp made his hip hurt. When he got closer he saw that in addition to the police cars there was a fire truck and an ambulance. He pushed himself through the crowd and saw two policemen walking into his house. He remembered the drugs he had in his room. His stomach turned and he hesitated to get closer. Then he looked at the person in the stretcher. He recognized her immediately. It was his mother. David: (approaching a paramedic). What's going on? Why are you here? Paramedic: Do you live here? David: Well, no. My mother lives here. Paramedic: We're taking her to the hospital for an evaluation. She almost got run over by a car. She was walking in the middle of the street, disoriented and confused. We tried to ask her what happened, but she's incoherent. Luckily, one of the neighbors recognized her. He tried to take her back to her house, but she became belligerent and started kicking and screaming. She scratched him up a little bit, but he's OK. He's the one that called the police. David: So, what's gonna to happen to her? Paramedic: We don't know yet, it depends on the nature of her problem. One thing for sure, she'll be in the hospital until the doctors have a good idea what's wrong with her. You can be a big help by telling us what you know about her medical history. David: I . . . I . . . I've been away for quite a while, so I don't know much about it. Paramedic: The neighbor said she lived alone, so the police got an emergency search order. They're looking for medical records, prescriptions, and things like that. (Before David could answer, the paramedic yells to the others) Hey! Here's the patient's son. Policeman #1: (approaches them). Are you a relative of the patient? David: I'm her son. Policeman #1: The neighbor said her kids were all gone. David: Well, I'm just staying with her off and on. Policeman #1: What's your full name? David: David Brown. Policeman # 1: And when was the last time you saw her? David: Today around one. Policeman #1: Did you notice her acting strange, or do you know of anything that could've upset her? David: No. Well, she's been drinking a lot lately. Policeman #1: How do you know? David: Like I said, I've been staying with her off and on, . . . (looking away) well, uh, since I got out of state prison. She's been acting kinda strange all the time I've been here, but I thought it was because of her drinking. 2.—Staging instructions and stage set up David is questioned by policeman #1 Policeman #1 asks questions David. David looks nervous. He hitches up his trousers, and fiddles with his shirt and hair. (Double bell) David rubs his mouth and face with both hands. He avoids eye contact by looking down and glancing to the sides. Policeman #]1 stares at him. (Bell) Policeman #2 enters stage right holding a box. Policeman #1 looks at him as he approacl Policeman #2 talks first to policeman #1 and t] David looks worried. Puts his hands in his trousers and balances from side to side. Dialogue between David, and policeman #1 and #2 Policeman #1: Who lived with her before? David: (hesitant) Well . . . I think she's been alone for a few years, since before I was sent off. Policeman #1: (staring inquisitively at David) Why were you in prison? David: (turning his head down and almost murmuring) I . . . I killed my stepfather. Policeman #1: Have you been arguing with her . . . since you've been back? David: No . . . not really. Policeman #1: What do you mean? David: I'd just lock myself in my room when she'd start talking crap. Policeman #1: Does she have any other children? David: Yeah, I have a sister, but she and mom aren't close. They don't even talk. Policeman #1: Are you going to stay in her house while she's in the hospital? David: I . . . I don't know. Maybe. Policeman #1: You said you stayed here off and on, where else do you stay? Narrator: David felt trapped. He got a cold chill because he was caught,in a lie He did not have another address to give, not even his sisters'. If he said he lived there he was going to get nailed if they found the drug,s in the house. He felt very uneasy answering questions from the police. He wanted to run away. But that would just make things worse. Someone called saying they were ready to leave. The policeman turned and looked at the ambulance pulling out. David prayed for him to go too. Instead, another police officer approached them. He was carrying a box. Policeman #2: (walks straight to his partner, ignoring David) I need a breath of fresh air. The smell of that dump was killing me. I couldn't find much except roaches and rotten food. Why didn't you come back to help me? Policeman #1: I was on my way back when one of the paramedics found the woman's son. I stayed here to ask him some questions. Policeman #2: Oh, is this him? (turning to David) How long has your mom been sick? David: I . . . I don't know, I didn't even know she was sick. Policeman #2: We need to go and file the report, but we'll be back in the morning. You know the house better and probably know where she keeps things. We'd appreciate if you'd help us find the name of her family doctor or a hospital where she's gone in the past. David: We always went to the county hospital when we were sick, but I don't know when was the last time she was there. Policeman #2: Did your mom have a job? David: I think so, but I don't know exactly where. Policeman #2: Look for some check stubs from her employer too, maybe they know more about her condition. David: OK. (hesitating). When do you think you'll be here tomorrow? Police #2: Why? What time do you have to go to work? David: (hesitating). I'm . . . I'm not working, I was just asking. Police #2: (irritated at David). I don't know when we'll be able to get here. David: (noticing his irritation). I . . . that's OK, I don't mind waiting. I'll be at the house all day if you want. Police #1: OK, that settles it. Let's go. AT THIS POINT THE PLAY IS STOPPED FOR DISCUSSION OF MATERIAL PRESENTED SO FAR LOST IN A SEA OF PROBLEMS

Q Do you think Mary's alcohol use was the cause of her mental problems? Explain why. Sample Response: It could be. She was disoriented, violent and crazy before she went to the hospital. Trained professional asks prticipating individuals to point at the area in the Behavior and Self diagram where this falls into. (PERCEPTION) Following is another example of an expert opinion narrated by trained professional: Some alcohol induced disorders are intoxication delirium, withdrawal delirium, alcohol induced persisting dementia, alcohol induced persisting amnesic disorder, alcohol induced psychotic disorder, alcohol induced mood disorder, alcohol induced anxiety disorder, alcohol induced sexual dysfunction and alcohol induced sleep disorder. (DMS VI 199) Q What negative changes do you see in people that are intoxicated or addicted to drugs or alcohol? Sample Response: They can't think right, they want to fight; they don't understand things or turn mean. (DMS IV pg. 183) Q Do you think these negative changes wear out once the person gets the drugs or alcohol out of their system? Sample Response: Not always it varies from person to person, from the kind of drug they use, the dose the duration and the time they've been using it. (DMS IV pg 183) Q How are substance induced disorders similar to mental disorders? +Sample Response: They are very similar. People that use drugs may suffer from substance induced psychosis, anxiety or sexual disorders. Q What kind of long term or permanent mental problems can people develop as a result of drug or alcohol intoxication? Sample Response: people may develop dementia, amnesic disorder, and hallucinogen persisting perception disorder or flashbacks for a long time after they stopped using drugs or they can be affected by them permanently. (DMS IV 192-193) Q What kind of mental disorders can people develop as a result of their drug use? Sample Response: Substance-Induced delirium, Substance-Induced Persisting Dementia, Substance Induced Persisting Anmestic Disorder, Substance-Induced Psychotic Disorder, Substance-Induced Mood Disorder, Substance-Induced Anxiety Disorder Substance-Induced Sexual Dysfunction, Substance-Induced Sleep Disorder and Hallucinogen Persisting Perception Disorder (Flashbacks) (DMS IV 192) Q How can you tell if a person has a mental illness? Sample Response: By the things they do or say. *Trained professional's comment: Doctors do not have a scientific method like an MRI to diagnose all mental disorders. They still don't know exactly how the mind works. They have given different labels to behaviors that are outside the norm, and organized them in groups of symptoms in order to do their job and can be wrong. For example only a few years ago doctors considered homosexuality a personality disorder and have labeled extreme shyness as social anxiety. Q Can a doctor tell for sure if a person suffers from a substance induced disorder or from a mental disorder? Sample Response: No it is very difficult to tell if a person had the mental disorder before using the drugs or if the drugs caused the mental disorder.

Following is another example of an expert opinion narrated by the trained professional: Doctors also have problems diagnosing substance induced disorders because many people use more than one drug and doctors cannot tell if the symptoms they are having is because they are intoxicated with one drug or going through a withdrawal from another drug. (DMS IV 191) Q If a doctor can't tell if their patients' mental problems are caused by their drugs how do they diagnose them? (DMS IV 191) Sample Response: They diagnose them as preexisting conditions because they don't know if the patient had the problem before using the drugs and the drugs just uncovered it or if the drugs were the primary cause for their problems. (DMS IV 191)

Trained professional's comment: For example, some drugs can increase the mood swings in by polar patients or the hallucinations or paranoia and delusion in schizophrenic patients. Q How are doctors today treating people with; mental disorders? Sample Response: With medication or different combinations of SSRIs (Selective Seratonin Reuptake Inhibitors) or drugs like Prozac, Zoloft, Paxil, Serzone, Luvox, Effexor, Celexa and Lexapro. Q Can these new drugs give people a high, what are some known side effects of these drugs? Sample Response: No these new drugs do not give people a high. Some minor side effects are weight gain, sexual dysfunctions and emotional numbness, but more serious problems have been reported in some cases.

Following is another example of an expert opinion narrated by the trained professional: According to Shannon Brownlee, “psychiatric drugs can have powerful side effects many in the field (of psychiatry) have long insisted that it is the depression that makes patients commit suicide, never the drugs, despite evidence that at lest in some, cases there is no doubt it is the medication. Studies done with these drugs show that healthy volunteers, or people with no history of mental illness can suddenly start having suicidal thoughts after taking the drugs. Some psychiatrists have also reported that a higher numbers of young patients started having severe psychiatric symptoms, including anxiety and mania after they began taking SSRIs.” But even its most adamant critics agree that SSRIs have helped many mental patients and that they shouldn 't be taken out of the market. (Brownlee, Oct. 17, 2004)

The question answer session resumes as follows: Q What advice would you give to someone you care about if he or she was diagnosed with a mental illness? Sample Response: To be aware of the side effects of the prescription drugs the are taking. Q What kind of treatment would you recommend to someone that was not born with a mental illness but was diagnosed with a mental disorder? Sample Response: Validate participants' response Q Would it make a difference if the person with a mental disorder used alcohol or drugs? Sample Response: Yes because substance abuse disorders are very similar to mental disorders like psychosis, mood disorders, anxiety, and sexual problems. Q Look at the Behavior and Self Diagram and tell me How does being labeled with a personality disorder affect a person's self and behavior? Sample Response: It affects a person's perception. They pay more attention to their faults and fears. They don't feel good about themselves and feel rejected by others. They don't have the same opportunities than others and lose the desire to do things. Q In spite of this downside why do you think some people want to fake a personality disorder? Sample Response: Some people do it to avoid responsibility and justify crimes or destructive behavior. Or they may do it to get Social Security.

Q Do you know anyone living in leisure with government money because they were diagnosed with a physical or mental condition? Sample Response: No. Most people that live off the government don't have enough money to support themselves. Q Do you think that people that fake a disability and receive government money are better off than you? Sample Response: No. Even though they don't have to work they usually worry about not having enough money. They work for cash, con people or do illegal things to get extra cash. They have to look over our shoulder all the time worrying they might get caught. They are not free to enjoy life. Q Do you think that drugs used to treat depression and other mental illnesses can cure people from their personal and moral weaknesses? Explain why. Sample Response: No. Prescription drugs can make people feel less anxious or depressed, but they cannot change the way they think.

Following is another example of an expert opinion narrated by the trained professional.

Nelson Mandela told his fellowmen after years of subjugation by apartheid: Our biggest fear is not that we are inadequate people. Our biggest fear is that we have unlimited power. It is our own light that frightens us, not the darkness. We ask ourselves, Who am I to shine? Do I have beauty? do I have talent, or intelligence? In reality, who told you, you don 't have all that? Making yourself small does not help the world. To hide your talents will not help the people around you feel less insecure. We are born to manifest the glory that is within us. Not in some, but in all of us. When we allow our light to shine, we are unconsciously given others the permission to do the same. When we free ourselves of our fears, our mere presence will automatically liberate others.

AT THIS POINT THE DISCUSSION IS ENDED AND THE PLAY IS RESUMED

3.—Staging Instructions and Stage Set Up

David goes into his house and remembers how his mother used to enjoy it. Table is at center stage, horizontally. David enters the “house” from stage right. He stops and reacts to rotten smell and holds up his nose (look around and imagine the layout of your own house) (Bell) Mary enters stage right holding a mop. She looks happy and smiles as she begins to mop. She takes a deep breath and runs her hand to the back of the chair. She sits and freezes (Double bell) David enters the “kitchen” he take a plate form a kitchen cabinet. Imagine a bunch of roaches crawling in the plate. (Double bell) David leaves the kitchen and walks to the opposite side of the stage to his “bedroom closet”. He looks for a boot on the floor of the closet. Takes out a package and stands up with difficulty ( bad right leg) He puts the package on his pocket takes three steps to the front of the stage and freezes.

Narrator's Monologue:

Narrator: David went into the house. The policeman was right, it smelled bad. He remembered how it smelled when they were kids. His mother used to mop every day early in the morning, and open the windows to air the rooms and let the sun in. She liked the smell of pine-sol and enjoyed sitting in the chair next to the living room window when she came home from work because it had been warmed by the sun. She would inhale deeply and say with a smile “This smell reminds me of the forest.” Now the house smelled like stale air, rotten food, filth and mold. He didn't clean and apparently neither did his mother. He went to the kitchen and turned on the lights. All the little roaches eating fast food scraps ran for the dark corners. He turned around and headed to his room. In the back of the closet, inside an old boot he dug for a plastic bag. He was relieved when he felt the bag with the tip of his fingers. He pulled it out and immediately put it in his jacket pocket.

4.—Staging instructions and stage set up David meets with Dog, his friend the drug dealer. David enters stage center right and meets up with Dog. Dog is leaning against the wall smoking. He looks bored and takes a few steps to meet David. Dog gets agitated and paces angrily with his fists closed and chest up while he listens to David. David looks afraid of Dog. (Double bell) David pulls a small package from his pocket. (Bell) Dog takes the package and looks upset. He opens the package and,begins to separate the content as if counting. He moves toward David and gets on his face. (Double bell) David pulls back and takes a few bills from his pocket. He gives them to Dog. Dog snaps the money out of his hands. (Bell) Dog gives David a push and takes him fall over a trash can. Dog exists stage left. David stays on the floor and curls up with his head between his arms and freezes. Dialogue between David and Dog Dog: (standing with two other guys outside the convenience store. David approaches them. Dog seems happy to see David). Hey Dave, got something for me? David: Well . . . yeah . . . but I need to talk to you. Dog: (puffing his chest out toward David). What about? I'm not in the mood for bad news. (He grabs David by the back of his collar and pushes him to the side of the building). David: My mom got sick and the police were at the house. They had a search warrant. Luckily they didn't find the stuff. I can't have this in the house anymore. They're coming again tomorrow and if they find it I'm doomed. Dog: You mean you haven't sold it yet? David: Well . . . no . . . I mean I've sold some. Dog: How much do you have left? David: Ten packs. Dog: (Pulls a little book from his front pocket and reads). I gave you thirty. So give me the money for the rest. David: Well . . . I don't have all the money, I'm gonna have to owe you. Dog: What do you mean you're gonna have to owe me? (He starts hitting David on his shoulders, pushing him back). You damn stoner you smoked the stuff yourself! I should have known better than to trust you! (David pulls the plastic bag out of his pocket and hands it to Dog). Now I'm gonna see what you have here, and I want the money for what's missing by tomorrow. Do you hear me? Don't think I'm gonna give a crap about your story. You stoners are all full of those stories. I don't care about your damn mother. Just be sure to give me the rest of the money by tomorrow, got it? (Dog gives David one last push. This time he makes David lose his balance). David: (On the ground facing Dog, pulls out some bills from his pocket) I have some of it. Dog: (Snatching the money from David's hand) Good. But the deadline is still tomorrow. Narrator: (David looked at Dog as he walked back to his friends, again with his chest out. After a few seconds, David stands up and walks away, looking preoccupied). David had given Dog the money that his baby sister Suzanne had given him earlier that day. He felt very low. He believed he deserved the humiliation. He was messed up and so was the rest of his family. AT THIS POINT THE PLAY IS STOPPED FOR DISCUSSION OF MATERIAL PRESENTED SO FAR DRUGS A MIRGE IN THE DESERT

Q From what we know David lives in a poor neighborhood. Do you think that poverty pushes young people like Dog to become drug dealers?

Sample Response: No. Not all poor young people become drug dealers. There are also wealthy young people who choose to be drug dealers. Q Why do you think people choose to make money selling drugs or through criminal activity instead of working? Sample Response: Because they are anti-work. They claim they can make more money committing crimes. Being a drug dealer gives the person status and authority. TRAINED PROFESSIONAL ASKS PARTICIPATING INDIVIDUALS TO POINT AT THE AREA IN THE BEHAVIOR AND SELF DIAGRAM WHERE THIS FALLS INTO. (ATTITUDE, BELIEFS) Q Most criminals claim they turned into crime because they had a difficult childhood. Do you think childhood traumas or the example of their parents or siblings can turn a person into a criminal? Sample Response: No. Not all people with difficult childhoods or bad role models become criminals Q Do you think Dog became a drug dealer because he can't read or write well or doesn't have any job skills? Sample Response: No. Most criminals don't have learning disabilities, instead of learning while in school they were usually belligerent or spaced out. But even though they had bad grades they believed they were smarter than the others. Q Do you think it was necessary for Dog to pushed David around to make his point and get his money? Explain why. Sample Response: No. He was just building himself up by putting David down. It was a way for him to establish his status and authority. Q If drugs were legalized do you think drug dealers would become honest business men? Sample Response: No. Dr. Steven Samenow says that “there are people who will be exploitative, larcenous and violent no matter what the laws are. Criminals crave power for its own sake, and they will do virtually anything to acquire it.” (pg 177-178) Q Where do you think Dog will be five years from now or ten years from now? Do you think he'll have a house in the coast, an expensive car and a fast boat like drug dealers in the movies? Explain why. Sample Response: (Validate participant's response) Q What do you think that a person that sells drugs needs to do to get big money? Sample Response: (Validate participant's response) Q Besides the money, sex and the drugs, why do you think people want to deal with drugs? Sample Response: For the excitement of the lifestyle. Q Do you think the lifestyle of a drug dealer is as glamorous as shown on TV? What are some of the drawbacks of being a drug dealer? Sample Response: (Validate participant's response) Following is another example of an expert opinion narrated by the trained professional:

In his book, The Criminal mind Doctor Stanton E. Samenow said that criminals do not value money. That it doesn 't matter if they have a nickel or a thousand dollars money passes through their hands very fast. When they have large amounts of money they don't keep track of it and spend it fast. And when-they are broke they are counting every penny in their pocket. He says that criminals don't have the discipline to manage money. (pg 239) AT THIS POINT THE DISCUSSION IS ENDED AND THE PLAY IS RESUMED.

5.—Staging instructions and stage set up David remembers his childhood and the violence he suffered from his stepfather's Max. (listen to whole track before acting). David & Suzanne are at stage left back she is sitting and he is standing next to her. She looks upset and cries while holding her belly. He shows compassion by stroking her hair. (Double bell) David grabs Suzanne by the arm walk to center stage where they join Mary & Max. (Double Bell) Crying Suzanne silently explains to Mary about her belly. Mary looks upset at Max and gestures with her arms. David looks angry. Max looks surprised and says no by shaking his head. He pushes Mary out of his way and exits stage left. While still within reach Mary grabs on to him to keep him from leaving but she cannot stop him. She and Suzanne move to the back left corner. There, Mary cries while Suzanne looks sad as she holds her belly. (Bell) Max enters stage center. Mary runs to greet him and he pushes her aside. He goes directly to David who is now eating at the table. Max raises his hands defiantly as he paces in front of David. David backs off, they both freeze. (Bell) Max moves the chair at back left to the front left. He sits and holds up a steering wheel pretending to drive. (Double bell) David walks in front of Max & falls as if hit by a car. Mary stands next to Max while David gets up with difficulty. Now limping, David goes to the chair behind the table and sits. He looks angry as he rubs his knee. Max walks toward David defiantly. He waves his arms in a threatening way and sticks his chest out. David looks at him scared. (Bell) Max lounges toward David with his hands out as if trying to strangle him. David grabs a knife from the table and stabs Max. Max falls dead. David turns to face the wall and places his hands behind his back as if cuffed. Suzanne and Mary exit the stage from opposite sides walking slowly and crying. Dialogues of narrator and Max: Narrator: David remembered the last days they were all together. Suzanne became pregnant by their mother's boyfriend when she was only 13. That incident triggered the bottled up hatred David had for Max. David was determined to make Max pay. He was going to go with Suzanne to the police and file charges against Max. In a heated argument Suzanne told their mother about their plans. Mary questioned Max again and Max left the house while she pleaded with him to stay. Later that day, Max came back. He pushed Mary aside and told her he was going to take care of the problem once and for all. He found David sitting in the kitchen. Max: (David is sitting in a chair with his hands covering his face. He puts his hands on the table and looks up when he hears Max's voice). I don't know what your damn sister told you, but it's not true. I'm not going to let you bastards put me in jail. Suzanne might be thirteen, but you've seen how she acts around boys. If you go to the police, I swear you little mother I'll come back and I'll kill you! Narrator: David was not built to be a fighter. He was small-boned and frail looking. When he was growing up Max used to beat him up for no reason. One day, David was coming home after playing with some friends when he saw Max's car approaching him at the intersection. David remembered seeing Max turn the wheel of the car towards him. Max would have killed him if he hadn't run towards the sidewalk. But he didn't move fast enough and Max managed to hit him anyway. There were no witnesses and Max claimed that David stepped in front of the car. His mother believed Max and convinced the police it was true. David ended up with a broken hip and has a limp to this day. “This time Max wasn't going to get away,” David thought. David was determined to make him pay. So that day, when Max walked into the kitchen and tried to intimidate David, instead of fear, he felt David's rage. When Max got too close to David, and was about to strangle him, David reached for the knife that was sitting on the table and stabbed him repeatedly. David was taken to the county jail. While he was there he found out that his sister had gotten pregnant again and that his mother had kicked her out of the house. Then he was convicted and sent to the state prison. Suzanne had been on the streets since, making a living turning tricks.

6.—Staging Instructions and Stage Set Up

Suzanne visits her mother at the hospital. Mary is sitting at center stage as if in a trance. She is rocking with her arms resting on her,lap and her chin down. Nurse #1 is checking her pulse when nurse #2 enters the room and goes to the table then joins nurse #1. (Bell) Suzanne enters stage right and approaches the nurses. (Bell) Both nurses exit stage left. Confused, Suzanne stares at her mother from a distance. She is overwhelmed with memories and doesn't know what to do with her arms and hands. She grabs her shoulders and rubs her neck as she paces. (Bell) Suzanne stands behind Mary, strokes her hair and places her hand on Mary's shoulder. (Bell) Suzanne backs off from Mary as she remembers the problems between them. She rubs her arms as if cold then covers her face with her hands and freeze. Dialogue between Suzanne and the nurses: Nurse 1: (enters and approaches Mary, who is curled up in a chair) Morning Mrs. Brown, how are you doing today? (Mary looks at her timidly and does not answer) Nurse 2: (approaches Nurse 1) She's still not talking. I've talked to the doctor and he reduced her medication. The counselors can't work with her like this. Suzanne: (entering) Excuse me. I'm looking for Mrs. Mary Brown. Nurse 2: This is her room. We were wondering if she had any family, cause nobody has come to see her. Suzanne: You mean my brother hasn't been here? Nurse 1: Well . . . If he has we haven't seen him. Suzanne: (looking at her mother from a distance and thinking). All these years I've been afraid to face her. I ruined everyone's life. I thought that Max was treating me like his real daughter when he asked me to sit on his lap and took me along when he ran errands. My mother used to say she wished her father had been close to her like Max was to me. But when Max was in the house alone with me he would touch me and expose himself. Then he would tell me it was just a game that all fathers and daughters played it and that no one should know about it. I'm sorry mom. I didn't know. All that time I felt disoriented, and couldn't concentrate. I was afraid to fall asleep because I couldn't stop the nightmares. I was bad, and you were right to feel jealous and resentful of me. It's been a long time since we've seen each other. You look so frail and old, like a different person . . . I'm so ashamed, I wish I was dead.

7.—Staging Instructions and Stage Set Up

Mary remembers some painful moments of her life. Mary is sitting at center stage as if in a trance. She is rocking with her arms resting on her lap and her chin down. (Bell) Mary gets up and stops in front of Joey. He is standing with his back against her and faces her when she starts talking. He shakes her by the left arm and she shows pain. He turns his back on her after that. (Bell) Mary walks holding her left elbow with her right hand. She stands in front of Suzanne. Suzanne stands frozen holding her belly. Mary shakes her head in disapproval and walks in a submissive way with her head down toward Max. (Bell) Max is standing proud with his arms crossed looking at Mary in a condescending way. He gives her a bottle. Mary takes the bottle looks defeated with her arms hanging from her shoulders and her back curved she walks toward David (Bell) Mary stands in front of David she looks at him for a minute and turn to look at the others again. She picks up the bottle and drinks as she walks back to the chair at-center stage. She sits and lets the bottle fall off her hand as she goes back to a trance position and rocks again.

Monologues by the narrator and Mrs. Brown

Narrator: Mrs. Brown didn't speak. All those unresolved issues in her life had become blockages that prevented her from assimilating the experiences. These obstacles had created a neurosis. The return of David unleashed feelings she: had tried to bury with alcohol. Seeing him again made her relive the anger, the pain of the betrayal, the alienation and the defeat. His mere presence had triggered the anxiety. It weakened the many defenses that had allowed her to carry on. Now she was overwhelmed and couldn't respond to the world. Mrs. Brown: (thinking) When my husband Joey found out that I was pregnant for the second time he became very violent. He started yelling and throwing things at me, blaming me for ruining his life. Then he came at me and started hitting me with his fists, and kicking me. I ended up with a broken arm. The neighbors called the police but Joey left before they got there. I never saw him again. In spite of the hard times, Suzanne was a happy girl. Max used to call her “his princess”. I couldn't believe her when she came up with that story about Max. Max had moved in with me and the kids when Suzanne was only two. He was like her real father. How could I believe he'd rape her? All I've ever wanted was to have a family. When David went to trial for killing Max the lawyers accused me of being a bad mother for letting Max abuse my children for all those years. The pain and the guilt was just,too much for me. I couldn't face myself anymore. The only way I could live with myself was by drinking. I drank more and more. Before long I lost my job of ten years, and as if that weren't enough, Suzanne got pregnant again. I couldn't take it any more. I told her to leave. . . . I was tired, so tired from all the problems, and the booze was my only relief, my only friend it was all I had left.

AT THIS POINT THE PLAY IS STOPPED FOR DISCUSSION OF MATERIAL PRESENTED WHEN THE FAMILY WENT WRONG

Q What kind of mother would you say Mary was? Sample Response: Uncaring, she was more interested in her boyfriend than her children. Trained professional asks participating individuals to point at the area in the Behavior and Self diagram where this falls into. (ATTITUDE) Q Why do you think Mary was more interested in keeping Max happy? Sample Response: Because she had been a victim of abuse and was more concerned with her own safety. Q Psychologists and psychiatrists have focused their attention on people who have problems, but Abraham Maslow decided to study people who were role models and had left a legacy in the world. (Gwynne, pg. 1) Do you think he saw people differently than other psychologists because of the people he studied? Explain why. Sample Response: Yes because the people he studied were different from the ones the other psychologists studied. Q Freud said that people were like animals and acted; out of instinct. Skinner believed they could be programmed to behave in certain ways through punishment and reward. Maslow did not agree with either of them. He said that humans were basically trustworthy; that they could protect themselves and govern themselves. Which of these points of view do you think is the most realistic? Sample Response: Validate participant's response. Following is another example of an expert opinion narrated by the trained professional: Maslow became famous for his “Hierarchy of needs” (hand out a copy).

He said that people tend to gravitate toward growth and love but to do so they have to: 1) First meet their physiological needs like food, water, sleep, sex and so on. 2) The second thing that people need is safety. They need to be safe from animals and the elements, but they also need to feel safe among other people. People may turn to religion to feel safe from their environment and to feel hope for the future. 3) The third need people want to fulfill is belonging and love. People need to feel they belong to a group or that other people care about them. 4) Once those needs are fulfilled people move to their esteem needs. They want to be recognized and admired and to be able to influence other people. 5) Self actualization is at the top of the hierarchy because at this level people have the need to explore their full potential as human beings; they want to establish a closer relationship with God by practicing the spiritual or moral virtues. (Gwynne, pg. 2 & 3)

The question and answer session resumes as follows:

Q Now look at your copy of Maslow's hierarchy of needs and tell me where would you place Mary? Sample Response: She is at the safety needs. Q Where would you place Max? Sample Response: He is also at the safety needs. Q But if Max is a bully why would he be at the safety needs? Sample Response: Because he feels insecure about his manhood. Following is another example of an expert opinion narrated by the trained professional: Maslow said that it is not natural for people to be violent. He said that people can turn violent to defend themselves, when they don 't feel safe; that violence and other evils take place when people are unable to move to their next level of needs. Then, he said, people become sick and turn evil. Q Do you agree with Maslow's explanation or do you think that our society is deteriorating and decaying. (Gwynne, pg. 1) Sample Response: Validate participants' response. Q Where do you think families in the old days fit into Maslow's hierarchy? Were people more likely to help each other in the past? Did families stay together more? Sample Response: They were meeting their physiological and safety needs. In the old days everybody had to contribute to the family. Children had to work to help the family survive, school was not mandatory people helped each other because that was the only way to survive. Q Where do you think most people are today in Maslow's hierarchy? Sample Response: Though there are still some safety issues people are mostly at the third level. They are trying to fulfill their need for belonging and love. That's why dating services have become so popular. Q What do you think is keeping you from moving to the next level of the hierarchy? And how are you venting your frustration? Sample Response: Validate participants' response.

AT THIS POINT THE DISCUSSION IS ENDED AND THE PLAY IS RESUMED

8—Staging Instructions and Stage Set Up

Mary is semiconscious but manages to respond to Suzanne. Mary is sitting at center stage as if in a trance. Her eyes are fixed in an imaginary spot. She is rocking with her arms resting on her lap and her chin down. (Bell) Nurse #2 is in the back left silently speaking with Suzanne. (Bell) Nurse #2 exits stage left. Suzanne takes a few steps toward Mary. Slowly she gets closer to her. She freezes. Without looking at her, Mary turns her head trying to recognize who is there & slowly smiles. (Bell) Suzanne cries and Mary stretches her arm in the air trying to reach her. Crying, Suzanne falls on her knees next to her mother. She then places her face on Mary's lap. Mary puts her hand in the back of Suzanne's head & and continues to rock but now looking at Suzanne. Monologue by Mrs. Brown and dialogue between Suzanne and nurse: Narrator: Major symptoms of depression are loss of pleasure, loss of appetite, inability to concentrate, harsh self-criticism, and dependency. Many people who are by nature depressive, or have depressive tendencies, use alcohol to self-medicate. They try to dose themselves with a socially acceptable over-the-counter antidepressant. But when the effect of the alcohol wears off, the hidden depression begins to creep in. This withdrawal drives people with this ailment back to the alcohol, and the cycle begins again. Some scholars contend that addicts choose a drug with the particular medicating properties that fit their ailment.

They have recognized a strong relationship between alcohol and depression.

Nurse 1: (addressing Suzanne) It's like she's in an amnesic stage. She doesn't talk or seem to recognize anybody. Why don't you get closer? Maybe she'll recognize you.

Suzanne: (walks hesitantly toward her mother and stops in front of her). Mom? It's me, Suzanne. Can you hear me? Narrator: (Mary slowly raises her head). Happy memories rushed to Mary's mind when she heard that familiar voice. She could remember when Suzanne was a baby and her eyes were full of happiness. She took a deep breath and her heart accelerated when she saw the tears pouring from Suzanne's eyes. A view previously obscured by a thick fog was suddenly cleared. She was able to step out of herself. Her defenses yielded, allowing the feelings to flow freely. For an instant she seemed to have had a transcendental experience. But the fog quickly closed in again, leaving only the memory of Suzanne and her tears. To everyone's surprise, Mrs. Brown raised her hand as if wanting to touch Suzanne. Suzanne cried even more and slowly got on her knees in front of her mother. When Suzanne felt Mary's tremulous hand caressing her she sat on the floor and placed her head on her mothers lap. They both cried profusely. Words were not necessary. They had finally acknowledged each other's pain.

9—Staging instructions and stage set up A social worker visits David at his house to discuss Mary's future. avid and the social worker are sitting at the kitchen table. She is asking him about Mary and taking notes of his answers. David is nervous and sits at the edge of the chair bouncing his leg and playing with his hands while he answers. (Double bell) David puts his elbows on the table. He first rests his forehead on his hands then covers his face with them. The Social worker sits frozen. (Bell) The. Social Worker gets up and David follows her. They stand at the right front. David shakes her hand and she exists. David walks back to center front. He looks worried. His mouth feels dry, and his stomach hurts. He starts walking back to the table but stops to looks around at things at the room.

Dialogue between David and Social Worker: Social Worker: (looking repulsed, sitting on the edge of the chair and covering her nose with a handkerchief She is taking notes as she speaks with David). So . . . what's your mother's full name? David: (responding meekly) Mary Brown. Social Worker: How long has she lived here? David: I just remember we've been here since I was born. Social Worker: And you say she's still married to your father? David: I . . . I don't know. All I know is that he left one day before my sister Suzanne was born. None of us have seen him since. Social Worker: Hmm. . . . David: I . . . I'm sorry I haven't been much help; there's just a lot of things my mom never talked about. Social Worker: Well, I need to verify some of the information you gave me and wait for the doctors' diagnosis. But I can tell you this. If your mother is determined to be permanently impaired, her property would probably be sold. The proceeds would be placed in a fund to pay for her living expenses, and she would be in the custody of the state. Narrator: David listened attentively, while in his mind he saw himself trying to open the door of a house that was no longer his. He felt a cold chill, and for a moment he felt out of balance, as if someone had pulled the rug out from under him. It seemed that life was pushing him and he did not know what direction to take. After the social worker left, David's first impulse was to get high. But he didn't have anything in the house. Then Rev. Crane's words came to his mind. AT THIS POINT THE PLAY IS STOPPED FOR DISCUSSION OF MATERIAL PRESENTD SO FAR PARALYZING GUILT Q When parents divorce or children are abandoned do you think the children blame their parents or themselves? Sample Response: They blame themselves. They think there was something wrong with them. Trained professional asks participating individuals to point at the area in the Behavior and Self diagram where this falls into. (PERCEPTION, EXPECTATIONS) Q When a parent tells the child “See what you made me do” or when children are mistreated, do you think they blame their parents or themselves? Sample Response: They blame themselves. They think they deserve the abuse.

Q Dr. Terrance Real said that children blame themselves for their parents' choices and that is how guilt is passed on from parents to children and from generation to generation. (Real, pg. 205-206) Look at the Venn diagram and tell me how do you think that guilt affects the child's sense of self and behavior? Sample Response: It affects their attitudes and expectations on the self side and their environment and experiences on the behavior, side. Q Where do parents learn how to raise their children? Sample Response: From their own parents, new trends on parenting, or television shows. Q Tell me what is your favorite television family. How do the parents communicate with their children? How do they discipline them? Sample Response: Validate participant's response.

Q Children can also feel guilty for not meeting their parents' expectations. On TV we see parents that are too critical, too controlling or uncaring. You see how the guilt has molded the children of those characters self and behavior. Tell me a behavior or a phrase that the child characters use all the time as a result of the guilt that was passed on by their parents. Sample Response: Validate participants' response Q One of the ways of dealing with passed on guilt is by drinking or using drugs. Do you think this is the best way of dealing with it? Explain why. Sample Response: No. People who drink or use drugs to get rid of their guilt end up feeling more guilt afterwards because they end up hurting themselves and the people who love them. Q Do you think that passed on guilt is the main reason why people become addicted to alcohol and drugs? Is it possible for children of good supporting parents to become drug addicts? Sample Response: (Validate participant's response) Trained professional asks participating individuals to point at the area in the Behavior and Self diagram where this falls into. (ATTITUDES & EXPECTATIONS) Following is another example of an expert opinion narrated by the trained professional: No, passed on guilt is not the main reason why people become addicted to drugs, and yes children of good supporting parents can become drug addicts. In his years of practice, Doctor Stanton Samenow discovered that most addicts don 't use drugs to medicate childhood traumas but they all want to convince people that they are not responsible for their addiction. He concluded that addicts are very much in control of their behavior. He said, “The criminal is usually involved in crime before he smokes his first joint, or tries a drug for the first time. Some criminals find that they need drugs in order to have the courage to commit more daring and exciting crimes. They make it a habit to use drugs every time they want more excitement. Criminals can stop using drugs by themselves in order to get a better high with less drugs. They also decide what drugs to use and how much they need to have to be ready for specific activities. They control their drug use; it doesn 't control them.” (pg 126-127)

The question answer session resumes as follows: Q Do you agree with Dr. Samenow when he said that the drug addict controls their drug use that it doesn't control them? Give an example Sample Response: I agree. Many people have stopped using drugs after deciding they had enough. Q Millions of people drink coffee first thing in the(morning. Do you think they do it because of habit or because they can't help themselves? Sample Response: Out of habit.

Following is another example of an expert opinion narrated by the trained professional: Dr. Stanton Samenow says that what is habitual is not necessarily compulsive and beyond one's control. To say that a person has a habit of doing something does not mean he lacks responsibility of his actions. Criminals are not impulsive but calculating. They scan the environment and take advantage of opportunities. (pg 124) The question answer session resumes as follows: Q Do you think that all addicts feel guilty about using drugs? If so, when? Sample Response: Validate participant's response Q What do you usually do when you feel overwhelmed with guilt? Sample Response: Validate participant's response AT THIS POINT THE DISCUSSION IS ENDED AND THE PLAY IS RESUMED.

10—Staging Instructions and Stage Set Up

David goes to see Rev. Crane to ask him for help. David enters stage right. He looks worried and presses down his knuckles as he stands trying to decide in which direction to go. (Double bell) Limping, David starts walking around the stage. He stops and looks up as he thinks how to approach Rev. Crane. He looks worried and runs his hand through his hair and presses his knuckles. (Bell) Rev. enters stage right and begins stretching next to the chair. He stops briefly when he sees David standing in front of him then continues to stretch. David looks impatient. He clenches his fists as he paces. (Bell) Rev. sits and with his hand he gestures David to sit. He leans his torso toward David as he talks to him. David backs off and turns his face away from Rev. Crane. (Bell) Rev. stands in front of David. David keeps his distance from him by moving his torso away from him. Rev. paces motioning with his hands as he talks to David. David seems interested on what he is saying and keeps his eyes on him.

Dialogue between David and Rev. Crane

Rev. Crane: (voice only) Remember David, every time you use drugs to find relief from your problems, you're giving up your freedom, not because they're illegal and you might get caught, but because you're letting your mind control you. Narrator: Deep down David knew the drugs were not going to solve his problem, but only make it worse. He decided to go see Rev. Crane before going to the hospital. Maybe if he told Rev. Crane he was ready to change he would give him some money to pay Dog. He realized how alone he was. Aside from Suzanne, and Rev. Crane, he had no one else to turn to. David started walking and imagining Rev. Crane happily giving him the money after he heard of his decision to change. When he walked in Rev. Crane's office, he saw Rev. Crane standing in a strange arched position.

Rev. Crane: (grounding posture). Hi, David. I didn't expect to see you so soon. Come on, . . . stand next to me and stretch. David: (ignoring Rev. Crane's invitation) I'm going through a lot of problems and I can't see the way out. I feel like using again.

Rev. Crane: (Stops stretching, and looks calmly at David. He sits and invites David to sit next to him. He looks at David again, only this time with a solemn look). Escaping reality isn't going to solve your problems. Now, I can sit here and convince you not to use drugs today, but what's gonna happen tomorrow when nobody'll be around to help you? We might be able to put out the fire today, but we need to prevent other fires from happening. In other words, . . . You need to make your life better or you'll be lost. David: I don't want to give up, but I have a lot of things working against me.

(David covers his face with his hands and starts crying). Rev. Crane: You might not realize it now David but God is giving you an opportunity to turn your life around. You could have been arrested if the police found the drugs in your mother's house, or when you were out with those drugs in your pocket, that guy you owe the money to could have really hurt you. Now you know that you can't lean on your mother forever; that you need to figure out how to pay your own way. You see this as a problem but that is only your perception. The map is not the territory, remember? That means that the way we perceive things is not really how they are. You need to see that your life can be different from what it's been. Once you realize that you'll be able to see that you have all the resources you need to create the life that you want. AT THIS POINT THE PLAY IS STOPPED FOR DISCUSSION OF MATERIAL PRESENTED SO FAR THE BLEEDING PAIN OF VICTIMIZATION:

Q When we say the word “victim” what kind of image comes to your mind? Sample Response: I think of a person that was hurt by others. Or a person that is suffering because of unexpected events or circumstances, like a car accident. I also think of a person that suffers because of a condition or an illness. (The American Dictionary pg 1347) Q What do you think people mean when they say “I have never been a victim”. Do they mean they have never been hurt or never suffered? Sample Response: Validate participant's response; Trained professional asks participating individuals to point at the area in the Behavior and Self diagram where this falls into. (PERCEPTION)

Following is another example of an expert opinion narrated by the trained professional: When people s,ay they have never been a victim they are not saying that even though they were not in control of the events that hurt them they were in control of their reaction to the event. (Sellon, pg 30) Their attitude towards pain is different from most people. Instead of avoiding pain they welcome it because it strengthens them and brings them closer to God. An example of their attitude is this little prayer, “God break my heart more, so it can be capable of-greater love.” The question and answer session resumes as follows: Q Do you think David is one of those people that welcome pain? If not, how do you think David sees himself? Sample Response: No. He doesn't like to feel pain and he sees himself as a victim. Q Have you heard people say that we can choose to never become a victim? What do you think they mean by that? Sample Response: Validate participants' response Trained professional's comment: These philosophers mean that we have the power to Choose how to see our painful experiences. They mean that we can decide whether to process the painful experiences with our emotions or our rational mind, or with our spirit. When people process pain with their spirit, they stop obsessing on what happened and pay more attention on how to respond or to react to the situation. Q How do you think that blaming their parents for a troubled childhood can help people heal? Sample Response: It cannot help them, heal because it just reinforces the victimization, and their sense of helplessness. Q What do you think David would need to do if he was to choose not to be a victim? How easy do you think it would be?, Sample Response: Validate participants' response NLP EXERCISE TO ACCEPT FAMILY'S FAULTS. AT THIS POINT THE MASTERY OF OBJECTIVES IS REVIEWED, THE FLOOR IS OPEN FOR COMMENTS AND THE SESSION IS FINISHED

### EXAMPLE 3

Before class begins, individual participants take the attitude pre-test. A hand out called mastery of objectives is also given to individual participants at the beginning of the class. This mastery of objectives has a series of questions about the session. The individual participants will learn the answers during the session and discuss such answers at the end of the day.

1.—Staging Instructions and Stage Set Up

Suzanne prepares for a night out but memories of her past begin to torment her. Suzanne looks happy brushing her hair and holding a big hand mirror in front of her face. Jenny is curled up in a chair behind her. Suzanne turns to talk to Jenny who tells her she's sick. Suzanne responds irritated. (Bell) Suzanne blocks her view with a mirror. Jenny leaves stage right curved holding her belly and mouth. (Bell) Max enters stage left. When Suzanne lowers the mirror, she sees Max standing in front of her. He is reaching for her arm. She acts scared and covers her face with both hands. (Bell) Max exits stage right. Mary enters stage left. Suzanne uncovers her face when Mary is standing in front of her. Mary is staring at her shaking her head and crossing her arms in disapproval. Suzanne pulls her top up and fixes her outfit. She then clinches her eyes and shakes her head while holding it with her hands. Mary exits stage right. Suzanne freezes in that position.

Dialogue between Suzanne and Jenny Suzanne: Come on Jenny. It's getting late and we're gonna miss the guys. Jenny: (coughing,persistently). I don't feel very good. I feel chilly and weak. (coughs again) Suzanne: Why'd you have to get sick? You know Carlos is having a party tonight, and if we're not at the usual place he'll pick up some other girls. Narrator: Jenny was Suzanne's only friend. She took Suzanne in when she found her curled up against a wall in an alley where she usually turned tricks. Suzanne had been sexually abused by her stepfather, Max, starting when she was ten, and got pregnant by him when she was 13. When she finally told her mother about it Mary didn't believe her. David was going to help Suzanne press charges against Max, but Max knew what was going on. One night Max came home drunk, determined to stop them. He found David in the kitchen and started pushing him around.

2.—Staging Instructions and Stage Set Up

David remembers how Max used to dominate him and alienate him as a child. David is sitting at the table eating when he hears Max's threatening voice. He lifts his head to locate the place where the voice is coming from. He then draws his shoulders into a protective position and waits with his head tilted to the left. (Bell) Max enters stage left and stops in front of the table. David gets up slowly, walks with a hunched back and stands in front of Max. Max entices David to fight by pulling his arms up but David lowers them as soon as Max lets go. Max begins to punch David and David blocks his face with his left arm while swinging his right arm in front of him. (Bell) Max grabs David by the collar and forces him: to his knees. David doesn't resist. (Bell) Mary enters stage right and sees David on the floor. Max turns toward Mary and starts acting all innocent. He grabs Mary by the arm and they both exit stage right. David stays in the floor reaching out for his mother.

Max and narrator's dialogue: Max: I don't know what your damn sister told you. But it's not true. I'm not going to let you bastards put me in jail. Suzanne might be 13, but you've seen how she acts around boys. If she got pregnant it must have been by someone else. If you go to the police, I swear you little mother I'll come back and kill you! Narrator: David knew that Max wasn't bluffing. He'd taken Max's beatings many times in the past, and knew Max was capable of backing up his threats. Even though David was much older and taller now, the scared little boy inside of him got paralyzed for a moment. Max: What's the matter boy? You don't like to fight? I'll show you how to be a man, come on, come on, hit me. Ha, you're too wimpy. Come on, fight back . . . Hit me harder . . . You're nothing but a sissy. I can kill you right now if I want to . . . and I just might . . . Narrator: Every time Max attacked him David used to stay on the floor immobilized with fear. He would try to reach for his mother with teary eyes but before he could utter a word Max would mock him by saying “Mommy, mommy save me.” Then Max would call him a sissy and make fun of how small he was. Max: (gets up when he sees David's mother walk in. David leaves the stage). I'm telling you Mary, the boy's a liar. We were just playing. I'm just trying to make a man out of him. Stop being such an overprotective bitch anyways.

3.—Staging Instructions and Stage Set Up

David remembers how Max crippled him when he was a young teenager.

The stage will be dark and flashing lights will illuminate the stage to signify an ambulance nearby. The narrator begins to speak about the situation as the lights flash. David is laying on his back unconscious. A policeman takes notes as he looks at him. (Bell) Max approaches the policeman and acts innocent. Mary joins Max and gestures to the policemen as if agreeing with Max's. When Mary says “he's like a father to my children” the policeman nods and exits stage right.

Dialogue between Max and Mrs. Brown

Narrator: When David was eleven he suffered an accident. Well, the police didn't have any witnesses to prove otherwise, and David was too scared to tell.

Max: I don't know why the, boy jumped in front of the car. I tried to miss him but it was too late. I couldn't react fast enough. I think he was high on something.

Mrs. Brown:, I believe my husband, officer. For some time now David has been very quiet and keeping to himself. There are lots of drugs in the neighborhood. Maybe someone gave David something without him knowing. I'm sure it was an accident. Max couldn't do something like this intentionally. He's like a father to my children.

4.—Staging Instructions and Stage Set Up

David remembers the reaction him and Suzanne had when their mother sided with Max. David looks angry. He is standing at the back right stage with closed fists. He is looking at Max and Mary. Suzanne looks very upset. She is sitting next to him covering her mouth with both hands and looking at Max and Mary. Mary looks submissive. She is standing with her knees flexed, arms to the side and open palms. Max looks angry. He has one arm up as if pushing Mary away. They are both in a frozen position. (Bell) Mary moves toward Max pleading while he grabs a bag and starts putting his clothes in it. She tries to hold him back by grabbing his arm. Max shakes her off and stumps out. Mary falls on the floor crying. (Double bell) David rubs his bad leg. Limping he takes a few steps to the front and looks at Suzanne and then at Mary. (Double bell) in slow motion, David walks and stands in front of the table and grabs a knife from it. He stops and stares at the floor imagining Max lying in front of him. He freezes.

Monologue by Mrs. Brown. Narrator: David could remember hearing his mother question Max about Suzanne's pregnancy. Max denied the accusations and threatened to leave her for goo,d. He moved around the room with a bag and started putting his things in it. Mary always backed down when she saw him doing this. He told her this time he meant it, and started out the door with the bag over his shoulder, saying he'd send someone for the rest of his stuff. Mrs. Brown: Please Max. Don't go. I don't know what got into these kids. I'll talk with Suzanne again and make her tell me the truth. Come back!.

Narrator: David knew that Max was just bluffing. He always did. But this time he wasn't afraid. Max had beaten him, broken his hip and left him with a permanent limp. He had abused Suzanne, the only person who cared about him and gotten her pregnant. David had kept his rage and hate bottled up inside of himself for years. But suddenly it was all coming out. He felt strong enough to defend himself and Suzanne, the only person who cared about him. For the first time he stood up to Max. During the confrontation, David stabbed Max repeatedly with a kitchen knife. Max was dead and David was sent to prison.

AT THIS POINT THE PLAY IS STOPPED FOR DISCUSSION OF MATERIAL PRESENTED SO FAR DOMINANCE AND SUBMISSION:

Q What do you think Max was trying to do by keeping Mary from defending David? Sample Response: He was giving David the message that he also controlled his mother and that women were to be ignored and devalued. (Real 134) Trained professional asks participating individuals to point at the area in the Behavior and Self diagram where this falls into. (ACTION, EXPERIENCE) Following is another example of an expert opinion narrated by the trained professional: According to Terrance Real, when a father undermines the mother's parenting authority and treats her as “only a woman” he gives the sons the false impression that they are better than any woman just because they are males. (143)

The question and answer session resumes as follows: Q Do you think David was “feminine” because instead of learning how to be a man like Max he was closer to his mother? Sample Response: No. Most people think that being close to their mother make boys feminine but it's not true. Terrance Real said that forcing a boy to be though is not healthy. He said that warm and loving fathers or fathers with “feminine” qualities are better role models to the boys than fathers who conform to traditional stereotypes of masculinity. (Real 141)

Trained professional asks participating individuals to point at the area in the Behavior and Self diagram where this falls into. (WHO WE ARE) Q What kind of problems do you think men have as a result of undermining their mothers? Sample Response: Validate participants' response Trained professional asks participating individuals to point at the area in the Behavior and Self diagram where this falls into. (PERCEPTION, ATTITUDE AND EXPECTATIONS) Following is another example of an expert opinion narrated by the trained professional: According to Terrance Real, boys that are emotionally disconnected from their mothers have problems with close relationships. They reject their emotions and the sensitive part of themselves because they see them as feminine. Just like women have to develop their masculine aspect, men also have to develop their feminine aspect in order attain their whole human potential or become whole, like the Ying Yang. Mr. Real says that boys don 't need to be forced to disconnect from their mothers. It is a natural process that happens to all the young when they grow up. At that time young people stop relating to their parents as children and are able to develop a mature relationship with their mothers instead of disconnecting. (Real pg. 137 & 144)

The question and answer session resumes as follows:

Q What do you think is the “cycle of violence”? Sample Response: Most victims of family violence go through a three phase cycle. The first phase is the psychological cycle when tension begins. The abuser blames the victim for the problems. The second is the phase of reconciliation of love and repentance. The abuser admits to over reacting to whatever the victim did wrong and agrees to let it go. The third phase is confusion, when the victim tries to convince him or herself that if he or she tries harder things will change and the cycle starts over again. Q What do you think Max gained by telling David he could kill him any time he wanted to? Sample Response: He gained power and control over him. Trained professional asks participating individuals to point at the area in the Behavior and Self diagram where this falls into. (ADAPTATION) Q Do you think it's OK to call children names or that by doing that the children will apply themselves and do better? Show me where other peoples' opinions are located in the Behavior and Self diagram. Sample Response: No, it's not OK. Children may do better but it will scar them. In the Behavior and Self diagram we can see that these negative experiences affects both their behavior and their self perception. Trained professional asks participating individuals to point at the area in the Behavior and Self diagram where this falls into. (WHO WE ARE.) Q Why do you think children in similar situations stay in the home? Sample Response: They think that nobody cares because they have a negative perception of the environment or think they need to stay to protect their mother and sisters. Trained professional asks participating individuals to point at the area in the Behavior and Self diagram where this falls into. (EXPECTATIONS & ENVIRONMENT) Q If Mary had listened to Suzanne's accusations and given her security do you think Suzanne's life would have been different? How do you think it would be? Sample Response: (Validate participant's response)

Trained professional asks participating individuals to point at the area in the Behavior and Self diagram where this falls into. (ENVIRONMENT)

Q Do you think that threats are also forms of abuse? Sample Response: Yes. If the person threatened feels helpless it is a form of abuse. Trained professional asks participating individuals to point at the area in the Behavior and Self diagram where this falls into. (PERCEPTION, EXPECTATIONS) Q What do you think Max was trying to accomplish when he threatened Mary with leaving her? Sample Response: He was establishing his superiority and making her conform to patriarchal traditions and religious attitudes toward women. Trained professional asks participating individuals to point at the area in the Behavior and Self diagram where this falls into. (ADAPTATION) DISTRIBUTE POWER AND CONTROL WHEEL HANDOUT

Q Why do you think Mary reacted the way she did to Max's threats?

Sample Response: Mary had a poor perception of herself. Her attitudes and expectations were also low. She believed that he was right and that she and her children were wrong. She did not know about the cycle of violence. Trained professional asks participating individuals to point at the area in the Behavior and Self diagram where this falls into. (ATTITUDES, EXPECTATIONS)

Q What do you think David could have done to protect himself from Max's violence?

Sample Response: File charges with the police, talk to the school counselor, finding a safe place for him and his sister to go to, etc. Trained professional asks participating individuals to point at the area in the Behavior and Self diagram where this falls into. (ACTIONS) Q Why do you think people like Mary stay in abusive relationships? Sample Response: The concept of self is affected. The more people stay in the relationship the more passive and submissive they becomes until they reaches a state of hopelessness. Trained professional asks participating individuals to point at the area in the Behavior and Self diagram where this falls into. (ACTIONS) Q Do you think that people that kill someone in the heat of an argument should be exonerated or be free from responsibility if they have no prior criminal record? Sample Response: No. Following is another example of an expert opinion narrated by the trained professional. Dr. Steven Samenow says that even though the crime may not be premeditated, the criminals have fantasized about inflicting pain or killing their victim. People that commit these crimes see themselves and react to the world the same way as a criminal. They are inflexible, impatient, and demand that others do what they want (pg. 120)

AT THIS POINT THE DISCUSSION IS ENDED AND THE PLAY IS RESUMED.

5.—Staging Instructions and Stage Set Up

Suzanne looks for a way out of her problems. Suzanne is standing at mid center stage fixing her dress and checking her shoes. Jenny is sitting at back right stage. She looks sick. She is coughing and placing her hand in her throat and stomach acting sick. She freezes. (Bell) Suzanne looks upset. She swings the purse over her shoulder she walks to stage front left. Facing the wall she glances side to side. She rubs her face and looks distressed. (Bell) Suzanne looks arrogant. She lifts her chest and walks very properly with almost no hip movement and her purse dangling from her bent arm to stage left back. Jenny coughs. Facing the wall Suzanne glances side to side and freezes with her chin against her chest. (Bell) Suzanne looks frustrated. She walks to center back stage with her purse clutched against her side. She turns to face the audience and waves with both hands as if trying to get someone's attention. She stops and lets her arms fall to the side looking defeated. (Bell) Suzanne looks depressed. She walks slowly dragging her purse on the floor to stage back right. She freezes. (Bell) Suzanne walks to Jenny who asks her to take her to the hospital. Suzanne paces upset in front of Jenny then walks to stage front center and whistles to call in a cab. Dialogue between Suzanne and Jenny Suzanne: You know I need to play my cards right. I want to be taken care of, and I think Carlos is my ticket out of this dump. Jenny: (coughing persistently). Go ahead and go without me. If I rest today I'll feel better tomorrow. Suzanne: Fine. I'll go without you. Narrator: When Suzanne had her baby, her mother forced her to give him up for adoption. But it wasn't long before Suzanne got pregnant again. This time, her mother kicked her out of the house. Suzanne went to a runaway shelter. While she was there, she had a miscarriage and lost her second baby. Now she was working the streets, thinking she was in control of her life. But her childhood problems left deep scars in her personality. Her suicidal thoughts, her anger and her shame never disappeared. The nightmares and the flashbacks continued to haunt her in spite of her denial. Suzanne didn't understand that she was still reacting to her mother's rejection and to Max's deranged manipulation. The loss of security and self-acceptance during her childhood gave her a distorted view of reality. Her response to rejection was to see herself as superior to ordinary people. She had the illusion that one day she would be discovered by a rich man or a prince who would see through her loose lifestyle and discover her heart of gold. Jenny: (Coughing even harder, she gets up and bends over as if to throw up. Pause and lights go out). Suzanne: What a waste . . . I get a new dress and take the time to fix myself extra nice, because Carlos says he's coming to get us for his party. I wait at the same place for almost an hour, then I see him drive by with some other girls. They're all laughing loud and the girls are jumping around in his convertible. I waved at him but he didn't even give me a second look. I hate my life. I hate everybody. There is no God . . . No justice in this world. Narrator: As Suzanne's illusion gained power she felt more and, more obsessed with making it come true. This created a conflict with her reality. She would get anxious and desperate every time things didn't work out the way she imagined. She was so obsessed with the idea of being rescued by a rich man that she thought going back to school or learning a new skill would only interfere with her goal.

In Suzanne's mind, fantasies and daydreams replaced a painful and unacceptable reality. She wasn't aware that she was wasting her life waiting for those illusions to materialize. She couldn't accept the fact that her dreams were unreal and that the chances for them to come true were no more than a fairy tale. Jenny: Suzanne. . . . I . . . I think I need to go to the hospital (coughing and choking). Suzanne: Why are you doing this to me? Last time you were sick you didn't go back for more medicine. You better do what the doctor tells you because this is getting really old. I . . . I'm sorry. I didn't mean it. I'll be right back. I'm going to get a cab.

6.—Staging instructions and stage set up: Suzanne is in the waiting room of the hospital waiting for Jenny.

She is reading a magazine. A woman is sitting with a crying baby when Suzanne enters stage right.

(Bell) Woman with baby exit stage left. Suzanne finds a magazine in the chair she i about to sit in. She reads the cover of the magazine out loud. Then she opens the magazine and begins to read. Suzanne keeps her eyes in the magazine all the time, flipping pages from time to time. (Bell) a man enters stage left looks around and sits at empty chair. He freezes.(Bell) two women enter together stage right one helping the other one walk. They both sit and freeze. (Bell) the man raises his head as if someone had called his name and exits stage left. (Bell) the woman who was helping the other one excuses herself and exits stage right.

Monologue by magazine writer Suzanne: (picks up a magazine and begins to read aloud). “I was cursed with bad luck.” Yeah, I can relate to that. . . . Writer: My problem was that I was born poor and with my parents worst traits. I didn't choose to have my father's ugly nose or my mother's stocky body. I didn't choose to live in government housing, or be called names and made fun of by the kids at school. I was so used to feeling sorry for myself that I didn't even see that I was using my bad luck as an excuse to stay down. Bad luck kept me chained. What if I fail? With my bad luck chances were greater. I thought I would never be successful, that I shouldn't even try. I had accepted my fate, accepted that I was an inferior person. When people tried to help me by encouraging me to try, I would tell them; ‘It's too hard. I'll try but I know I can 't do it.’ I would say, yes but in my mind I would tell myself, ‘I can 't because I have to do all these other things first. One day I realized that rich and beautiful people also had bad luck. I noticed that those people, people that seemed to have everything I've ever dreamt of having, people like famous musicians and movie stars Were being arrested for drugs, treated by depression and some of them even committed suicide. One days I came to the conclusion that in reality none of us, are born in perfect conditions. I realized that the great leaders of humanity did not let their bad luck stop them. On the contrary they were determined to change the world around them. Their condition helped them understand other people with their same limitations. Instead of feeling helpless they used their bad luck as a source of energy that pushed them to fight. My life took a radical turn when I threw my bad luck out the window. A year ago I would have never thought to have an article published in a popular magazine like this one. I no longer say I can't, because I know that can if I want to, and am willing to do what is necessary to achieve it. Bad luck is like those monsters that scared me when I was a little girl. I had to grow up to realize they didn't exist.

AT THIS POINT THE PLAY IS STOPPED FOR DISCUSSION OF MATERIAL PRESENTED SO FAR TRAPPED BY BAD LUCK

Q Tell me about the time when things you were expecting to happen didn't work out because of your bad luck. Sample Response: (Validate participants' response) Q Were you taking a risk or gambling? Sample Response: (Validate participant's response) Trained professional asks participating individuals to point at the area in the Behavior and Self diagram where this falls into. (EXPECTATIONS & ACTIONS) Following is another example of an expert opinion narrated by the trained professional Risk's are taken after evaluating the possibility of gain or loss. But to gamble is to take a chance with the odds against you. (Wong, pg. 304) The question and answer session resumes as follows Q Is playing the lottery a gamble or a risk? Sample Response: It's a gamble. Professor Harry K. Wong said that your chances of winning the state lottery are 14 million to 1. (pg. 305) Q Is being successful at something a gamble or a risk? Sample Response: It is a risk. Professor Harry K. Wong said that the odds of success in whatever a person chooses to do are 1 to 1. There is only one person they ever need to compete against and that is themselves. (pg. 305) Q Do you think Suzanne was right in thinking that she was born with bad luck? Explain why? Sample Response: No, she was not doing anything to succeed. She was hoping for someone like Carlos to rescue her. Trained professional asks participating individuals to point at the area in the Behavior and Self diagram where this falls into. (EXPECTATIONS) Q Do you think that Suzanne's expectations were realistic? Explain why. Sample Response: No. Because for them to become true other people had to act the way she wanted them to. Q How do people that believe in bad luck think like those with criminal tendencies? Sample Response: They both expect people to act the way they want them to, they blame the world for their problems; they want to have a good life without sacrificing or having to work for it. Trained professional asks participating individuals to point at the area in the Behavior and Self diagram where this falls into. (ATTITUDE,EXPECTATIONS)? If a friend invites you to a party, how do you decide whether to go or not? Sample Response: I think what I am going to gain or lose by going. Trained professional asks participating individuals to point at the area in the Behavior and Self diagram where this falls into. (ACTIONS) Q If you decide to study computers because someone told you that there are lots of jobs in that field, how would you know if you are taking a risk or a gamble?

Sample Response: (Validate participants' response)

Following is another example of an expert opinion narrated by the trained professional. According to Dr. Wong, before taking a risk a person needs to 1) know what he or she is doing. For example, have you used a computer before? Do you like sitting in front of the computer for hours? 2) Have a plan of action. How much time are you willing to invest to learn the technology and to retrain? 3) Have sufficient resources. Do you have a natural aptitude to work with machines? Have a way to support yourself while training? Have enough time to study? Etcetera.

Trained professional tells a story for clarification: A middle age man that had been on probation for over 6 years told his new probation officer that his goal was to go back to school and study computers. The young officer was happy to hear that at least this one man wanted to do something with his life. After the man left the officer decided to learn more about the man from the time he was placed on probation. To his surprise he read in his file that this man had been talking about his goal for years and had done nothing about it. Following is another example of an expert opinion narrated by trained professional. Educator Harry K Wong said: “Nothing will ever be accomplished by sitting around doing,nothing, making butt prints in the sand of time” . . . “doing nothing is even more dangerous than gambling” (on the other hand he pointed out) accomplishment and rewards go to those who take risks” (pg. 304)

AT THIS POINT THE DISCUSSION IS ENDED AND THE PLAY IS RESUMED

7.—Staging Instructions and Stage Set Up

Suzanne is in the hospital waiting room and finds out that Jenny has AIDS. Suzanne looks irritated at the woman with the crying baby when a nurse enters stage right and stands in front of Suzanne. (Bell) Suzanne gets up and walks with the nurse towards Jenny who is sitting with a blanket across her legs. The three of them take turns talking. While one of them talk the others react to what is being said. The woman with baby stays on stage. Jenny tells Suzanne she has AIDS and Suzanne turns to the nurse in disbelief. Jenny asks Suzanne to get tested and the nurse backs up Jenny. (Bell) Suzanne wags her finger at Jenny refusing to take the test and distances herself from both. The nurse paces calmly and talks about HIV. (Bell) Suzanne slowly begins to calm down. She moves close to the nurse and asks her about the test. (Bell) The nurse gives Suzanne a pamphlet with information. They all freeze.

Dialogue between Suzanne Jenny and the Nurse

Nurse: (approaches Suzanne) Excuse me, are you Jenny Gonzalez' relative? Suzanne: No, I'm her roommate. Is she ready to go home? Nurse: We're done with the exams and she wants to see you. Jenny: (Suzanne follows the nurse to Jenny) I . . . I want you to be here in case my friend has any questions. Suzanne: What's wrong?You're not getting dressed. Why are you crying? Jenny: I'm not coming home with you. . . . I have to stay here for a few days. Suzanne: Why? What's wrong? . Jenny, I have AIDS. (she breaks down and cries). Suzanne: (turning toward the nurse) What does that mean? Nurse: Your friend is in the final stage HIV. Suzanne: But she's young. She can't be sick. Go on Jenny, tell the nurse you're fine. You just have a bad cold, that's all. Jenny: (trying to control her tears) I wish it was . . . (Sobbing) Suzanne, the nurse has been asking me lots of questions . . . and I had to be honest. . . . I had to tell her about my sex life. You and I have been working the streets for a while and have had sex with the same Johns. (sobbing) That's why I want you to get tested. Suzanne: (gets upset and walks toward the door) I don't need to be tested. I'm not sick, and none of the men I've been with seemed sick. . . . You know that Jenny. I don't need to be tested. Nurse: Your friend is only trying to help you. Once infected with HIV, a person may feel healthy and have no symptoms for up to 15 years or longer. That's what we call asymptomatic HIV infection. The problem is that during this time the virus can be passed from the infected person to others through. Your friend is naturally scared, for herself and for you. She doesn't want you to go through the same thing. That's why she wants you to take the test. No one can force you. It's voluntary, and the results are confidential. That means that no one can be told the results of your test unless you've give us written permission. Jenny: Suzanne, please do it. Don't wait until it's too late like I did. (She sobs and covers herface with her hands) Suzanne: (addressing,the nurse). Do you mean that one blood test will-tell me if I'm OK? Nurse: No. It takes the body at least two weeks and as long as six weeks from the last time you had sexual contact or shared a needle to develop enough antibodies for HIV to register a positive test result. In some cases, people have not registered positive after nine months, but have gone on to develop AIDS. That is why we advise our patients to wait for three to six months after their last risky behavior before testing the first time, and instruct, them to come back and be tested again three months later. We recommend this because there's a time lag. During the time lag, a person could register negative on the HIV antibody test, but still be infected with the HIV and be infectious to others. Suzanne: So no sex or any other risky behavior for three to six months before I can first be tested? Nurse: That is correct if you want to have accurate results. Though condoms are recommended as a preventive measure, I want to be sure you understand that they are not 100% safe. AT THIS POINT THE PLAY IS STOPPED FOR DISCUSSION OF MATERIAL PRESENTED SO FAR SEX AND SURVIVAL

Q Why do you think that HIV/AIDS prevention is always included in drug & alcohol rehabilitation programs? Sample Response: Because people who use drugs and alcohol are more prone to act impulsively or be careless while under the influence.

Trained professional asks participating individuals to point at the area in the Behavior and Self diagram where this falls into. (ACTIONS)

Q Do you know someone with AIDS? Can you share with the class how has this person's life changed? Sample Response: Validate participants' response Q How else do you think having AIDS affects a person's life & the life of his loved ones? In particular, how does having AIDS affect a person's personal life, their family, their ocial life and their economy? Sample Response: Validate participants' responses. Trained professional asks participating individuals to point at the area in the Behavior and Self diagram where this falls into. (ENVIRONMENT) Q Do all venereal diseases have symptoms in their initial stages? Sample Response: No. Diseases like HIV and syphilis are asymptomatic in their initial stage. Q Give me some reasons why men and women engage in casual sex? Sample Response: To meet physical needs; to meet economic needs, to meet emotional needs such as acceptance or to feel loved, to cover a sense of failure by trying to build the self-esteem with multiple sex partners.

Trained professional asks participating individuals to point at the area in the Behavior and Self diagram where this falls into. (EXPECTATIONS & ACTIONS)

Q In your opinion are young people more likely to have venereal diseases than older people? Sample Response: Yes

Trained professional asks participating individuals to point at the area in the Behavior and Self diagram where this falls into. (ENVIRONMENT & ACTIONS)

Following is another example of an expert opinion narrated by the trained professional: Young people continue to have the most incidents of infection, but now with the introduction of Viagra people in their 50s, 80s and even 90's are more sexually active and the number of venereal diseases among this group has increased significantly.

The question and answer session resumes as follows: Q Aside from the sexual partners, who else may be infected with a venereal disease? Sample Response: Unborn children of people infected with HIV and syphilis can suffer from physical problems and mental impairments and even death due to the disease. Q How can men tell if they have a venereal disease? And how can women tell? Sample Response: Men can see anomalies in their sexual organs, women cannot; therefore they are more likely to ignore the initial symptoms. Q Is having casual sex a risk or a gamble? Explain why. Sample Response: A gamble because you are taking a chance with the odds against you.

AT THIS POINT THE DISCUSSION IS ENDED AND THE PLAY IS RESUMED

8.—Staging instructions and stage set up David has problems finding a job and decides to sell drugs. David is standing sideways at center stage. He straightens his shirt and pants and fixes his hair. A man stands at center right stage. Limping David walks to him. He shakes the man's hand and gives him a job application. The man glances through the document, gives back to David and shakes his head and gestures an “I'm sorry” to David. David takes the application and stays with his hand stretched then he moves to the audience and offers them the application. No one takes it. (Double bell) David un-tucks his shirt and fixes his clothes to look more street wise. He tries to walk cool in spite of his limp and moves to stage front right. (Double bell) He stops and turns to face the back wall and lifts his head to the side as if listening to the ambulance. He freezes.

Narrator and David's monologue: Narrator: The first week David was out, he applied, for jobs in different stores. He moved in with his mother, thinking he could get his own place within a month. But even though he expected some rejection, he couldn't avoid hurting each time it happened, and his optimism soon vanished. By the third week, he went through the motions, thinking it was a waste of time. His stress and frustration made him look for an escape, a way to cope. He stole a few dollars from his mother and bought some drugs from Dog. He'd known Dog since they were kids, and after rekindling their acquaintance he decided that the only way to survive was to become a dealer like Dog. Dog agreed to give him a chance and gave him some drugs on credit. David: (remembering) The ambulance took my mother to the hospital cause she went out and almost got run down by a car. As soon as they all left I got the drugs I'd hidden in the back of the closet and headed out to find Dog.

9.—Staging Instructions and Stage Set Up

David remembers his last encounter with Dog and his failed effort to straighten up his life. David enters stage center right and meets up with Dog. Dog is leaning against the wall smoking. He looks bored and takes a few steps to meet David. Dog gets agitated and paces angrily with his fists closed and chest up while he listens to David. David looks afraid of Dog. (Double bell) David pulls a small package from his pocket. (Bell) Dog takes the package and looks upset. He opens the package and begins to separate the content as if counting. He moves toward David and gets on his face. (Double bell) David pulls back and takes a few bills from his pocket. He gives them to Dog. Dog snaps the money out of his hands. (Bell) Dog gives David a push and makes him fall over a trash can. Dog exists stage left. David sits on the floor then slowly gets up and rugs his knee and shoulder. He takes three steps to the front and stops. (Imagine your house and look at the walls, the ceiling, the fixtures. Go to an imaginary table. Pick up something and put it down) (Bell) David pulls out a joint from his pocket. He slumps in a chair and begins to smoke.

Dialogue between David and Dog Dog: Hey Dave, got something for me? David: Well, yeah but I need to talk to you. Dog: What about? I'm not in the mood for bad news. David: My mom got sick and the police were at the house. They, they had a search warrant. Luckily they didn't find the stuff. I can't have this in the house anymore. They're coming again tomorrow and if they find it I'm doomed. Dog: You mean you haven't,sold it yet? David: Well, no, I mean I've sold some. Dog: How much do you have left? David: Ten packs. Dog: I gave you thirty. So give me the money for the rest. David: I don't have all the money, I'm, I'm gonna have to owe you. Dog: What do you mean you're gonna have to owe me? You damn stoner, you smoked the stuff yourself! I should have known better than to trust you! Give me what's left! Now I'm gonna see what you have here, and I want the money for what's missing by tomorrow. Do you hear me?, Don't think I'm gonna give a crap about your story. You stoners are all full of those stories. I don't care about your damn mother. Just be sure to give me the rest of the money by tomorrow, got it? David: I, I have some of it. Dog: Good. But the deadline is still tomorrow. David: (Thinking) I tried to do the right thing, but I didn't have a chance, with my criminal history and my disability. I didn't think staying in this house would be so hard. My mother was always drunk, talking and fighting constantly with an imaginary Max. She was like crazy. When she noticed I was there, she would try to fight with me and follow me around telling me that I was an evil person, that God would take care of me. She'd say that Max was like the father I never had. I would try to avoid her by sneaking in and out of the house. Once I was in I would lock myself in my room. I felt like I was still in prison. I didn't feel like going out. I just wanted to stay high all the time. 10.—Staging instructions and stage set up

David finishes conversation with social worker and goes to see Rev. Crane for help. Rev talks to David about truthfulness. David stands at back left stage fixing his hair. He walks to left front stage to meet social worker. They stand there and talk. David shifts his body away from her by, putting most of his weight on one foot. He rubs his face and holds up his shoulders as he listens. She jiggles her car keys at his face as she talks. (Bell) The Social Worker exits stage left. David waves at her timidly. He runs his hand through his hair, checks his pockets glances side to side as if trying to decide what to do. Rev. sits at right chair. (Double bell) David walks to the table and acts with Rev. as a child negotiating something with a parent. Rev sits leaning on the back of the chair he looks at David while playing with a pen. When David finishes talking, Rev begins to gesture as if speaking. (Bell) Rev. sits and leans torso forward towards David. He uses his pencil as a pointer. (Bell) Rev. stands paces around the desk and ends up in front of David. David leans back.

(Bell) Rev. sits places his elbows on the desk and leans toward David. (Bell) Rev. stands paces around the desk and ends up in front of David. David stands facing him.

Dialogue between David and Rev. Crane

Narrator: David was getting ready to head to the hospital when a social worker showed up at the door. She asked him a lot of questions and told him that if his mother was determined to be permanently impaired they would place her in the custody of the state. She admitted that she did not think that he or his sister would qualify to be their mother's legal custodians. She explained that his mother's house would probably be sold and the money placed in a fund to pay for her living expenses. After the social worker left, David's first impulse was to get high. He needed help and went to see Rev. Crane.

David: (talking with Rev. Crane). But you don't understand. As soon as I limp my way into a business they've already decided that they don't want to hire me because of my handicap. They think I can't move fast enough or though they have to make special accommodations for me. If I'm lucky enough to get my application in, my chances ark even slimmer once they read that I'm an ex con.

Rev. Crane: Has anybody come out and told you this point blank; or is this just another one of the lies your mind's been telling you? When are you going to see that you're not a despicable little worm! If you can't see yourself as a valuable human being, at least think of yourself as another kind of worm, for instance, a caterpillar. “Think of today as the day of your transformation! The day you freed yourself from the cocoon; the day you discover that there's more to you than you ever thought; In other words, make this

the day you discovered your potential.” (Alcantara Rodriguez pg. 29)

OK, a transformation of this magnitude doesn't come easily. You'll be faced with many trials before you'll be able to see yourself differently. Do you know what your first trial will be? I'll tell you, it's something you probably don't even think is important but it is. It's a moral virtue or a God-like quality that doesn't come easily like joy or love, but one we have to work for all the time. I never thought truthfulness was so important until Mr. Escudero, one of my teachers, explained it to us during his class he said, “When people don 't get what they want by lying they'll steal. Then when they can 't get what they want by stealing, they cheat. And when they can 't get what they want by cheating they'll kill, yes, there'll kill people and even themselves”. (Low Five and the High Five to Ten) Back then I remember this one guy, Steve, was always late for class. We thought he was clever because he'd always come up with these creative excuses. I can still picture Mr. Escudero that one day. Steve came in late again. Mr. Escudero looked at Steve with an intent look in his eyes and before Steve could say anything, he said, “Lying kills the truth with words. Lying kills kindness; and steals people's trust.” (Low Five and the High Five to Ten) After saying that directly to Steve he turned to us and said, “every time a man cheats-he's killing honesty by destroying the trust that people gave him. A liar doesn 't have any friends. Nobody wants to be friends with a liar. Nobody will want to put up with his stories. Nobody will want to live with him, so he'll have no choice but to live alone!” (Low Five and the High Five to Ten) Steve just sat down and didn't say anything. But after that day, he was never late again. “There's no such thing as little white lies. Most people don't realize that little lies end up becoming big lies. Once they tell the first lie a second and bigger lie will follow to cover up the first one. Lies always multiply and get bigger and bigger with time.” (Low Five and the High Five, to Ten) Listen to me David, if you're ready to change. If you're ready to take the first step to becoming an honest and trustful person and want to have good relationships with others. You have to start by being truthful. That means you don't lie about your criminal history. You need to have the courage to be honest even if it means rejection and makes it harder to get a job. Don't do like some people who claim to be honest when they're not, or say they're giving when they're really greedy, or claim to be nice when they're really mean. These people aren't being truthful. They're only fooling themselves when they make those claims, they think that people don't see through them, but their actions are telling a whole different story. Honesty and truthfulness, I think, are the most difficult and most important moral virtues. That's why you need to be truthful before you do anything else.

AT THIS POINT THE PLAY IS STOPPED FOR DISCUSSION OF MATERIAL PRESENTED TRYING AND NOT SUCCEEDING: Q When David realized he could no longer get money from his mother he went to see Rev. Crane. What other choices do you think he had? Sample Response: Get money from his sister, steal, prostitute himself, etc. Trained professional asks participating individuals to point at the area in the Behavior and Self diagram where this falls into. (ENVIRONMENT)

Following is another example of an expert opinion narrated by the trained professional: According to Dr. Stanton Samenow we think that society and the environment turn people into criminals but that is not true. Crime did not get worse during the depression and lots of people that live in difficult environments have not become criminals. He said that people with criminal tendencies choose to deal with adversity different from regular people. (pg. 15-17)

The question and answer session resumes as follows: Q Why do you think David approached Rev. Crane by telling him that nobody would hire him? Sample Response: To make Rev. Crane feel sorry for him and con him into giving him money. Following is another example of an expert opinion narrated by the trained professional: According to Dr. Stanton Samenow, people with criminal tendencies, regardless of their education and economic means, see people as pawns to be pushed around at will. Trust, love, loyalty and teamwork are incompatible with their way of life. (pg. 20-21)

The question and answer session resumes as follows: Q Do you think that David's reasons for not finding a job were valid? Explain why. Sample Response: No. Other people with handicaps and criminal histories have jobs. Trained professional asks participating individuals to point at the area in the Behavior and Self diagram where this falls into (ATTITUDE). Q Do you think it was OK for David to con Rev. Crane if that was to keep him from being hurt by Dog? Under what other circumstances is it Ok to con people?Sample Response. Its not Ok for David to con anybody to get out trouble. The ends do not justify the means. Trained professional asks participating individuals to point at the area in the Behavior and Self diagram where this falls into. (EXPERIENCES) Q Besides conning people, what other ways do people with criminal tendencies use make people give them what they want? Sample Response: they threaten them or act in a threatening way by raising their voice, destroying things, clenching their fists and other violent acts. (Samenow, pg. 99) Trained professional asks participating individuals to point at the area in the Behavior and Self diagram where this falls into. (ACTIONS)

Q Do you think that selling drugs was David's only choice or his best choice? Explain why. Sample Response: It was his best choice. He probably thought that he could make money from selling than from a regular job. Following is another example of an expert opinion narrated by the trained professional: According to Dr. Stanton Samenow the idea that people with criminal records can 't find jobs because of their past, their lack of skills and low self-esteem is not true. People with criminal tendencies are not interested in a regular job n,o matter how much it pays. They are only interested in, crime. He said “If something is legitimate, to them it is hardly worthwhile. (pg 85-86).

The question and answer session resumes as follows: Q How do you think David felt after his meeting with Dog? Sample Response: He was afraid, and felt dehumanized. Trained professional asks participating individuals to point at the area in the Behavior and Self diagram where this falls into. (PERCEPTION) Q In your opinion, can drug dealers' threats make an addict give up drugs? Explain why Sample Response: No. It's part of the excitement of the life style. Q Why do you think people like David have more problems than others to be completely honest? Sample Response: (Validate participants' response) Trained professional asks participating individuals to point at the area in the Behavior and Self diagram where this falls into. (PERSEPTION, ATTITUDE) Following is another example of an expert opinion narrated by the trained professional

According to Dr. Samenow, people with criminal tendencies know that they have an upper hand over others and get a sense of power by keeping secrets from other people. (pg. 99) The question and answer session resumes as follows: Q Do you think David saw himself as a decent person? Sample Response: Yes. Following is another example of an expert opinion narrated by the trained professional In his studies Samenow discovered that most people with criminal tendencies can shut down their negative emotions like fear, guilt, and self doubt while going after what they want. Dr. Steven Samenow says that people with criminal tendencies don 't see any contradiction between prayer and crime. Both are right for them depending on what they want at a particular time. They use their religiosity to wash away their crimes and feel free to continue doing what they want. (pg 162 & 171) The question and answer session resumes as follows: Q Rev. Crane told David he needed to be truthful and not to lie about his criminal history. What other things do drug addicts need to be truthful about? Sample Response: They need to be truthful about their addiction, their criminal tendencies and their lack of responsibility. Trained professional asks participating individuals to point at the area in the Behavior and Self diagram where this falls into. (EXPECTATIONS). THE DISCUSSION IS ENDED AND THE PLAY IS RESUMED

11.—Staging Instructions and Stage Set Up

Rev. Crane tells David to look at his problems differently, to use his job qualities and sends him off to get a job. David gets up and pleads with Rev. Rev. turns and walks toward his chair and stands holding the back of the chair. (Bell) Rev. motions David to sit. David sits with curved back. Rev. sits with straight back. (Double bell) David leans on the desk and begs Rev. for money. After David finishes pleading Rev. begins to talk. He leans forward to make his point. (Bell) Rev. and David stand., Rev. moves next to David and pads him on the back. David begins to leave when Rev. taps him on the shoulder. David turns and listens to what Rev. has to say. (Bell) Rev. and David shake hands. Rev walks to the desk and sits. David exits stage right. Dialogue between David and Rev. Crane David: But I have to come up with the money I owe Dog for the drugs today or he'll kill me. Why can't you lend it to me? I promise I'll pay you back. Rev. Crane: Sorry David, I can't do that. You need to take care of that business on your own. Instead of a problem, try to see it as an opportunity to test your personal strength. Believe me, I know looking for a job isn't easy, and it takes a lot of time. It'd be wonderful if you found a good-paying job that would let you get rid of your debt in a just a few days, but let's be real, there's a lot of unemployed people with more skills than you, competing for those jobs. I know you're pressed for time, that you need to take care of your debt now. That just means you can't be picky. Remember, “Success doesn't come by chance but by a lot of effort and hard work.” (Alcantara Rodriguez pg. 38) Look for jobs where there's a chance of getting hired on the spot, where they won't put you through long interviews and background checks, you know, like in construction or in restaurants. David: At five fifteen an hour it's gonna take me a couple of weeks to come up with the money I need. Rev. Crane: First get the job. Then talk to this guy Dog about payment. Once you do that, stick to the agreement. He's a businessman and he knows he'll get his money faster if you're working instead of in the hospital. Now go down the street and look for help wanted signs in restaurant windows. Remember that attitude speaks louder than words, so be sure to have a good attitude. Goody bye David and good luck. David: Bye Rev. Crane Rev. Crane: “Before you go I have to tell you one more thing: In every job, no matter what it is or how much it pays; employees who are dedicated, who try to do their work well and don't have excuses for not doing their job, will always be in demand. Employers like to have people in their business who don't criticize others; who don't put their company down and who treat others with respect.” (Alcantara Rodriguez pg 38-39). “They want people who are willing to help no matter what needs to be done and especially they want people who don 't mind being corrected. Keep an eye on your attitude even after you're hired. Be sure to have an attitude of service, not just for your boss, but with the customers and everyone who works with you.” (Alcantara Rodriguez 38-39) Now, get going, and good luck. Come and see me tomorrow, so we can start planning the next step: facing your drug problem. 12.—Staging instructions and stage set up Pedro talks to David about his life, how he focuses on the positive doesn't compare himself with others. David and Pedro are standing behind the restaurant taking a brake and talking. (Bell) Pedro removes his apron and tells David his story. David lights a cigarette and smokes while he listens. He looks at Pedro as he talks. Pedro gestures with his hands as he speaks. (Double bell) David asks Pedro a question and listens to him as he squats or leans against a wall. (Double Bell) David moves closer to Pedro and makes a comment. Pedro gestures with his hands as he speaks. (Bell) Pedro waves at David and exits stage left. David waves back and takes a few steps to center back. He stops and puts off his cigarette, run his hand through his hair and freezes. Dialogue between David and Pedro David: (standing and smoking). Tell me, Pedro, how long you've worked here? Pedro: Six months. David: I don't know if I can last here more than a week. My hands are peeled off and sore from soaking them in that hot water. The dishes just keep piling up no matter how fast we move. Pedro: I'm just happy to have a steady income. When I first got here I used to stand in the corner with a bunch of other immigrants, waiting for a contractor to pick us up. I dug ditches, climbed on roofs, carried bags of concrete. You name it, I've done it. One time a guy picked me up and he said he just needed one man to do some yard work. I worked with the shovel all day in the hot sun and he didn't even offer me a glass of water. When I was done and I asked him for my pay, instead of giving me my money he picked up a bat and hit me on the back. He said he was going to call the police and the immigration department because I was stealing his tools. I couldn't hit him back. I didn't want to go to jail, so I left. I had to walk all the way back to where I lived. I was tired and hungry without a penny in my pocket. David: Why didn't you let him call the police and tell them he owed you money? Pedro: At that time I didn't know any English, so I couldn't explain to the police what happened; I had to swallow my anger and leave. I didn't want to go to jail because I knew that once I was there I would get deportied. As I walked back home I remembered how much I wanted to come to this country. I had heard stories about immigrants getting killed by racist people, but I didn't think it could happen to me. David: But you seem so happy all the time. How do you do it, after all the things you've been through, and making minimum wage? Pedro: I don't compare myself to other people. My grandma was a countrywoman. She never went to school, but she was a wise woman. She knew a lot about life. She used to tell us, “Comparing yourself with others will make you realize what little you have and how different you are from them.” You need to know what my mother and father went through just to put a roof over our heads, to understand how much better my life is. Back in town where I am from there is no running water and no electricity. Cars were only for the rich city folks. I don't have much here, but I have a small apartment with running hot water, food in the refrigerator and an old car that takes me wherever I need to go. You may think I'm poor and I am if you compare me with the restaurant owner. But I have a lot more than I used to have in my home country. David: Well, see you tomorrow. I've never worked so hard in my life; I'm tired, but I don't feel like going home. Hum, home, what a joke, a filthy old house full of filthy old memories I hated being there and having to put up with my mother. I should go see her in the hospital, but I don't know if, I'm ready to handle it. AT THIS POINT THE PLAY IS STOPPED FOR DISCUSSION OF MATEIRAL PRESENTED SO FAR RECOGNIZING THE TEACHER IN EVERYONE:

Q Compare how Pedro's attitude is different from David's. Sample Response: Pedro seems to be content with his life while David feels that the job he is doing is beneath him. Trained professional asks participating individuals to point at the area in the Behavior and Self diagram where this falls into (ATTITUDE) Following is another example of an expert opinion narrated by the, trained profession,al: Dr. Samenow says that people with criminal tendencies believe that they are more capable than people with more experience and training. They think they have special talents that nobody else has. When they don 't get recognition they think they deserve, they complain about lack of opportunity or discrimination. (pg 88)

The question and answer session resumes as follows: Q Pedro was willing to work hard to get ahead. Do you think David was willing to make the same sacrifices? Explain why. Sample Response: Probably not. Trained professional asks participating individuals to point at the area in the Behavior and Self diagram where this falls into. (EXPERIENCES, ACTIONS)

Following is another example of an expert opinion narrated by the trained professional: Dr. Samenow said “It is misleading to claim that the criminal wants what the responsible person wants, that he values the same things that a responsible person values. Both may desire wealth, but only ode will work, steadily and earnestly to acquire it and then use it responsibly. (pg 21) The question and answer session resumes as follows: Q Do you think that a job will be enough to change what David wants out of life?Sample Response: No. Trained professional asks participating individuals to point at the area in the Behavior and Self diagram where this falls into. (PERCEPTION)

Following is another example of an expert opinion narrated by the trained professional: Dr. Samenow says that people with criminal tendencies do not keep jobs for long periods of time because they get bored with the routine of the job. They have problems with their superiors because they insist on things done their way and argue with their co-workers and superiors. They usually find a way to take or steal from the business. In sum, a job does not change what a people with criminal tendencies wanted out of life. (pg 90-93)

The question and answer session resumes as follows:

Q Besides working a regular job what else would David need to do to change his lifestyle? Sample Response: He would have to.,question his beliefs and don't make other people responsible for his change. Trained professional asks participating individuals to point at the area in the Behavior and Self diagram where this falls into. (ATTITUDE, EXPECTATIONS) Q What do you think it will take for someone like David to give up his way of life, or to live without the excitement and exhilaration he likes? (EXPERIENCES) Sample Response: He would need to have a significantly emotional experience. Q During the first session we talked about body mind and spirit. Do you think that work has a spiritual value? Explain why. Sample Response: Yes. Work has a spiritual value when we do it for non-selfish reasons or when we work to benefit other people. Trained professional asks participating individuals to point at the area in the Behavior and Self diagram where this falls into. (PERCEPTION)

Q. Look at your handout with the list of virtues and identify the virtues that people can strengthen while they work? Sample Response: humility, compassion, appreciation, caring, discipline, endurance, friendship, patience, perfection, service & trustworthiness). Following is another example of an expert opinion narrated by the trained professional Work is an expression of spirituality. It gives a person dignity and value especially when the work is menial or unrewarded. But people see menial jobs as demeaning and pointless. This misconception combined with a distorted sense of entitlement takes away the spiritual value of work. (C. Jinarajadasa, pg. 94). NLP EXERCISE TO PROJECT A DESIRED FUTURE. AT THIS POINT THE MASTERY OF OBJECTIVES IS REVIEWED, THE FLOOR IS OPEN FOR COMMENTS AND THE SESSION IS FINISHED.

### EXAMPLE 4

Before class begins, individual participants take the attitude pre-test. A hand out called mastery of objectives is also given to individual participants at the beginning of the class. This mastery of objectives has a series of questions about the session. The individual participants will learn the answers during the session and discuss such answers at the end of the day.

1.—Staging Instructions and Stage Set Up

Suzanne leaves the hospital confused when she meets Ms. Wendy (Ms. W) an old neighbor. They go to have coffee and talk. Suzanne enters stage right. She looks sad and walks slowly to the center. She holds her temples, runs her hands through her face and glances up and down as she walks with her hands locked. (Bell) Ms. W enters stage left and meets Suzanne at center stage. Suzanne acts surprised as if something sparked in her hands. (Bell) Suzanne and Ms. W freeze while the narrator talks. Suzanne stands holding her head with one hand and wrapping her waist with the other. Ms. W looks at Suzanne with compassion. (Bell) Ms. W and Suzanne talk and gesture while standing. (Bell) Suzanne cries and sobs as she talks. They walk around the stage before sitting. Suzanne sits facing the right.

(Bell) Ms. W and Suzanne silt. Ms. W gets coffee from prop table. Suzanne acts sad as she talks. (Bell) Ms. W asks Suzanne about school and Suzanne seems angry as she recalls the experience. Ms. W looks at her as she listens. (Bell) Ms. W stands to get more coffee and sits. She tells Suzanne about her niece.

Dialogue between Suzanne and Ms. Wendy

Narrator: Suzanne walked out of the hospital even more confused than before. She'd been working the streets since she was 15. She'd never had a regular job. She had no skills and never even considered working for minimum wage. She thought it was stupid to work long hours when she could get the same money in just one or two hours. Suzanne: (thinking). Without Jenny I won't be able to pay for the apartment. And the stupid nurse is trying to convince me to stay off the streets. How does she think I'm gonna make it now when I don't have any money? Ms. Wendy: Hey, Suzanne. Suzanne: Oh! Ms. Wendy, you scared me. Narrator: Ms. Wendy lived two houses down from Suzanne's mother. She was not a close friend, but had always come to their rescue every time they had a family crisis. She was a religious woman who practiced God's commandments. She had known Suzanne since she was a baby and was happy to see her again. But when Ms. Wendy saw Suzanne's face she knew that something was troubling her. Ms. Wendy: Sorry Suzanne, I didn't mean to scare you. But I haven't seen you in such a long time, I wasn't sure it was you. Suzanne: Why? Do I look that different? Ms. Wendy: Well you're still as pretty as before, but you're a little taller and slimmer. Suzanne: (starting to sob) Thank you. I've had such a terrible day (cries). Ms. Wendy: Well, why don't we go have some coffee and see what's troubling you. Maybe I can help. Narrator: Suzanne was choking on her tears and not able to respond, so she nodded her head and between sobs Suzanne told Ms. Wendy about Jenny, the nurse and her predicament with work and money. She explained that she had no idea what to do. Ms. Wendy: Last time I saw you, you were still in school and if I remember right your brother had killed your stepfather. Tell me what's happened to you since. Suzanne: I didn't think it was that long. Hmm, well, David killed Max cause he'd got me pregnant. Then I had my baby. At first I didn't want the baby cause of Max, but I changed my mind after the nurse brought him to me right after he was born. But I couldn't keep'm because my mom made me give him up for adoption. I still dream of getting my baby back but I don't even know where he's at. Ms. Wendy: So did you ever go back to school? Suzanne: Yeah, but I didn't graduate. Things weren't the same after I got back from having the baby. Kids at school were mean to me and started calling me Suzanne the slut. They made up all kinds of stories about me, like I'd slept with the whole football team and didn't know who my baby's father was. I tried to set them straight but it was like the whole school had turned, against me. So I decided to do the slut thing and ended up pregnant again. When my mother found out she threw me out of the house. I had a miscarriage and here I am now, still living up to my school reputation; Suzanne the slut; the class whore. Ms. Wendy: Hmm, one of my nieces was also known as the school slut. My sister took her to see a counselor because she was always getting into fights and was about to get expelled. Before then she was a normal kid who'd never been in trouble. It all happened when she developed. By the time she was thirteen she was wearing 38-D bras. She was a little girl in a woman's body. She said kids gossiped about her, called her names all the time and boys were constantly harassing her.

2.—Staging Instructions and Stage Set Up

Ms. Wendy tells Suzanne about the Slut myth and women's sexuality. Suzanne and Ms. W are still sitting at the table drinking coffee and talking. Suzanne sits still, sips her coffee and looks attentively. Ms. W gestures with her arms as she talks. (Bell) Suzanne reacts with disgust and shakes her head in disapproval to Ms. W's words

(Bell) Suzanne looks interested and leans forward to hear better. (Bell) Suzanne acts happy when she hears about Ms. W's niece. Ms. W gestures with her hands as she talks. Suzanne sips her coffee without missing a word. (Bell) Suzanne motions with her hand for Ms. Wendy to stop and asks a question. (Bell) Suzanne listens to Ms. W more relaxed.

Dialogue between Suzanne and Ms. Wendy

Suzanne: So what happened to her? Ms. Wendy: Well like I told you, my sister took her to a counselor. The counselor had them read a book about the slut myth and teenagers. It was called Fast Girls. I remember because I borrowed the book from them and read it myself. The book said that “in our collective minds, there are archetypes. That means myths that are similar in different cultures around the world. These archetypes or myths seem to hang on through time and we take them as if they're true. One of them is the myth of the slut or the promiscuous woman. (pg. 55 & 56) This archetype is usually linked to sexual women. But in our society teenagers that look or act different from the norm are also branded as sluts. Girls who have an early puberty or have been victims of incest and childhood sexual abuse are often singled out as the school sluts. (pg. 17). The myth always seems to make men attracted to these marked women, but at the same time they don't like them because they're afraid of their sexual power. Back in the 1930s and 40s, psychologist Carl Jung said that the only way men are able to control the sluts, or the promiscuous women, was by seducing them, beating them or raping them.” (pg. 77) Suzanne: It's not fair, I was the victim, I was the one that got raped by Max and I was the one punished. Ms. Wendy: Yeah, it really bothers me to know that “even today teenage girls are being victimized because movies and TV shows promote the archetype and reinforce it in our collective minds. What makes it even more disgusting is that most people believe that promiscuous women, or girls marked as sluts, are evil and deserve a tragic ending.” (pg 71 & 72) Suzanne: I know, when I bump into people from school they always tell me they knew I was gonna end up like this. I pretend I'm cool about it but deep down it, it really hurts. Ms. Wendy: That's why my niece was so angry, because she didn't want to accept that fate. The counselor helped her understand how the archetype worked and I gave her some of my books and magazines with articles on women and spirituality. She wanted to get over the experience so bad that she read them all. Now she goes around the country telling her story and empowering women. She tells them to be proud of their sexuality. Suzanne: Good. So what else does she tell'em? Ms. Wendy: In her talks, she begins by telling women how “in early civilizations women were considered goddesses because of their sexuality. She says that in those days people didn 't know about insemination so they didn't know who fathered their children, but they knew who gave them life. That's why women were worshiped and seen as fertility symbols of the God Mother.” (Welwood, The Quest Winter 1990, pg 43) Suzanne: So why did things change? How come women are treated different now? Ms. Wendy: Things changed because people always find better ways of doing things. Evolution is part of our nature. “People back then realized that hunting was not the only way they could feed themselves. So men settled and started helping women work the land. (Welwood, The Quest pg 43). Men began marrying women not because they loved them but to have a right to a family and property. Did you know that the word “matrimony” literally means woman's inheritance? That's because in many early societies women were not only the cultivators of the land, some historians claim they were the first property owners and community organizers.” (Welwood, The Quest pg 43) Do you know that to this day there are primitive communities in which women are still the property owners and community organizers, where they still hold the power? Suzanne: Well, no. I guess that's some of the stuff I missed when I dropped out. So tell me. Ms. Wendy: OK, like I said, “men started helping women in the fields. With time they became good at farming. They made tools and started saving the extra crops. Most important, men discovered their own power. Armed with confidence they fought women for control, and women were eventually conquered. Once dominated women became the men's possessions. That's when women's spirituality changed.” (Welwood, The Quest pg 43) 3.—Staging instructions and stage set up Ms. Wendy and Suzanne talk while a sexual woman (S woman),enter the cafe followed by a prudish woman (P woman) accompanied of a man walk in. Suzanne and Ms. W sit drinking coffee and gesturing as if talking. (Bell) Man and P woman enter stage right and sit. She pulls on her skirt to cover her legs and pulls up her collar. (Bell) S woman enters stage left. She stands in front of juke box and dance. The man looks at her dance while P woman tries to get back his attention. (Bell) S woman notices the man and calls him with her index finger. The man joins her and claps as she dances. P woman looks at them and covers her face as if crying. She gets up and stands behind Suzanne with her face down and freezes. (Bell) S woman keeps dancing. The man now points at her with disapproval and try to keep the men in the audience from looking at her. She pushes him away and dances her way to front stage. The man swings his right arm up as if giving up and turns to P woman. With an innocent smile he taps her in the shoulder to get her attention. (Bell) P Woman pushes the man away. He swings his right arm up as if giving up and exits stage right. S woman stops dancing and stands in front of P woman. They both stand looking at each other defiantly. (Bell) P woman exits stage right and S woman turns to the juke box and leans on it looking down. (Bell) S woman exits stage right while Suzanne and Ms. Wendy finish talking. (Bell) Ms. Wendy gives Suzanne a paper with a phone number. Suzanne gets up, hugs Ms. W and exits stage left. Dialogue between Suzanne and Ms. Wendy Suzanne: I don't get it. What does that have to do with women's spirituality? Ms. Wendy: “One of the things men have done to keep, women under control is to take away the one thing that,made them powerful. Their sexuality was made into something evil. Women were no longer worshiped for their gift of life but were made into defective and inferior descendents of Eve. In other words, women's sexuality was made into sin. It's become something that corrupted men, and degraded and cheapened women. (Welwood, The Quest pg 44) That's why so many women suppress their sexuality; why they're ashamed of it and try to hide it. Most women think! they can regain their self-worth by embracing the status quo. They give themselves to their obligations and become people pleasers. But that's only made them less valued.” (Welwood, The Quest pg 44.) Suzanne: So what can we do to change things, to get men to treat us different, to get our value back? Ms. Wendy: “We certainly haven't made any progress by going along with the status quo. I think we need to put the slut myth to rest, along with any other archetypes that prey on people who are different. I think we need new values that honor women's nature, values that don't condemn their sexuality. We need values that give women the room to please God instead of people.” (Alter, the Quest Winter 1993, pg 43) Suzanne: That all sounds good but what does this have to do with my problem with money and Jenny? Ms. Wendy: You've been through a lot Suzanne and you've survived by not paying attention to the attacks of other people. You're also not ashamed of your sexuality which is part of your identity as a woman. I think outcasts like you have a better chance of connecting with their spirits than most people, because the only way we are able to listen to our spirit is in solitude. That's why people who are interested in spiritual things distance themselves from the world and look for solitude. Suzanne: Really? I never thought that being an outcast was good. Ms. Wendy: Listen to me Suzanne, spiritual growth requires change, and every change hurts and comes with a loss. Even if your life was not ideal, you're scared to change it. You're afraid of losing your friend, of facing the world alone and surviving without prostituting. But when you sell . . . or give away your sexual favors for no reason . . . you're not valuing the one thing that has made us women powerful and special. That's why you need to see your sexuality as a spiritual gift; as something precious that you as a woman are entrusted with. Suzanne: I've always believed people were right when they put me down. I thought that my sexuality was dirty. But I think I understand now. You're telling me that it's a gift that God gave to us women and that I have to value it. I never thought things could be different for me. I wanna change and have people look up to me like they look up to your niece. I wanna be somebody. Ms. Wendy: I'm glad to hear you say that. Suzanne: Look, I've gotta go, I have a lot of things to do. But before I go, do you think I could borrow some of those books you were talking about? Ms. Wendy: Sure. Here's my number. Call me so we can set up a time to meet next week. Suzanne: Thanks. Bye*.Ms. Wendy. AT THIS POINT THE PLAY IS STOPPED FOR DISCUSSION OF MATERIAL PRESENTED SO FAR WOMEN AND THE SEARCH FOR WHOLENESS

Q Why do you think kids at school started picking on Suzanne? Sample Response: (Validate participants' response) Following is another example of an expert opinion narrated by the trained professional:

Emily White said that school kids feel uncomfortable with their own sexuality and pick on those who seem open about theirs. In her studies in High Schools Ms. White said that school kids talk about other kids because they seem different, and because they are bored. Talking about others helps them release the tension in their own lives, and it also helps them reaffirm their own sexual biases. It also gives them a sense of control of their own desires. (White, pg. 17 & 43) By turning one girl into the slut among them, school kids try to reassure themselves that they are on the right side of fate: They are good while she is evil. They are safe while she is unsafe. They have the right kind of desire while she has the wrong kind. (White, pg. 59) Trained professional asks participating individuals to point at the area in the Behavior and Self diagram where this falls into. (PERCEPTION AND ATTITUDES) Q Besides girls like Suzanne, what other kids are also rejected in the school? Sample Response: Boys who are seen as fags or sissies, immigrant kids, or kids from different ethnic backgrounds are also rejected, and picked on. Q Why do you think kids pick on those who are different? Sample Response: Because that's the way they protect their space. Following is another example of an expert opinion narrated by the trained professional:

Emily White said “to cause humiliation is to exert control, and to exile another kid is to prove that you belong, that you are here (178) The question and answer session resumes as follows: Q Do you think that kids that are rejected feel safe in school? Sample Response: No. They are always afraid of being jumped on or attacked at any time and for no reason at all. Q Who do you think starts the rumors about the slut girl? Sample Response: Sometimes they are started by girls who see her as different or threatening. Other times they are started by boys who want to make themselves look good by telling or exaggerating what they did with a girl or want to get back at her after she dumped or rejected them. Q Why is it that some girls that talk dirty, cuss and dress provocatively are not labeled as sluts? Sample Response: (Validate participants' response) Following is another example of an expert opinion narrated by the trained professional.

Emily White said that not all girls that cuss and dress provocatively are labeled as sluts because it is not about what the girls do but about what kids say they do. (White, pg. 50) Q If you Were a school reject how would you see yourself and what would you do? Sample Response: (Validate participants' response.)

Following is another example of an expert opinion narrated by the trained professional. Emily White said “Whether girls had slept with one or a hundred men, the ones who had been sexually abused as children felt promiscuous from the very early time. Women who had been sexualized and sexually trespassed on as children felt a kind of recognition and resignation when they were called slut and they didn 't protest too much. (pg. 166)

Q Tell me about a real person or a TV or movie character that was a school reject. How did their behavior change as a result of that? Sample Response: They join other rejects or become part of counter cultural clicks like gangs, or become Goths, punks, mods, or bikers. (White, 189) Q Look at the Behavior & Self Diagram and tell me how does being rejected by other kids affect a young persons sense of self. Sample Response: It affects their perception, attitude and expectations. Q Ms. Wendy told Suzanne that when men discovered their own power they conquered women. How do you think men saw themselves after they succeeded in dominating women and how do you think women saw themselves? . Sample Response: Men saw themselves as better than women and women saw themselves as inferior. Q It seems that women today are becoming more aggressive and acting more like men. Why do you think this is happening? Sample Response: Because women don't like the role society has imposed on them and value the same things men value.

Following is another example of an expert opinion narrated by the trained professional: Emily White said that some women don 't want to be passive little mothers waiting for men to lead them. They also don 't want their sexuality restricted and used for only the right reasons. When women adopt men's values they feel like an explorer, and the aggressor, they feel they can overtakes territories and claims them as his own. (pg. 110)

The question answer session resumes as follows:

Q Think about your favorite male sit corn character. What does he do when he needs to express feminine values like caring, compassion, grace, harmlessness, kindness, love, selflessness, sympathy, tact etcetera? Sample Response: He usually says I'm not a woman I'm not supposed to feel or care about those things. Q Today women are better off than women in the past. What else do you think needs to change so they can regain their power without having to imitate men or fight over it? Sample Response: Men and women have to recognize that feminine values like caring, compassion, grace, harmlessness, kindness, love, selflessness, sympathy, tact, are as important as masculine values because they are also God like qualities.

AT THIS POINT THE DISCUSSION IS ENDED AND THE PLAY IS RESUMED

4.—Staging Instructions and Stage Set Up

Narrator talks about Mary's childhood and her relationships. Nurses stand front stage right holding their charts and glancing at Mary who rocks in a chair with her eyes shut. (Bell) Nurses exit stage right and Mary stops rocking. She pushes her back against the chair tense. She freezes. (Bell) Two people enter stage left they put a straw hat on Mary and force a garden tool on her right hand. They force her out of the chair and leave her standing at front left stage. They exit left stage. (Bell) Mary drops,the garden tool and hat and meets Joey who enters stage right. He hands her flowers. (Bell) Joey gets his guitar at prop table and begins to play. Mary picks up a pillow and places it on her belly. He looks at her and angrily he puts the guitar down and puts on a construction hat. He sits to tie up his shoe. The laces brake. Infuriated he takes off the shoe and slams it on the floor. He gets up and starts to hit Mary who falls and curls up holding her belly. Joey exits stage right.

(Bell) Max enters stage left and Mary gets up holding the pillow as a baby. He is holding a bottle and has a joint in his pocket. Mary puts the pillow down on the table and gets the bottle and joint from Max. She takes a puff and drinks wiping her mouth with her forearm. Max looks at her with contempt with his arms folded across his chest.

Dialogue between nurses and Mrs. Brown's monologue

Nurse #1: I thought she'd do better after she saw her daughter yesterday. Nurse #2: She went back to the way she was before. Mrs. Brown: Nooo! Narrator: A person is the sum total of his life experiences, each of which is registered in his personality and structured in his body. Mary was no different. She was born to a large family of farm workers. Her mother worked in the fields along with her father. Her children became a burden more than a blessing, and even if she loved them she had no time or energy to demonstrate it. Mary was practically raised by her older sisters. As a baby she was not held or caressed. She was not welcomed or accepted. Memories of her childhood were about work, not play. Like her brothers and sisters, she was just an extra pair of hands to help in the fields. During her early teens, Mary's family moved to Atlanta. That's where she met Joey. She was a young and inexperienced girl and gave into the romance and the adventure. For the first time she felt special. She craved the love and closeness the she lacked as a child. But Joey was not prepared for the responsibility of a family. He dreamed of being a guitar player, and was forced to give up his dream when Mary got pregnant. He had to get a job in a factory to support Mary and their new child. Joey became bitter and took it out on Mary every chance he got. When Mary got pregnant again, a few years later, Joey became very violent. He had been saving for years to buy a professional guitar and now Mary had to stop working and he had to make up for the lost income. It was the end of his dreams. With no concern for the baby in his wife's womb, he kicked and punched Mary repeatedly. The neighbors called the police, but he left before they got there, never to be seen again. Mary met Max when Suzanne was two. He encouraged Mary to “loosen up” by drinking, taking pills or smoking marijuana. Mary was partial to alcohol because it relieved her sense of inner emptiness and coldness. It uninhibited her and made her feel more sociable. Yes, Max taught her how to have fun and she was willing to support him. After all, who else would be interested in an older woman with two children?

5.—Staging Instructions and Stage Set Up

Mary relives her last argument with Max and his death. Max is standing center stage pacing angrily with arms on the hips and staring at Mary. She follows him around and puts the back of her hand in her forehead and pleads. (Bell) Mary gets closer to Max and grabs him by the arm. He brakes lose and exits stage left. Mary freezes holding out her arm reaching for him. (Bell) Mary walks to center stage and stares at the floor walking in a circle imagining Max dead. (Bell) Mary begins to cry and walks to where she imagines his head. She kneels on the floor and places her hands in her temples as she shakes her head from side to side with an expression of pain. (Bell) Mary stops and screams “No”. Then she lowers her head and curls up her back. She wraps, her arms around her shoulders and freezes.

Dialogue between Max and Mrs. Brown: Max: I'm telling you Mary, your kids are just trying to make trouble for me. After all I've done for them. They wanna put me in jail for something I didn't do. But I'm not gonna wait for that to happen. I'm leaving; see if you can find another fool that will put up with all this shit. Mrs. Brown: Please M[ax. Don't go. I don't know what got into these kids. I'll talk with Suzanne again and make her tell me the truth. Come back, No! (Thinking) That evening, Max came back. He'd had a few drinks. He went to the kitchen and started arguing with David. I heard them yelling at each other. When I walked into the kitchen, Max was laying on the floor, dead. (sobs) No, no, no. (cries) Noo! Narrator: Joey felt betrayed when Mary got pregnant. She had destroyed his dreams of stardom. But Mary never ceased to be a caretaker. She accepted her responsibility for building the male ego. Max needed someone like that. As a man, he had not been able to assert his masculinity by making money, or being successful in any undertaking. He had problems with authority and quit his jobs because the boss was always too demanding. He spent long periods out of work. He was depressed, and acted out by having sexual escapades and by putting Mary down. She offered herself as a scapegoat, and expressed Max's projected vulnerability by being meek. AT THIS POINT THE PLAY IS STOPPED FOR DISCUSSION OF MATERIAL PRESENTED SO FAR LOVE, A FOUR LETTER WORD

Q Look at Who We Are in the Behavior and Self diagram and tell me how has the family been used to keep women from having power? Give me examples. Sample Response: By seeing women as baby making machines Q Look at Who We Are in the Behavior and Self diagram and tell me how has the government been used to keep women from having power? Give me examples. Sample Response: Government, denied women the right to vote, it has also determined their right to, choose or abortion issues. Q Look at Who We Are in the Behavior and Self diagram and tell me how has society been used to keep women from having power? Give me examples. Sample Response: Society expects women to behave in certain ways by making them act “Lady like”. Q Look at Who We Are in the Behavior and Self diagram and tell me how has, religion been used to keep women from having power?. Give me examples. Sample Response: By giving women a weak and evil nature. Following is another example of an expert opinion narrated by the trained professional: The Christian religion has made Eves of all women. They are made responsible for men's fall or men's failures. Early Christian literature described women as “The gate of Hell” “The confusion of man,” “an incessant warfare” and a “daily ruin.” (Welwood, pg. 44)

The question and answer session resumes as follows: Q Based on this negative concept of women, how do you think husbands felt about their wives and how they treated them? Sample Response: They did not trust them and treated them harshly. Following is another example of an expert opinion narrated by the trained professional: In the fifteenth century, a Christian friar wrote the Rules of Marriage. In his writings, he advised the husbands to “scold her sharply, bully and terrify her. And if this still doesn't work . . . take up a stick and beat her soundly.” (Welwood, pg. 44). Religion has allowed men to maintain their power over women not only through violence, but also by social conditioning and tradition.

The question and answer session resumes as follows:

Q Look at Who We Are in the Behavior and Self diagram and tell me how has culture been used to keep women from having power? Give me examples. Sample Response: By imposing on women ideas and customs made by men. Q Look at Who We Are in the Behavior and Self diagram and tell me how has tradition been used to keep women from having power? Give me examples. Sample Response: By making women follow customs without question. Q One item on the Who We Are list of the Venn Diagram has molded the others. Identify that item and explain why it is still so powerful even today. Sample Response: Religion. Because religion is based on beliefs that cannot be changed by arguments or by force. Q Even today, some Christians blame women for the decay of society. They say that, “by not standing by their men, women have destroyed the traditional family; That by becoming more independent women are having more illegitimate children who grow up without a father.” (White, pg. 106) Q Do you too think society is decaying and that women are to blame? Explain why. Sample Response: (Validate participant's response) Q Think about the character of Mary in the play. What kind, f woman would you say she was and what could she done different to please the men in her life? Sample, Response: (Validate participant's response)

Q Do you think that Mary picked the wrong men but that most women have happy marriages?

Sample Response: No. most married women do not have happy marriages.

Following is another example of an expert opinion narrated by the trained professional:

Terrance Real wrote that “on a number of sociological studies, married women were,less happy, less well adjusted, more anxious, more overtly depressed, and generally more neurotic than either married men or single women. He explains that some women seem willing to keep their covertly depressed men strong by becoming less functional than their partners. (Real 312)

The question and answer session resumes as follows:

Q How many of you have seen the Jerry Springer show? (participants' raise their hands) How would you describe the women in the show? Sample Response: They are usually trashy, aggressive, bad, etc.

Trained professional asks participating individuals to point at the area in the Behavior and Self diagram where this falls into. (BEHAVIOR)

Following is another example of an expert opinion narrated by the trained professional

In one of the episodes of this show a woman got back at her husband's infidelity and violent behavior by sleeping with both his brothers. After her confession the audience chanted frantically . . . slut, slut, slut . . . When the crowd calmed down, the woman turned to her husband and told him in a meek tone “I tried to work things out. I tried to talk to you but you wouldn 't listen. You only paid attention to me when you wanted sex, the rest of the time you ignored me . . . I want to feel loved, I want to feel appreciated”

The question and answer session resumes as follows: Q How many women in this class have told their partners at one time or another that they want to be heard and appreciated? Raise your hands. How many men have heard this from a partner? Raise your hands. Sample Response: The facilitator should respond too. Following is another example of an expert opinion narrated by the trained professional:

Some women may have affairs to feel loved. But model mothers become afflicted with Munchhausen by Proxy Syndrom. They inflict pain in their children to get the attention, nurturance and leniency that they feel unable to obtain any other way. That is because every woman, regardless of her lifestyle and beliefs, wants to feel the love and appreciation of the men in their lives. That can be their fathers, husband or children.

The question and answer session resumes as follows:

Q Why do you think some women are attracted to men involved in gangs, or to men that are famous and powerful? Sample Response: To get validation by association. Or get the respect they want through these men. Q What do you think happens when men recognize their woman's spiritual value and stopped exploiting and condemning their sexuality? Sample Response: Women make peace with themselves and value their own divine essence, or their power. Women stop fighting men for power and begin to trust and value the men in their life. Trained professional asks participating individuals to point at the area in the Behavior and Self diagram where this falls into. (SELF)

Q Do you think that men that allow women to exercise their spiritual power lose their authority and end up being controlled by their women? Sample Response: No. Most women do not want their husbands to be unmanly. Q How do you think some couples today have been able to overcome the limitations that the family, government, society religion, culture and traditions have imposed on them?

Sample Response: By seeing each other as human beings with both masculine and feminine qualities of equal value.

Following is another example of an expert opinion narrated by the trained professional: A good example of this is the reality show “Dog; The Bounty Hunter”. He is not afraid crying or of showing his sensibility in the show, he is open, and values his wife. When he gives in to her wishes, he doesn't do it because she controls him, he does it because he cares about the relationship and wants preserve it. That hasn't made him less of a man.

The question and answer session resumes as follows: Q Do you know of any other couples, including characters on TV or movies-that build each other up? Tell us about them. Sample Response: Validate participant's response. THE DISCUSSION IS ENDED AND THE PLAY IS RESUMED

6.—Staging Instructions and Stage Set Up

David visits Mary at the hospital and talks about his resentment for her. Nurse #1 and #2 are standing by prop table talking when David enters from stage left. He asks for his mother. The nurses leave stage left after David approaches Mary. (Bell) David turns to look at Mary who is sitting rocking with her eyes shut. (Bell) David takes a few steps closer to Mary and stares at her. She lifts her head and begins to say no by swinging her head slowly from side to side. He remains standing in front of her. (Bell) Mary drops her head and freezes. David thinks outloud pacing slowly on her right side. He rubs his face, runs his hand over his head, then glances at Mary and turns away from her as he thinks.

Dialogue between nurses and David: Nurse #1: (talking to nurse #2). We changed the medication but she's still the same. She doesn't want to eat and gets very restless at night. She doesn't have any energy to stand or move from the chair. Then she goes into long crying spells. David: Excuse me, I'm looking for Mary Brown. I'm her son. Nurse #1: Yes, this is her room. Narrator: David hesitated before he approached his mother. He was afraid she'd start an argument. And he was afraid they would blame him for his mother's condition. David: Mom, It's me, David. Mrs. Brown: (talking deliriously). I'm sleepy. 1 don't wanna to go to the fields today. Please mamma, let me stay. Joey, take me away to the city. I wanna learn how to dance. I:wanna to look like the city girls. No! I can't take care of that baby. You go ahead and give him to a good family. Why? Why, Suzanne?

David: (thinking). The more Max raged, abused and put my mother down, the more she dug in. Still, she worked hard and kept us alive. Looking back, I suppose I should've been grateful to her, but I wasn't. I didn't care about her. I don't mean that in a bad way. She just didn't count. I never had a real conversation with her. She was so obsessed with keeping Max happy that she turned a deaf ear to my cries and accusations. She would actually turn and walk away from me as if she hadn't heard me. But mother wasn't Max's scapegoat. She participated, in her own detached way, in the violence of our family. Max hurt us physically and mentally, there is no doubt about that, but the injuries I felt from my, mother went deeper. “Like many children from chaotic homes, even though Max was the abuser, my strongest resentments were reserved for my mother who refused to protect me.” (Real, pg. 315)

7.—Staging Instructions and Stage Set Up

Rev. Crane tells David that an addiction does not disappear by itself and that drugs numb feelings both good and bad. David is sitting in front of Rev.'s desk. Rev has his hands clasped together leaning back. He tilts his torso toward David to emphasize his words. (Double bell) David stands confident and walks in front of the desk keeping eye-contact with Rev. (Double bell) David loses confidence and sits. (Bell) Rev. stands and paces in front of David gesturing with his hands as he speaks. (Bell) Rev. stands by his desk. He places both hands in the desk and leans toward David. David looks uncomfortable and pushes his torso away from Rev. (Bell) Rev. walks slowly to stage back left. He looks out a window and walks back toward David. David turns keep looking at Rev. (Bell) Rev. sits. He uses a pen to emphasize his words. (Bell) Rev. takes a more serious attitude. He drops the pen and rests both arms in the desk with clenched fists and leans toward David. David lowers his head as he listens.

Dialogue between David and Rev. Crane

Rev. Crane: Let's stop fooling ourselves David. You can't keep denying your addiction. I'm really glad you got a job, but we need to address this problem now, before it starts creeping back.

David: I don't think I need any help for this. I can give up drugs all by myself. To prove I'm right, I can tell that I went this whole day without using drugs and I'm not lying. Rev. Crane: You didn't become an addict overnight. So what makes you think you can recover in a day? Do you think a person who's fat because of overeating can wake up one day and say. That's it, I'm not fat any more. Habits need to change; a whole lifestyle needs to change in order to get results. I applaud your effort to stay clean. Will power is very important for recovery, but that's not all it takes. Unfortunately, relapses happen way before drugs even come back into the picture. If you don't make changes now, old habits will drive you back to where you were. Good intentions don't work unless they're supported with knowledge. Let me ask you this, when do you have the strongest urge to use drugs? When you feel pressured to do something that you think is too difficult? Or do you feel like using when you feel sorry for yourself, or when you feel overwhelmed with life's demands? In other words, what's the trigger for your addiction? Do you feel the urge to use when you feel insecure in your relationships and life's too much to handle? If you use drugs for any of these reasons, let me tell you you're not alone. Many people become physically and mentally ill because of these same reasons; because of everyday stress. Sure drugs can keep us from experiencing pain, but they also keep us from experiencing joy. The problem is that we can only experience life through our emotions. We need them in order to feel alive. During my years of ministry at the prison, “I've seen many inmates mutilate themselves. They use all kinds of objects to carve their names in, their bodies, they'll even swallow razor blades. When they can't find anything to produce pain, they scratch and bite themselves. Why do they do it? The answer's simple. They're looking for relief from feeling nothing at all. They want to escape from their emotional numbness.” (Real, pg 146 & 147) Is that the kind of life you want for yourself? How can I make you understand that just wanting and wishing won't make your addiction magically go away; it'll never go away by itself.

8.—Staging Instructions and Stage Set Up

Rev. Crane explains to David why miracle cures are effective and why they are also limited. Rev. is standing by prop table and David turns his body to keep looking at him, (Bell) Rev. picks up a box with care and walks slowly to his desk.

He sits and carefully places the box in front of David. (Bell) Rev. opens the box and slowly pulls a smaller box from inside. He closed the box and puts the smaller on top. He opens the smaller one and pulls another one from inside it. He closes the box and sits it on top of the first. He repeats this until he has a pyramid of boxes leaving the last one unopened. David looks at the boxes with curiosity.

(Bell) Rev un-stacks the boxes and spreads them all over his desk. (Bell) Rev puts all the boxes inside the bigger one ending up with one box.

Dialogue between David and Rev. Crane

Rev. Crane: I know you think it can be done. We've all heard stories about people who got clean after attending a religious healing, or with a single therapy session or even from some kind of healing ceremony or magic potion. Miracle cures stop working when the false reality the experience creates can't be sustained any longer; when other problems come to the surface. But the wonderful thing people have learned through these healing methods is that we have the capacity to change our reality. But first we need to learn how to do it. We need to use that skill every time a new problem comes up. That's because our problems are like an onion. There's always another layer to peel after we're done removing one. Have I ever told you about my friend Fernando? He knew lots of wise phrases. I remember him saying “We didn't come to this life to be victims, but to be tested.” (Alcantara Rodriguez, pg 39) I can see you're wondering how? We're tested when we feel uncomfortable with different life experiences, when we have problems accepting our reality. That's when most people get stressed, when their beliefs don't seem to hold true anymore.

Instead of resisting the change and repressing the stress through drugs or destructive behavior, we need to take what we've learned from the experience and move to a new level, just like we did back in school. We need to make a conscious effort to expand our minds. And we need to test our reality by learning how people in other times or other places have faced similar tests. Every time we add a new perspective to the way we see life. We make permanent changes to our sense of reality, and a miracle cure will take place.

9.—Staging Instructions and Stage Set Up

Rev. Crane tells David how society has molded men's identity. David is standing rubbing his neck and pacing as he tells Rev how Max used to beat him up. (Bell) Rev. stands and walks to David. He puts his hand on David's shoulder then paces as he talks. (Bell) Rev. picks up a broom and starts sweeping. He pauses when he talks to David. (Bell) Rev. moves David's chair to the front center. He rests the broom against the prop table. David looks sad and stares at him as he moves around the stage. (Bell) Rev sits and freezes. 2 men enter stage from opposite sides and tie a bandage on each of David's-wrists then begin to wrap him to the chair with the bandages. They poke at him and pinch him while David is unable to defend himself. Then they exit stage acting tough. David opens up his mouth as if screaming and then puts his chin against his chest and freezes. (Bell) David slowly frees himself keeping the bandages tied to his wrists. (Bell) Rev. unfreezes. He walks to David and removes the bandages from his wrist. They both remain standing at center stage. Rev. paces and gestures with his hands as if talking.

Dialogue between David and Rev. Crane

David: You know, my stepfather used to beat me up all the time, and I learned that the only way to make him stop was by not showing any pain. When I was ten he tried to kill me by running me over with the car. He hit me and broke my hip. That's why I have a limp. You might think I'm a bad person after hearing what I'm gonna say, but I don't regret killing him. He enjoyed controlling and hurting us, he got what he deserved.

Rev. Crane: Only God can be the judge of that. It's unfortunate that in spite all our scientific discoveries and advances in technology, we're still so primitive when it comes to human relations. I wanna make this clear, I don't wanna make excuses for your stepfather, but remember this very important principle people make decisions based on their knowledge. Unfortunately your stepfather, like many boys today, learned that the only way a man can be valued in our society is by performance or achievement. There's constant pressure for men to prove themselves; they're always being judged for their actions. (Real, pg. 182) Remember how the subconscious brings up memories and feelings from the past? That just adds to the pressure. It can make daily life a painful experience. It's no wonder so many boys and men are unstable bouncing back and forth from grandiosity to the shame. From what you've told me, your stepfather was not much of, an achiever it might be that he covered his shame by a false sense of grandiosity; he validated himself by abusing your mother and your sister. “It's our antiquated definition of manhood that forces boys to, deny their feelings of vulnerability and ignore their emotional needs. How can we expect men to recognize other people's emotions and be responsive to them if they can't even recognize their own? It's unfortunate, but anger is the only emotion men are allowed to display without feeling vulnerable. (Real 146)

I think the way we prepare boys to become men is really messed up. I don 't think boys really need to have their toughness tested before,they're accepted as men. I think we 've kept these ridiculous traditions just to show boys what we went through” (Real, pg. 132-135) What do you know about your stepfather? What kind of childhood did he have? Your conscious mind has spent all these years wondering why your stepfather did what he did, while your subconscious mind has been playing the tape of those painful memories over and over again. The truth is that nobody and I dare say not even your stepfather knows why he acted the way he did. Though there's no answer or justification for his actions, you can satisfy yourself with the idea that your stepfather had a distorted idea of himself as a man., “You know not all victims of abuse become abusers, (so you don't have to become one) but it's a well known fact that all abusers were victims of violence themselves”. (Real, pg 118) And that means your stepfather was abused too.

AT THIS POINT THE PLAY IS STOPPED FOR DISCUSSION OF MATERIAL PRESENTED SO FAR NOTHING TO DO AND NOWHERE TO GO

Q If you were David would you trust Rev. Crane? Sample Response: No, because he is an authority figure and cannot be trusted. Trained professional asks participating individuals to point at the area in the Behavior and Self diagram where this falls into. (EXPERIENCE) Following is another example of an expert opinion narrated by trained professional: Mistrust is a big obstacle for everybody that wants to help people with addictions like counselors, spouses, employers, police officers, judges, preachers and doctors. When these people deal with them individually, addicts may seem to be willing to address their problem while inwardly resisting to acknowledge it. (Lovern, pg 88)

The question and answer session resumes as follows:

Q Do you think Rev. Crane could build David's self-esteem with his encouragement and positive support? Sample Response: No, Validate participants' response

Trained professional asks participating individuals to point at the area in the Behavior and Self diagram where this falls into. (EXPECTATIONS & EXPERIENCE)

Following is another example of an expert opinion narrated by trained professional: John D. Lovern, PhD. Said that addicts don't like themselves therefore they cannot understand why someone else would like them or want to help them. When a person reaches out to them with a helping hand, addicts think they are “suckers” that those people can be manipulated or that they are crazy. The way addicts act around-the people that want to help them keeps them from receiving the praise, the warmth, and tenderness they crave. Instead of accepting tile help, addicts attack the people who try to support and love them.” (pg. 49) The question and answer session resumes as follows: Q How is the attitude of the addict similar to the criminal's? Sample Response: Criminals also think that they are smarter than everybody else and don't miss the chance to take advantage of people. They also turn against their loved ones when they don't comply with their wishes. (Samenow, pg. 97) Q David told Rev. Crane he could give up drugs if he wanted to. Do you think you-can do it too?

Sample Response: (Validate participants' response)

Following is another example of an expert opinion narrated by trained professional. Most people think that drug addicts cannot control their impulse to use drugs but Dr. Stanton E. Samenow disagrees. In his years of practice he discovered that drug addicts can stop using drugs without professional help. He says they do it not because they want to give up drugs for good but to reduce the habit and get a better high from less drug. (pg. 127)

The question and answer session resumes as follows: Q If drug addicts can give up drugs without professional help, why do they choose not to do it? What do they gain from using drugs? Sample Response: (Validate participant's response)

Following is another example of an expert opinion narrated by trained professional: Dr. Samenow says that drug addicts don 't want to be drug free because they enjoy the effects of the drugs, they feel they're part of the counter culture and the excitement of doing the forbidden. They get attention from their families, their crimes can be attributed to their drug use and get lesser sentences. Society has lower expectations from them because of their addiction. (Samenow, pg 207)

The question and answer session resumes as follows:

Q David did not think drugs had anything to do with his problems. Do you think that drugs had nothing to do with his problems? Explain why. Sample Response: I disagree. Drugs were at the center of his problems. He was afraid of being killed by Dog, he was more interested in getting high than in finding a job, he did not have any friends or a romantic interest. He depended on his mother for support. Q Rev. Crane said people cannot give up drugs with miracle cures. Do you know anybody that did? Tell how they did it and how long has that person been drug free? Sample Response: Validate participant's response Q What kind of attitude did that person had before going through the experience and do you think the person believed in the miracle cure? Sample Response: That person was ready to change because of a significant emotional experience. That could have be the fear of being killed or sent back to prison or a strong desire to have a different lifestyle.

Following is another example of an expert opinion narrated by trained professional: Psychiatrist Milton Erickson used to tell the story about Joe, a young thief that set his eyes on the town,'s most beautiful girl. In spite of their social differences he had the audacity to invite her to the town's dance. She told him “You can, if you're a gentleman.” The possibility to dance with her motivated him to work and give up his life of crime. Erickson attributed Joe's dramatic change to psychotherapy. But Joe did not go to a counselor or a psychologist. What Erickson meant with the term was that a simple event in Joe's life, the hope of going to the dance with the prettiest girl in town was sufficient to want him to change. (Lovern, 20-22)

The question and answer session resumes as follows:

Q Once the dance was over what do you think motivated Joe to continue with his new lifestyle? Sample Response: Before he changed, Joe used to hang out with cheaters and thieves, but work and the memory of the dance made him realize that he could be a valuable person. Q Do you think judges are unfair when they send drug addicts to prison because they don't stop using drugs? Sample Response: No. Addicts should comply with the laws like everybody else.

Following is another example of an expert opinion narrated by trained professional: Steven Samenow says that criminals think that they are entitled to bend the rules and the laws because “everyone does it” or “people are like that”, they think that only difference between them and the rest of society is that they got caught. (pg. 221-222)

The question and answer session resumes as follows: Q Raise your hand if you have tried to be clean before. (Ask one of the participants) Was it easy? (have other participants that raised their hand answer) What do you think you need to do to make it work this time? Sample Response: To stay away from people and places. Trained professional reads following example: Staying away from people and places is important but it's more important to do what's right and not make exceptions for yourself The lesson we have to learn from the story of Adam and Eve is not that women are evil, but that minor infractions like taking a bite off the forbidden fruit can carry very serious consequences.

AT THIS POINT THE DISCUSSION IS ENDED AND THE PLAY IS RESUMED

10.—Staging Instructions and Stage Set Up

Rev. Crane explains to David that pain is not a punishment from God and that it exists for a purpose. David is sitting with his head down and hands clasped between his legs. He raises his head when Rev. begins to talk. Rev. is standing in front of David talking and gesturing with his hands. (Bell) Rev. rises his right arm pointing at the sky with his palm and begins pacing and gesturing as he talks.

(Bell) Rev. puts his hands in a prayer position as he quotes Jesus then he paces and gestures as he talks.

(Bell) Rev. raises his chin to the sky with his arms stretched down and open palms as he quotes Jesus.

(Bell) Rev. goes to prop table, picks up a book turns to David and begins reading. David sits looking at Rev. with hope with his back stretched and his head up. (Bell) Rev. closes the book and puts it back at the prop table. He walks and stands resting his hands in his desk and leaning toward David. (Bell) Rev. sits and uses a pen to emphasize his words.

(Bell) Rev. leans back and places his clasped hands on his chest.

Monologue by Rev. Crane

There's another question that you've probably been asking yourself all these years why did God allow this to happen? “It's time you understand that God didn't give you those painful experiences. Your spirit chose them as part of its evolution.” Otherwise, how would you explain the suffering Jesus went through? Do you think that God wanted his favorite son to be tortured and killed? When Jesus found out the Romans were looking for him, he went to the Mount of Olives. His earthly body, like ours, didn't want to experience pain. He cried and prayed for God to save him by saying, “Father, if you so desire, remove this cup from me.” But his spirit knew his pain had a purpose that by going through the experience he was going to be beyond and above all men. That's why he finished his prayer by saying. “Nevertheless, not mine but thy will be done.” With his sacrifice Jesus gave us eternal salvation not through our bodies or our minds but through our spirits.

I wanna read you a few lines from a spiritual teacher: Abdul-Baha. He said, “Men who suffer not, attain no perfection”. The more the fields are ploughed the more fertile they become. The more the tree is pruned the bigger and stronger it gets. The longer the gold is left on the fire the purer it will be. That is why in all times God's prophets have to endure great tribulations and difficulties; because those who suffer most attain to the greatest perfection. “Abdul Baha was understanding pain from a spiritual point of view. In these few phrases he gave us a new perspective on reality. You've been living, thinking that God didn't care for you, that he hid abandoned you, but in reality you were being challenged, and prepared for greater things. I told you when we first met that my mission was to help people like you find the path of right living. Now I can tell you I wasn't talking about criminals or addicts but about people who were being prepared to glorify and honor God. That's why I think I have a great mission!11.—Staging Instructions and Stage Set Up

Rev. Crane tells David that he cannot blame God or anyone for his troubles and that he needs to forgive everyone that hurt him. Rev stands by prop table and pours coffee in two cups while glancing at David. He puts the pitcher down and paces while he talks to David. David turns to look at him. (Bell) Rev. takes two cups of coffee and sits them at the desk then he paces and gestures as he talks.

(Bell) Rev. stands in front of, David he looks up as he quotes Jesus. He sits and leans toward David then leans back. (Bell) Rev. spills his coffee. He stands and wipes the desk with a handkerchief he pulls from his pocket while talking and, glancing at David. Then he sits and leans toward David to emphasize his words. (Bell) Rev. stands walks to the corner of the table and leans to face David. Then he paces close to his chair. (Bell) Rev. sits with his arms resting on the desk. David looks at him with his head tilted to the side. They both freeze when the narrator speaks.

Monologue by Rev. Crane

There's still something you have to do now to close this chapter in your life. You have to forgive your stepfather. You need to forgive all the people who hurt you, including yourself. The last thing Jesus taught us, believe it or not, was to forgive. While he was on the cross Jesus didn't curse the people that hurt him, he didn't pray to God for revenge like most of us would. Instead, Jesus said, “Father, forgive them for they know not what they do”. With those words Jesus expressed his love for the people who condemned him, the people who tortured him and for the friends who betrayed him. With those words, Jesus acknowledged we as men are imperfect we sometimes make foolish decisions, and hurt people who don't deserve it. Even though your mind will resist letting go of the resentment and guilt, your spirit has the capacity to forgive everything once and for all. David, I wanna make this clear. “Forgiveness doesn't mean that we have to accept a relationship with the people who hurt us or that we have to continue our association with them. What Jesus meant when he commanded us to love our enemies was that we should wish them well; that revenge is not the answer. That's why we need to pray for our enemies, to wish them happiness and all of life 's blessings. And why is it so important? Because only by for giving, can we find the inner peace we need to move beyond the pain. Now, if we just pray for the people who hurt us to place ourselves above them we're not really forgiving them. The only way we can know for sure that we've forgiven them is when we feel happy for them when we hear they're doing well. Only then will we know for sure that we 've forgiven them.” (Murphy pg 200-201)

Narrator: A long silence followed those words. David thought about his father, who abandoned them when he was only four, the brutality of his stepfather Max and his mother's neglect. Up to that time he had blamed them all for his failures. Forgiving them meant to let go of the crutch he had been carrying all those years, to take a step of faith and embrace life for the first time.

AT THIS POINT THE PLAY IS STOPPED FOR DISCUSSION OF MATERIAL PRESENTED SO FAR EMOTIONAL ATROPHIES THAT MAIM MEN:

Q Why do you think Max liked to play rough with David and beat him up? Point at the items on the Behavior and Self diagram that explain Max's behavior?

Sample Response: (ENVIRONMENT EXPERIENCE & EXPECTATIONS) He wanted to teach David to be strong by tolerating pain. Or he wanted to prove that the abuse he experienced himself as a child was normal and necessary to become men. Max could have done it to boost up his ego and show David he was better than the rest If the family. Trained professional asks participating individuals to point at the area in the Behavior and Self diagram where this falls into. (ATTITUDES)

Q What do you think happens to men like David that turn off their emotions to ignore their pain and their shame? Sample Response: Their perception of the self is damaged. They don't become stronger and try to hide their depression. Q There are many ways in which men can hide their depression what are some of the most common?Sample Response: By abusing alcohol or drugs; by becoming obsessive in their relationships; by trying to get a false sense of power through recognition in sports, at work or with money.

By controlling other people or exploding in rage; by inflicting pain to others.

Trained professional asks participating individuals to point at the area in the Behavior and Self diagram where this falls into. (ACTIONS)

Q (Ask the men in the group). What does the word “feminine” means to you as a man?

Sample Response: Research shows that most men respond to this question as not masculine.

Trained professional asks participating individuals to point at the area in the Behavior and Self diagram where this falls into. (ENVIRONMENT) Q Can you describe some feminine traits that men should never have? Sample Response: Men should never be emotional, delicate, vulnerable, in other words exhibit “feminine” qualities. Q What happens to men like David who cannot compete or do not have a strong masculine image? Sample Response: They cannot earn their status as men.

Trained professional asks participating individuals to point at the area in the Behavior and Self diagram where this falls into. (BEHAVIOR)

Following is another example of an expert opinion narrated by the trained professional: Doctor Terrance Real said that boys and men have to earn their status and privilege of manhood by turning their backs on vulnerability and enter the competition. Men that are non-competitive and those that are unconventional like gay men, men with disabilities or of the wrong class or color are punished for it. These men are not only excluded from the clans but subjected to ridicule, bullying and violence. These men are considered invisible in our society. (pg. 180) The question and answer session resumes as follows: Q Rev. Crane told David that Max could have been a victim of abuse himself. Do you agree with Rev. Crane when he said that not all victims of abuse become abusers? Explain why. Sample Response: Yes because there are many people, some of them famous that were abused as children and did not become abusers. Q Do you agree with Rev. Crane when he said that we, (and not God) are the ones that chose our painful experiences? Sample Response: Yes because if we didn't we would had to admit that we have an unfair God.

AT THIS POINT THE DISCUSSION IS ENDED AND THE PLAY IS RESUMED

12.—Staging Instructions and Stage Set Up

Rev. Crane reminds David of the things they talked about and the changes he's seen in him. They say goodbye. Rev stands and walk toward David. David stands when he sees him in front of him. Rev puts his hand on David's shoulder and they walk slowly side by side to front right exit and stop. (Bell) Rev and David stand in front of each other. Rev. gestures with his hands as he talks. David agrees to what he's saying by nodding. (Bell) David stretches his hand to shake Rev's hand. Rev. shakes' David's hand while he taps him on the shoulder. Then he walks to his desk and sits. He freezes as if reading a book. David sighs, runs his hand through his hair and walks to front left stage, he stops and facing the audience he lifts his head as if looking at a point far away.

Dialogue between David and Rev. Crane: Rev. Crane: Well David, during the past few days we've talked about different tests we have to go through in life, like choices, truthfulness and forgiveness, I can see how you're getting a better idea of who you are and its changing your attitude and your behavior. You've expanded your perception and conquered some of your problems. I am very happy for you, that now you're depending on your spiritual strength. Now you know that it's not you against the world but rather you against your subconscious mind and the trash it's accumulated throughout your life. There will be times when you'll give in to it, when your subconscious will try to confuse you. When that happens keep your eyes on your spiritual self and clear your mind of all those negative thoughts. Because, David this is our life's primary objective. David: (stretching his hand) Bye Rev. Crane. David: (thinking) I heard someone say that the teacher appears when the student is ready. Even though I have a long way to go, in these few days, I feel as if I've made a lot of changes in my life. I'll look for new ways to solve my problems. I know that with the help of God everything is possible.

AT THIS POINT THE PLAY IS STOPPED FOR DISCUSSION OF MATERIAL PRESENTED SO FAR CONQUERING THE MOUNTAIN OF FORGIVENESS:

Q After surgery a doctor usually sutures or staples the skin where he cut. Why do you think he does this? Sample Response: To keep the wound from being infected. Q What happens when a wound gets infected? Sample Response: The wound doesn't heal and the person can get sick. Q What do you think happens to people that leave their emotional wounds open? Sample Response: They get infected.

Following is another example of an expert opinion narrated by the trained professional:

To ignore an emotional wound is like leaving a wound open and exposed to all kinds of contaminants, that's why people go to counselors or doctors to help them heal. But some feminists think that talking to a counselor or a doctor about childhood sexual abuse doesn 't really help the victim, they say that it reduces the importance of the abuse by making it an isolated incident instead of a sick way of establishing male superiority. They say that the only way to stop abusers from preying on defenseless people is by going public and demanding protection. (White, 160-164)

The question and answer session resumes as follows: Q: Do you think that going public makes the difference between a victim and a survivor? Sample Response: No. It is the reaction to the abuse that makes a person a victim or a survivor. Q Rev. Crane told David that he needed to forgive Max and everyone that hurt him? Why do you think forgiveness is so important? Sample Response: Because the emotional wounds can get infected with hate, resentment, anger and guilt. Q. For what we know it seems that David also hated himself or hated his limitations. How do you think he could change the way he felt about himself? Sample Response: By choosing to change his behavior to fill hits own and not other people's expectations. Following is another example of an expert opinion narrated by the trained professional: When people know who they are, they become free to decide how to validate themselves. They no longer need the false esteem that power or money, or position, or beauty or youth gives them. They no longer have to try to become something they are not. Men would no longer have to be strong or to subdue women to validate themselves. Women would stop denigrating themselves and value their sexuality for what it is, a powerful gift, THE SOURCE OF LIFE. NLP EXERCISE TO FORGIVE AND LET GO OF RESENTMENT,

Class Summary
1. The first NLP presupposition says that the map is not the territory, or that we have our own view of life. How has your view of life changed during the course of this class?
2. During this class you were encouraged to practice the moral virtues including truthfulness. How have other people responded to you when you made the effort and how did you feel about yourself as a result?
3. Give an example on how the perception of yourself influenced your behavior?
4. One of the NLP presuppositions says that language is a secondary representation of experience. What word or phrase do you constantly repeat and what do you mean when you say it?
5. Give an example on good or bad behaviors that you learned during your childhood.
6. Give an example of something you did because it was the best choice you had at the time?
7. Tell me about thee time you applied your ability to do something into something new.
8. How can people know that you are a good person or have good qualities?
9. Tell me about a time you did something different because you were not getting results by doing it the old way.
10. The Behavior and Self Diagram made a clear distinction between behavior and self. On which of the two sides would you place the idea of doing illegal acts?
11. What behaviors do you want to change to make your life more enjoyable?

AT THIS POINT THE MASTERY OF OBJECTIVES IS REVIEWED, THE FLOOR IS OPEN FOR COMMENTS AND THE CLASS ENDS

These are examples of how the class is conducted. However one skilled in the art will appreciate that a deviation in the story line to accommodate participants and a different set of questions by the examiner covering the same concepts are well within the scope of this invention. The example essentially demonstrates the basic concepts that are covered in the class.

Any patents or publications mentioned in this specification are indicative of the levels of those skilled in the art to which the invention pertains. Further, these patents and publications are incorporated by reference herein to the same extent as if each individual publication was specifically and individually indicated to be incorporated by reference.

What is claimed is:

1. A treatment technique for overcoming pain and addiction comprising a classroom course for individuals in need of such treatment, wherein said classroom course is conducted by one or more professionals specifically trained to conduct said course, wherein said course comprises:
(a) the dramatization or simulation of a real life experience;
(b) a discussion between said individuals and said professional about the story and characters presented in (a);
(c) Neuro linguistic Programming excercises, wherein said Neuro linguistic Programming excercises take said individual to an emotional state, wherein said individual can process own traumas and fears.
(d) conducting an attitude test at the beginning and at the end of said course to measure changes in attitude as a result of said course.

2. The course of claim 1 wherein said dramatization in step (a) presents difficult areas of concern for individual participants

3. The course of claim 1, wherein the story recited in said dramatization in step (a) involves an emotionally distressed young individual, wherein said individual has a physical handicap and is also an ex convict with a drug addiction problem.

4. The course of claim 1, wherein said discussion in step (b) introduces opinions of scholars and experts in various fields in subject matters introduced in step (a)

5. The course of claim 1, wherein said discussion in step (b) allows the participants to express their own opinions in a non-threatening situation.

6. The course of claim 1, wherein said discussion in step (b) is not designed to impose ideas on said individuals or make changes for said individuals.

7. The course of claim 1, wherein said discussion in step (b) is designed to give said individuals choices with pre-determined boundaries.

8. The course of claim 1 wherein said discussion in step (b) utilizes a Behavior and Self Diagram to teach participating individuals to recognize the external factors that shaped their self-image and behavior.

9. The course of claim 1, wherein said guided neuro-linguistic programming excercise in step (c) involves processing any traumatic incidents in said individual's life.

10. The course of claim 1, wherein said Neuro linguistic Programming excercises in step (c) involves visualizing as future desired by said individual.

11. The course of claim 1, wherein said Neuro linguistic Programming excercises in step (c) involves reinforcing positive memories in said individual's life.

12. The course of claim 1, wherein said Neuro linguistic Programming excercises are based on neuro-linguistic programming techniques.

13. The course of claim 1, wherein said pain is not physical pain but is more of an emotional distress due to trauma.

14. The course of claim 10, wherein said trauma can be related to being a drug-addict, being incarcerated, or being unable to conform to the expectations of society.

15. The course of claim 1, wherein the story recited in said dramatization involves an emotionally distressed young individual, wherein said individual has a physical handicap and is also an ex convict with a drug addiction problem.

16. The course of claim 1, wherein the following topics are discussed in steps (a) through (c):
(i) the road to freedom;
(ii) finding your way out of darkness: NLP principles and the Behavior Self Diagram;
(iii) children,in violent homes;
(iv) neuro-linguistic programming exercise to process childhood abuse;
(v) childhood wounds;
(vi) recognizing the spirit;
(vii) lost in a sea of problems;
(viii) drugs a mirage in the desert;
(ix) the family went wrong;
(x) paralyzing guilt;
(xi) the bleeding pain of victimization;
(xii) neuro-linguistic programming exercise to accept family's faults;
(xiii) dominance and submission;
(xiv) trapped by bad luck;
(xv) sex and survival;
(xvi) trying and not succeeding;
(xvii) recognizing the teacher in everyone;
(xviii) neuro-linguistic programming exercise to project a desired future;
(xix) women and the search for wholeness;
(xx) love, a four letter word;
(xxi) Nothing to do and nowhere to go;
(xxii) emotional atrophies that maim men;
(xxiii) conquering the mountain of forgiveness; and
(xxiv) neuro-linguistic programming exercise to forgive and let go of resentment.

17. The course of claim 16, wherein said topics from (i)-(vi) are covered in the first section, said topics from (vii)-(xii) are covered in the second session, said topics (viii)-(xviii) are covered in the third session and said topics (xix)-(xxiv) are covered in the fourth session.

18. The,course of claim 1, wherein said course uses teaching material comprising videotapes, audio tapes, blackboard, power point presentations, paper and writing medium.
